(19) United States
(12) Patent Application Publication
(10) Pub. No.: US 2017/0236330 A1
(43) Pub. Date: Aug. 17, 2017

(54) NOVEL DUAL HMD AND VR DEVICE WITH NOVEL CONTROL METHODS AND SOFTWARE

(71) Applicant: Julie Maria Seif, Warminster, PA (US)

(72) Inventor: Julie Maria Seif, Warminster, PA (US)

(21) Appl. No.: 15/043,637

(22) Filed: Feb. 15, 2016

(51) Int. Cl. G06T 19/00; G06F 3/14; G06F 3/01; G02B 27/01; H04N 5/38; H04N 5/445; G06F 3/02; H04N 7/00; G06F 3/0488

(52) U.S. Cl. CPC G06T 19/006; H04N 7/002; G06F 3/1423; G06F 3/013; G06F 3/0488; H04N 5/38; H04N 5/44504; G06F 3/014; G06F 3/0202; G02B 27/0172; G02B 2027/0138; G02B 2027/014; G02B 2027/0118; G02B 2027/0123

(57) ABSTRACT

Discussed within this disclosure is a device which functions as both a heads mounted display and virtual reality device as well as various softwares which are required on the device for it's operation. A vast plurality of embodiments of the invention are disclosed. Another aspect of the invention is that the device is controlled by a wireless device application. Finally, there is a discussion regarding providing virtual reality environments which encompass users in all directions.

### CROSS-REFERENCE TO RELATED APPLICATIONS

Not Applicable

### SUBSTITUTE SPECIFICATION STATEMENT

This substitute specification includes no new matter.

### STATEMENT REGARDING FEDERALLY SPONSORED RESEARCH OR DEVELOPMENT

Not Applicable

### REFERENCE TO A SEQUENCE LISTING, a TABLE, or a COMPUTER PROGRAM LISTING COMPACT DISC APPENDIX

Not Applicable

### BACKGROUND OF THE INVENTION

The technology herein relates to the field of Head Mounted Displays and Virtual Reality devices and experiences provided by these technologies.

Heads Mounted Displays (referred to herein as HMD or HMDs) and VR devices (referred to herein as VR), are not a new area of technology. Over the past twenty to thirty years, various forms of these products have been created by companies and individuals, only to be plagued with similar problems that hinder these devices from being adopted by consumers. In recent years, a resurgence in the development and creation of these devices has been occurring due to the “wearables” or “wearable technology” phenomenon that is currently sweeping the world.

HMD devices are devices which provide semi-immersive experiences. They allow users to be presented with information while not taking up their full field of view, allowing the user to be able to see the outside world. Examples of information presented on these devices include notifications from social media or directions on how to complete a process. These devices typically utilize a miniaturized projection system, which projects information on to a surface in front of the user. This projection system usually contains an image combiner so that the projected information appears to be floating.

The surface that receives the projected information is typically positioned to off to the side or in the corner of the users vision. This causes the user to have to move their eye to look at it, not allowing seamless integration into their daily life or allowing the device to provide a wide ranging variety of semi-immersive experiences. If this surface is transparent in nature and the user is standing in bright light, displayed information becomes difficult to see.

Since these devices do not naturally integrate into the eye of the user's natural field of view and angle of view, eye strain and motion sickness can be caused. This is especially true of attempted solutions that involve projecting an image onto the retina.

Many attempted solutions are controlled by voice recognition, which doesn't allow for the user to be able to discreetly control their own device.

VR devices are devices that provide immersive experiences, which take up the full field of view of the user's vision, causing them to be unable to see the outside world. These devices allow the user to interact with virtual worlds. These virtual worlds consist of video gaming environments or simulated places that make the user feel as through they are carrying out an action or interacting in these worlds by captivating the user's vision. These devices typically utilize optical lenses and electronic displays. The issue with this method, is that you cannot have a display up very close to the face, as that would cause eye damage. Having to make space for the display or displays to be positioned in a non-damaging position as well as the size of the electronic hardware components, has made many attempts very bulky. This makes these devices not comfortable for the user to wear, nor are they ergonomic as eyestrain is an issue with these devices.

Many attempted solutions are not standalone devices, meaning that these VR devices have to be connected to a computer or another device to be operable. Thus, there are also usually many cords running between the VR device worn on the head to a computer or other device and to the method that is used to control the device.

These issues along with the aforementioned bulk issues, makes these devices lack ease of portability.

Attempted solutions use gloves as the main control method and input device for these devices. This method results in discomfort with prolonged wear, which normally manifests in the form of sweaty hands. For some users, sweat and the material associated with gloves could turn into rashes over time. This method also hinders portability depending on the size and proportions of the gloves and their method of connecting to the VR device and the other device or devices that the VR device may be connected to.

It is a significant challenge for these devices to be designed to be ergonomic, to avoid eye strain, and to be discreetly controlled. Specifically, for HMDs, it has been a challenge to design a device that can integrate into your day to day life seamlessly. Specifically, for VR devices, it is difficult to design a device that is not large in size.

This is unfortunate, because as previously mentioned these issues have hindered the adoption of these devices by the consumer. Accordingly, there is a great need for these problems to be solved, so that these realms of technology can expand and grow as well as be adopted by a wide variety of users.

### BRIEF SUMMARY OF INVENTION

The aforementioned problems are eliminated by the invention that is a wearable multifunction device that is capable of being both a Head Mounted Display (referred to herein as HMD) and Virtual Reality (referred to herein as VR) device and it's accompanying aspects such as novel software and or expansion packs which are described herein.

In the first embodiment of the invention, the device has two displays. The device has a case which encompasses these displays, with an opening or openings for the user to look directly at the displays. These displays which display a graphical user interface (referred to herein as GUI) for the HMD aspect or graphical virtual world environment for the VR aspect that are connected to one or more microprocessing units, one or more modules, programs, or sets of instructions stored in the memory for performing multiple functions. The microprocessing units and their associated modules, arrays, or other forms of hardware may be contained in the same case that the displays are located in or may be in separate case(s) which interconnect with the case containing the displays and allows for the hardware enclosed in the separate case(s) to connect to the displays stored within the case containing the displays.

In another embodiment of the invention, instead of having two displays, the device has only a single display. A program is stored in the memory which is configured to be executed by the one or more microprocessing units. The program includes: instructions to split the display down the middle vertically, so that the two created sections will be recognized by the operating system and or program or programs stored within the memory of the device as two separate displays, and in each section identical GUIs will appear or accurately positioned graphical virtual worlds will display.

In another embodiment of the invention, the device has two sets of one or more optical lenses in which the user looks through to view one or more displays. The device has a case which encompasses these displays and lenses, with an opening or openings for the user to look through the lenses to see the displays. These displays, display a GUI for the HMD aspect or graphical virtual world environment for the VR aspect which are connected to one or more microprocessing units, one or more modules, programs, or sets of instructions stored in the memory for performing multiple functions. The microprocessing units and their associated modules, arrays, or other forms of hardware may be contained in the same case that the lenses and displays are located in or may be in separate case(s) which interconnect with the case containing the displays and lenses and allows for the hardware enclosed in the separate case(s) to connect the displays stored within the case containing the displays and lenses.

In another embodiment of the invention, the user wears one or more contact lenses to view two displays and the device has two sets of one or more optical lenses in which the user looks through to view while wearing the contact lenses to view one or more displays. The user looks through these optical lenses to view two displays. The device has a case which encompasses these displays and lenses, with an opening or openings for the user to look through the lenses to see the displays. These displays, display a GUI for the HMD aspect or graphical virtual world environment for the VR aspect which are connected to one or more microprocessing units, one or more modules, programs, or sets of instructions stored in the memory for performing multiple functions. The microprocessing units and their associated modules, arrays, or other forms of hardware may be contained in the same case that the lenses and displays are located in or may be in separate case(s) which interconnect with the case containing the displays and lenses and allows for the hardware enclosed in the separate case(s) to connect the displays stored within the case containing the displays and lenses.

In another embodiment of the invention, the user wears one or more contact lenses to view two displays. The user looks through these contact lenses to view two displays. The device has a case which encompasses these displays and lenses, with an opening or openings for the user to look through to see the displays. These displays, display a GUI for the HMD aspect or graphical virtual world environment for the VR aspect which are connected to one or more microprocessing units, one or more modules, programs, or sets of instructions stored in the memory for performing multiple functions. The microprocessing units and their associated modules, arrays, or other forms of hardware may be contained in the same case that the lenses and displays are located in or may be in separate case(s) which interconnect with the case containing the displays and lenses and allows for the hardware enclosed in the separate case(s) to connect the displays stored within the case containing the displays and lenses.

In another aspect of the embodiment(s) of the invention, a program is stored in the memory which is configured to be executed by the one or more microprocessing units. The program includes: instructions to display an identical GUI on each screen.

In another aspect of the embodiment(s) of the invention, a program is stored in the memory which is configured to be executed by the one or more microprocessing units. The program includes: instructions to accurately display similar yet different views of the graphical virtual world environment on each screen. Within this disclosure there exists a discussion regarding the brain, the eyes, and how they work together to make a flawless field of view for humans. From this discussion, another discussion begins about how emphasis exists on identically and accurately positioning GUI and VR elements based off of data regarding the brain and eyes working together, so they appear flawlessly in the user's field of view.

In yet another aspect of all embodiments of the invention, camera(s) exist which are of accurate specifications and are accurately positioned on the front of the device to emulate the field of view and resolution of human vision. Within this disclosure a discussion exists about what specification and position the camera(s) need to have so human vision can be accurately emulated with camera(s).

In an embodiment of this aspect of all of the embodiments of the invention, two cameras, referred to herein as a dual camera embodiment, are used. In a dual camera embodiment, one or more programs are stored in the memory and configured to be executed by the one or more microprocessing units. The one or more programs include: instructions to adjust the cameras (example: zoom) if needed, instructions to obtain a real time video feed from the cameras, instructions to display each video feed on a separate display, instructions to layer an identical GUI on top of each real time video feed on each display, and instructions for the GUI to be positioned at various distances along the z-axis to make GUI elements seem like they are floating and that they are a part of the scene that the user is looking at.

In another embodiment of this aspect of all of the embodiments of the invention, one camera, referred to herein to as a single camera embodiment, is used. In a single camera embodiment, one or more programs are stored in the memory and configured to be executed by the one or more microprocessing units. The one or more programs include: instructions to manipulate the real time video feed that is captured by the camera to generate two similar but different views of the real time video feed to be shown to each eye, instructions to adjust the camera (example: zoom) if needed, instructions to obtain a real time video feed from the camera, instructions to display each video feed on a separate display, instructions to layer an identical GUI on top of each manipulated real time video feed on each display, and instructions for the GUI to be positioned at various distances along the z-axis to make GUI elements seem like they are floating and that they are a part of the scene that the user is looking at.

It should be also noted that the emphasis on accurately recreating the outside world within the device is to allow the user to see the outside world with clarity while allowing the GUI to add an unobtrusive layer of interactivity over what they are looking at.

In order to better integrate with the outside world, in some embodiments, this GUI will employ the use of transparency or opacity. For example, a program that is a web browser could be stored in the memory and executed by the one or more processors. When executed, the instructions of the program are to render all webpage backgrounds to be transparent, and to render images to have varying levels of opacity, thus allowing the user to still be able to see the outside world while browsing the web. There is also a discussion within this disclosure regarding that HMD applications, programs, or functions can have components which run in the VR aspect of the device. For example, if an HMD app having to do with outer space had a portion of the program that could run in the VR aspect of the device, it likely would be a graphical virtual world modeled to look like outer space which gives clarity to what is being described with in the HMD aspect of the program.

In another aspect of the embodiments of the invention, a light sensor or light sensor(s) located on the outside of the device transmits data to one or more programs that are stored in the memory and executed by the one or more processing units. The one or more programs include: instructions to adjust the brightness of the display to match the outside environment at the same speed that the human eye adjusts itself to light and instructions for the color scheme of the GUI to change based on the brightness or darkness of the outside environment so it will remain visible. It should be noted that this is done to preserve the health of the eyes and create a seamless experience. In some embodiments the user will interact with and control the device, the graphical user interface, and any graphical virtual worlds using any of or a combination of the following methods.

A camera or optical sensor in which may be used in combination with a supplementary light source inside the device allows the tracking and recognition of iris movements and blinks of the eyelids. One or more buttons can be allocated for either user assigned functions which require multiple presses, pre-assigned functions such as turning the camera which tracks iris movements on and off, or each of these buttons can be capable of performing these functions. A microphone and internal software provides voice recognition. Head movements are available as a result of an embedded sensor array containing one or more motion detecting or tracking sensors.

Wireless communications integrated within the microprocessing units, allows various peripherals to be connected to the device. For example, these peripherals could be peripherals such as VR gloves and fitness trackers. In some embodiments, this may occur via Bluetooth (registered trademark) technology tethering. This connection also allows for handsets to be connected to the device. Through this connection, the handset's existing sensors, sensor arrays, and or modules can be utilized as control methods for the device. Examples of these existing sensors, sensors arrays or modules within the handset include but are not limited to accelerometer, gyroscope, integrated motion unit, integrated navigation unit, magnetometer, and microphone.

For example, while playing a VR fencing game, a user could simply move their hand left and right while holding the connected handset which has one or more sensors or sensor arrays to detect or track any type of motion, to move an on screen sword left and right. It should be noted that these methods of control can be used simultaneously and all methods of control described herein can be applied to both the HMD aspect and VR aspect of the device.

In another aspect of the invention, a speciality application created for this device that is downloaded and installed onto a connected handset, allows for methods of interaction and control with the device. When the handset is connected to the device this application takes advantage of the connected handset's user input features, which in some embodiments may be a touch screen, and also simultaneously receives and transmits data from built in sensors, user input features, sensor arrays, microphones, and methods of control into methods of controlling the device.

Within this application is a program or programs which contains a set or sets of instructions to utilize the connected handset's user input features, and translates the user's interaction with those elements into methods of controlling the device or allows the user to interact with content shown on the display or displays within the device. In some embodiments, this may include tapping, swiping, touching, using multi touch or multi finger gestures or any method that includes interacting with a touch screen that is part of a connected handset. For example, a user could use the touch screen of their handset to scroll through directions while the device is being used in HMD mode.

Within the application is a program or programs which sends data regarding calls received on the connected handset to the device, so that the calls can be interacted with. Within the application is a program or programs which sends data regarding messages that are received on the connected handset to the device, so that the messages can be interacted with. Within this application is a program or programs which contains a set or sets of instructions to allow the user to assign either interacting with the connected handset to trigger one of the connected handset's sensors, using a user input feature, or in some embodiments using a single or multi touch gesture to bring up the handset's integrated soft keyboard within the application on the connected handset.

Within the application is a program or programs with instructions to track how the user is interacting with the handset's integrated soft keyboard. This application works in unison with programs stored on the device to mirror the integrated soft keyboard which is shown on the connected handset onto the display or displays of the main device, and to mirror the user's interactions with the soft keyboard on top of the mirroring of the integrated soft keyboard on the displays or displays of the main device.

In some embodiments, when using a connected handset with a touch screen, a program or programs within this application contain instructions to track the user's thumbs or fingers as the user taps or drags and or performs another interaction on the connected handset's touch screen surface when a soft keyboard is displayed to type and instructions to send data to mirror the soft keyboard and to mirror the tracking of the user's thumb or finger movement onto the mirrored soft keyboard so it can be displayed on the display or displays of the device.

On the main device, a program or programs are stored in the memory which are configured to be executed by the one or more microprocessing units. The program or programs include: instructions to receive the mirroring of the soft keyboard and the user's interactions with it and to display the mirroring of the soft keyboard with the mirroring of the user's thumb or finger movement, such as taps, drags, or other interactions with the touch screen to type on top of it on the display or displays of the device. This allows the user to see where their thumbs or fingers are positioned so they can see where to move their thumbs or fingers to type. Examples of using this typing feature include but are not limited to composing and responding to messages of various formats such as text messages or email messages and web browsing.

In other embodiments, the program or programs described above only contains instructions to receive the mirroring of where the user's thumbs and fingers are positioned on the keyboard and displays this over an image of the keyboard layout of the connected handset. In these embodiments, the Dual HMD and VR device would have several known handset keyboard layout images stored within it to be used with this application.

Within this application is a program or programs with instructions for the application on the connected handset to receive an image that is sent to it from the device, such as a control pad, instructions to track how the user is interacting with the control pad, and instructions to mirror the user's interactions with the control pad on the display or displays of the main device.

In some embodiments, when using a connected handset with a touch screen, a program or programs within this application contains instructions to receive an image that is sent to it from the device such as a control pad, instructions to track the user's thumbs or fingers as they interact with the control pad in various ways such as tapping, instructions to send input data to the program or programs on the device when specified areas of the control pad image are interacted with, instructions to show the control pad that is shown on the connected handset on the display or displays of the connected device and for the and then instructions to mirror the tracking of the thumb or finger movement onto the control pad which is shown on the display or displays of the device.

For example, the user taps an A button on the control pad image that is shown in the application which is on the connected handset and the device receives a message that the user has pressed the A button on the control pad prompting the program or programs on the device to respond however they are supposed to when a user interacts with the A button.

It should be noted that this method shouldn't be restricted to gamepads. Gamepads are a good example, because gamepads are known to have various input methods such as buttons, and specific gamepads have been developed for specific games. What is being attempted to be illustrated is that specific control methods can be created for specific applications or games. Generally, examples of these control methods could potentially be but are not limited to button or slider style interfaces, so that they could be easily utilized with a touch screen handset.

Since the user's eyes are focused on what is being shown to them within the device and they are using the connected handset's touch screen or user input features to interact with what is being shown to them on the display or displays inside the device, it should be noted that in many embodiments, the application essentially will only serve the purpose of sensing how the user interacts with the touch screen, user input features, or sensor or sensor arrays within the handset and thus may be a blank screen or solid color unless the handset's integrated soft keyboard or other control method transmitted to the handset from the device is needed.

It should be noted that all of the sensors that are a part of the connected handset can still be accessed to provide methods of control or interaction with on screen content while this application is open.

It should also be noted that the connected handset's user input method or integrated touch screen and sensors can be used simultaneously to control the device. For example, if a connected handset has an integrated touch screen users can trigger one of the integrated sensor or sensor arrays such as a motion sensor array by moving the handset while simultaneously tapping or swiping the touch screen to interact with something within the device.

In some embodiments, the connected handset will act as a co-processing platform in unison with the device.

In another aspect of the invention, by use of the connected handset a method is provided for ensuring that the user is not wearing the device while driving. A program is stored in the memory which is configured to be executed by the one or more microprocessing units. The program includes: instructions to access the location services and or global positioning system of the connected handset that is connected to the device, instructions to use the data that the location services or global positioning system within the device is receiving when the user is in motion and instructions that can indicate if travel speed of the user implies that the user is operating a motor vehicle, and instructions to curtail the device's functionality to reflect safety issues.

In another aspect of the invention, a method for providing a graphical virtual world environment that is 360 degrees, fully encompassing the user in all directions is described. A program or programs are stored within the memory which is configured to be executed by the one or more microprocessing units. The program or programs include: instructions for virtual worlds to extend past the boundaries of the display or displays the user is looking through, instructions for the user to use any of the aforementioned control methods of this device to be able to change their field of view position to be moved in any direction that is 360 degrees or less, and instructions for the user to move in various directions along the degree that they choose.

It should be noted that humans, in real life, can turn their body to face any direction within 360 degrees and move forward, backward, left, right, etc from whatever position they are in. When this happens, depending on the direction and distance of our movement we either end up viewing objects within our visual field at a different angle or what we see in our visual field changes entirely and we are exposed to more of the environment that we are surrounded in. By using the aforementioned control methods in conjunction with the program or programs that have just been described, the user is able to move through these virtual worlds very similarly to the way that they move through the real world. This allows the creation of virtual worlds that are more like environments, like the environment we live in, which surrounds us. For example, the user turns their head left or right while being immersed in a virtual world while wearing this device. By use of the integrated sensor arrays within the device, the user sees what is contained within their visual field at a slightly different angle and depending on how far the user moves their head in the direction that they desire they may see more of the virtual world, like when we turn our heads left or right while looking over a scene and we see more of the scene or view it at a different angle. In another example, the user is immersed in a virtual world, and wants to turn around within the virtual world to see what's behind them. A user input feature or interaction with an integrated touch screen on a connected handset can cause the field of view to change as if the user has moved 180 degrees in real time, like we do when we turn around in real life. From that point, the user can move forward in the direction they have just positioned themselves in or in any direction they choose within the virtual world. This aspect of the invention is based off of taking real life movements, and translating how those movements would be carried out in terms of computer functions and code.

It should be noted that virtual worlds can be created for this device to be as immersive or not immersive as the developer wants the worlds to be. Thus meaning that in some virtual worlds, the user may not be able to move as freely in all directions.

The multiple aspects and embodiments of the invention will become more apparent through the detailed description of the embodiments and the associated drawings.

### BRIEF DESCRIPTION OF SEVERAL VIEWS OF THE DRAWINGS

FIG. 1 shows a block diagram for the novel Dual HMD and VR device discussed within this disclosure.

FIG. 2 is a block diagram illustrating the portable multifunction device known as Dual HMD and VR Device in accordance with some embodiments.

FIG. 3 illustrates a side view of a portable multifunction device known as Dual HMD and VR Device in accordance with some embodiments.

FIG. 4 illustrates a reverse side view of a portable multifunction device known as Dual HMD and VR Device in accordance with some embodiments.

FIG. 5 illustrates a zoomed in reverse side view of a portable multifunction device known as Dual HMD and VR Device in accordance with some embodiments.

FIG. 6 illustrates an side view of a portable multifunction device known as Dual HMD and VR Device in accordance with some embodiments.

FIG. 7 illustrates a overhead view of a portable multifunction device known as Dual HMD and VR Device in accordance with some embodiments.

FIG. 8 illustrates a front view of a portable multifunction device known as Dual HMD and VR Device in accordance with some embodiments.

FIG. 9 illustrates a zoomed in reverse side view of a portable multifunction device known as Dual HMD and VR Device in accordance with some embodiments.

FIG. 10 illustrates yet another zoomed in reverse side view of a portable multifunction device known as Dual HMD and VR Device in accordance with some embodiments.

FIG. 11 illustrates contact lenses which are used with a portable multifunction device known as Dual HMD and VR Device in accordance with some embodiments

FIG. 12 illustrates contact lenses which are used with a portable multifunction device known as Dual HMD and VR Device in accordance with some embodiments.

FIG. 13 illustrates a reverse side view of a portable multifunction device known as Dual HMD and VR Device in accordance with some embodiments.

FIG. 14 illustrates a reverse side view of a portable multifunction device known as Dual HMD and VR Device in accordance with some embodiments.

FIG. 15 illustrates an overhead view of a portable multifunction device known as Dual HMD and VR Device, having optical lenses, in accordance with some embodiments.

FIG. 16 illustrates an overhead view of a portable multifunction device known as Dual HMD and VR Device, having optical lenses, in accordance with some embodiments.

FIG. 17 illustrates an overhead view of a portable multifunction device known as Dual HMD and VR device, which includes optical lenses with the device that are removable, in accordance with some embodiments.

FIG. 18 illustrates what the camera(s) which are included with Dual HMD and VR Device, in accordance with some embodiments, show the user on the display(s) of the device.

FIG. 19 illustrates the field of view of each of the human eyes independently and explains how each eye's field of view merges or overlaps to create one seamless field of view

FIG. 20 illustrates the field of view of each of the human eyes independently and explains how each eye's field of view merges or overlaps to create one seamless field of view.

FIG. 21 illustrates the field of view of each of the human eyes independently and explains how each eye's field of view merges or overlaps to create one seamless field of view.

FIG. 22 illustrates the front of a portable multifunction device known as Dual HMD and VR Device in accordance with some embodiments.

FIG. 23 illustrates a view of what is seen in each camera's field of view and shown on the display(s) of the Dual HMD and VR Device in accordance with the embodiment of Dual HMD and VR device illustrated in FIG. 3DD.

FIG. 24 illustrates how the video feed which is acquired in accordance with some embodiments, such as a single camera embodiment of the invention, is separated into two separate but intersecting fields of view so that each view is shown on a separate display.

FIG. 25 illustrates an example of an identical GUI, being layered over the video feed or feed(s) shown on the display(s) included in the invention portable multifunction device known as Dual HMD and VR Device in accordance with some embodiments.

FIG. 26 illustrates an example of a GUI with some transparent elements being layered over the video feed or video feed(s) shown on the displays included in the invention portable multifunction device known as Dual HMD and VR Device in accordance with some embodiments.

FIG. 27 illustrates an example of a GUI with solid elements being layered over the video feed or video feed(s) shown on the displays included in the invention portable multifunction device known as Dual HMD and VR Device in accordance with some embodiments.

FIG. 28 illustrates an aspect of the invention, where the color scheme of the GUI being layered over the video feed or feed(s) shown on the display(s) included in the invention portable multifunction device known as Dual HMD and VR device, changes color based on the lighting conditions of the outside environment in accordance with some embodiments

FIG. 29 illustrates an aspect of the invention, where the color scheme of the GUI being layered over the video feed or feed(s) shown on the display(s) included in the invention portable multifunction device known as Dual HMD and VR device, changes color based on the lighting conditions of the outside environment in accordance with some embodiments.

FIG. 30 illustrates an example of the image processing features which are available due to the camera(s) included the invention known as Dual HMD and VR device being utilized by the user.

FIG. 31 illustrates an example of the image processing features which are available due to the camera(s) included the invention known as Dual HMD and VR device being utilized by the user to access one or more softwares to analyze and obtain data from what the camera(s) included in the invention are able to view of the outside environment in accordance with some embodiments.

FIG. 32 illustrates items within a GUI shown on the displays of the Dual HMD and VR Device being scrolled as a result of the user moving their eyes in accordance with some embodiments.

FIG. 33 illustrates the user moving their eye upwards so that optical sensor(s), supplementary light source(s) for optical sensor(s), and software detects and track the movement of the eyes and the to control or interact with the invention, Dual HMD and VR Device, in accordance with some embodiments

FIG. 33A illustrates the user keeping their eye open before they move their eye or blink so that optical sensor(s), supplementary light source(s) for optical sensor(s), and software detects and track the movement of the eyes and the to control or interact with the invention, Dual HMD and VR Device, in accordance with some embodiments.

FIG. 34 illustrates a GUI element in accordance with some embodiments, shown on the displays of the invention, Dual HMD and VR device.

FIG. 35 illustrates the user blinking their eye so that optical sensor(s), supplementary light source(s) for optical sensor(s), and software detects and track the movement of the eyes and the to control or interact with the invention, Dual HMD and VR Device, in accordance with some embodiments.

FIG. 36 illustrates the GUI element that was shown in figure thirty four is now closed because of the user blinking their eye in figure thirty five, due to optical sensor(s), supplementary light source(s) for optical sensor(s), and software detecting and tracking the movement of the eyes and the to control or interact with the invention, Dual HMD and VR Device, in accordance with some embodiments.

FIG. 37 illustrates the user keeping their eye open before they move their eye or blink so that optical sensor(s), supplementary light source(s) for optical sensor(s), and software detects and track the movement of the eyes and the to control or interact with the invention, Dual HMD and VR Device, in accordance with some embodiments.

FIG. 38 illustrates a GUI element in accordance with some embodiments, shown on the displays of the invention, Dual HMD and VR device.

FIG. 39 illustrates the user moving their eye to the left so that optical sensor(s), supplementary light source(s) for optical sensor(s), and software can detect and track the movement of the eye to control or interact with the invention, Dual HMD and VR Device, in accordance with some embodiments.

FIG. 40 illustrates the GUI element that was shown in figure thirty eight is now moving in the direction in which the user is moving their eye in figure thirty nine, due to optical sensor(s), supplementary light source(s) for optical sensor(s), and software detecting and tracking the movement of the eyes and the to control or interact with the invention, Dual HMD and VR Device, in accordance with some embodiments.

FIG. 41 illustrates a notification which is layered over the video feed or feed(s) shown on the display(s) of the invention, Dual HMD and VR Device, in accordance with some embodiments.

FIG. 42 illustrates the user interacting with a notification which is layered over the video feed or feed(s) shown on the display(s) of the invention, Dual HMD and VR Device, in accordance with some embodiments.

FIG. 43 illustrates an on screen event occurring as a result of the user interacting with an element which was shown on the displays of the invention, Dual HMD and VR Device, in accordance with some embodiments.

FIG. 44 illustrates content on the displays of the invention, Dual HMD and VR Device, scrolling in accordance with some embodiments.

FIG. 45 illustrates the user pushing an upward directional button on a connected handset to scroll content on the displays of the invention, Dual HMD and VR device in accordance with some embodiments.

FIG. 46 illustrates on screen content shown on the displays of the invention, Dual HMD and VR Device, moving in accordance with some embodiments.

FIG. 47 illustrates the user shaking a connected handset to move on screen content shown on the displays, of the invention, Dual HMD and VR Device, in accordance with some embodiments.

FIG. 48 illustrates a prompt being shown on the displays of the invention, Dual HMD and VR Device in accordance with some embodiments.

FIG. 49 illustrates the user interacting with a wireless device application made to be used with the invention, Dual HMD and VR Device, in accordance with some embodiments.

FIG. 50 illustrates an action occurring on the displays of the invention, Dual HMD and VR Device, as a result of the user interacting with a wireless device application made to be used with the invention, Dual HMD and VR Device, in accordance with some embodiments.

FIG. 51 illustrates the user interacting with a wireless device application made to be used with the invention, Dual HMD and VR Device, in accordance with some embodiments.

FIG. 52 illustrates the user interacting with a wireless device application made to be used with the invention, Dual HMD and VR Device, in accordance with some embodiments.

FIG. 53 illustrates an action occurring on the displays of the invention, Dual HMD and VR Device, as a result of the user interacting with a wireless device application made to be used with the invention, Dual HMD and VR Device, in accordance with some embodiments.

FIG. 54 illustrates the user interacting with a wireless device application made to be used with the invention, Dual HMD and VR Device, in accordance with some embodiments.

FIG. 55 illustrates an action occurring on the displays of the invention, Dual HMD and VR Device, as a result of the user interacting with a wireless device application made to be used with the invention, Dual HMD and VR Device, in accordance with some embodiments.

FIG. 56 illustrates the user interacting with a wireless device application made to be used with the invention, Dual HMD and VR Device, in accordance with some embodiments.

FIG. 57 illustrates the user interacting with a wireless device application made to be used with the invention, Dual HMD and VR Device, in accordance with some embodiments.

FIG. 58 illustrates an application layout available for the wireless device application made to be used with the invention, Dual HMD and VR Device, in accordance with some embodiments.

FIG. 59 illustrates an application layout available for the wireless device application made to be used with the invention, Dual HMD and VR Device, in accordance with some embodiments.

FIG. 60 illustrates the user interacting with a wireless device application made to be used with the invention, Dual HMD and VR Device, in accordance with some embodiments.

FIG. 61 illustrates an action occurring on the displays of the invention, Dual HMD and VR Device, as a result of the user interacting with a wireless device application made to be used with the invention, Dual HMD and VR Device, in accordance with some embodiments.

FIG. 62 illustrates a menu screen within the wireless device application made to be used with the invention, Dual HMD and VR Device, in accordance with some embodiments.

FIG. 63 illustrates a menu screen within the wireless device application made to be used with the invention, Dual HMD and VR Device, in accordance with some embodiments.

FIG. 64 illustrates a menu screen within the wireless device application made to be used with the invention, Dual HMD and VR Device, in accordance with some embodiments.

FIG. 65 illustrates a user interacting with a menu screen within the wireless device application made to be used with the invention, Dual HMD and VR Device, in accordance with some embodiments.

FIG. 66 illustrates the user interacting with a wireless device application made to be used with the invention, Dual HMD and VR Device, in accordance with some embodiments.

FIG. 67 illustrates a keyboard launching within the wireless device application made to be used with the invention, Dual HMD and VR Device, as result of the user interacting with the wireless device application made to be used with the invention, Dual HMD and VR Device, in accordance with some embodiments.

FIG. 69 illustrates the user shaking the wireless device in which the wireless device application made to be used with the invention, Dual HMD and VR Device, is open.

FIG. 70 illustrates a keyboard launching within the wireless device application made to be used with the invention, Dual HMD and VR Device, as result of the user shaking the wireless device application made to be used with the invention, Dual HMD and VR Device, in accordance with some embodiments.

FIG. 71 illustrates the user interacting with a keyboard which is open within the wireless device application made to be used with the invention, Dual HMD and VR Device, in accordance with some embodiments.

FIG. 72 illustrates the users interaction with the keyboard which is open within the wireless device application made to be used with the invention, Dual HMD and VR Device, being shown and the entered text inputted into a text field on the displays of the invention Dual HMD and VR Device.

FIG. 73 illustrates the user using the wireless device application which is made to be used with the invention, Dual HMD and VR Device, to select a text field shown on the displays of the invention, Dual HMD and VR Device 100.

FIG. 74 illustrates the keyboard being launched as a result of the user interacting with the text field which is shown on the display of the invention, Dual HMD and VR Device, by using the wireless device application made for use with the invention, Dual HMD and VR Device, in accordance with some embodiments.

FIG. 75 illustrates the keyboard launching within the wireless device application made for use with the invention, Dual HMD and VR Device, as a result of the user interacting with the textfield shown on the displays of the invention, Dual HMD and VR Device, in accordance with some embodiments.

FIG. 76 illustrates the users interaction with a gamepad shown on within the wireless device application made for use with the invention, Dual HMD and VR Device, being shown on the display of the invention, Dual HMD and VR Device in accordance with some embodiments.

FIG. 77 illustrates the user interacting with a gamepad shown on within the wireless device application made for use with the invention, Dual HMD and VR Device 100, in accordance with some embodiments.

FIG. 78 illustrates a user safety feature which is integrated within the invention, Dual HMD and VR Device, in accordance with some embodiments.

FIG. 79 illustrates a notification being shown on the displays of the invention, Dual HMD and VR Device, in accordance with some embodiments.

FIG. 80 illustrates an example user interface on the displays of the invention, Dual HMD and VR Device, and the user interacting with the user interface using the wireless device application made for use with the invention, Dual HMD and VR Device, in accordance with some embodiments.

FIG. 81 illustrates an example user interface on the displays of the invention, Dual HMD and VR Device, and the user interacting with the user interface using the wireless device application made for use with the invention, Dual HMD and VR Device, in accordance with some embodiments.

FIG. 82 illustrates a menu screen within the wireless device application made for use with the application, Dual HMD and VR Device, in accordance with some embodiments.

FIG. 83 illustrates a menu screen within the wireless device application made for use with the application, Dual HMD and VR Device, in accordance with some embodiments.

FIG. 84 illustrates a menu screen within the wireless device application made for use with the application, Dual HMD and VR Device, in accordance with some embodiments.

FIG. 85 illustrates the user interacting with the wireless device application made for use with the application, Dual HMD and VR Device, in accordance with some embodiments.

FIG. 86 illustrates a user interface shown on the displays of the invention, Dual HMD and VR Device 100 in accordance with some embodiments.

FIG. 87 illustrates the user interacting with the wireless device application made for use with the invention, Dual HMD and VR Device.

FIG. 88 illustrates a user interface shown on the displays of the invention, Dual HMD and VR Device 100 in accordance with some embodiments.

FIG. 89 illustrates a user interface shown on the displays of the invention, Dual HMD and VR Device 100 scrolling as a result of the user's interactions, in accordance with some embodiments.

FIG. 90 illustrates an example user interface on the displays of the invention, Dual HMD and VR Device, and the user interacting with the user interface using the wireless device application made for use with the invention, Dual HMD and VR Device, in accordance with some embodiments.

FIG. 91 illustrates a user interface shown on the displays of the invention, Dual HMD and VR Device 100, in accordance with some embodiments.

FIG. 92 illustrates a user interface shown on the displays of the invention, Dual HMD and VR Device 100, in accordance with some embodiments.

FIG. 93 illustrates a user interface on the displays of the invention, Dual HMD and VR Device, and the user interacting with the user interface using the wireless device application made for use with the invention, Dual HMD and VR Device, in accordance with some embodiments.

FIG. 94 illustrates a user interface on the displays of the invention, Dual HMD and VR Device, for sending messages, in accordance with some embodiments.

FIG. 95 illustrates a user interface for sending messages on the displays of the invention, Dual HMD and VR Device, and the user interacting with the user interface using the wireless device application made for use with the invention, Dual HMD and VR Device, in accordance with some embodiments.

FIG. 96 illustrates a user interface for sending messages on the displays of the invention, Dual HMD and VR Device, and the user interacting with a textfield within the user interface using the wireless device application made for use with the invention, Dual HMD and VR Device, in accordance with some embodiments.

FIG. 97 illustrates a keyboard displaying on the wireless device application made for use with the invention, Dual HMD and VR Device, as a result of the user interacting with the textfield within the user interface for sending messages in accordance with some embodiments.

FIG. 98 illustrates the user's interactions with the keyboard which is open within the wireless device application made for use with the invention, Dual HMD and VR Device, being mirrored onto the displays of the invention, Dual HMD and VR Device, and text being inputted as a result of those interactions, in accordance with some embodiments.

FIG. 99 illustrates software or instructions giving the user address book suggestions as a result of the user inputting text using the wireless device application made for use with the invention, Dual HMD and VR Device, in accordance with some embodiments.

FIG. 100 illustrates the user using the wireless device application made for use with the invention, Dual HMD and VR Device, to select an address book suggestion, in accordance with some embodiments.

FIG. 101 illustrates on the displays of the invention, Dual HMD and VR Device, the successful selection of an address book suggestion, in accordance with some embodiments.

FIG. 102 illustrates a user interface for sending messages, shown on the displays of the invention, Dual HMD and VR Device in accordance with some embodiments.

FIG. 103 illustrates the user interacting with a user interface for sending messages, shown on the displays of the invention, Dual HMD and VR Device, by using the wireless device application made for use with the invention, Dual HMD and VR Device, in accordance with some embodiments.

FIG. 104 illustrates an address book user interface shown on the displays of the invention, Dual HMD and VR Device, in accordance with some embodiments.

FIG. 105 illustrates the user interacting with the address book user interface in accordance with some embodiments.

FIG. 106 illustrates the user using the wireless device application made for use with the invention, Dual HMD and VR Device 100, to interact with the address book user interface shown on the displays of the invention Dual HMD and VR Device 100, in accordance with some embodiments.

FIG. 107 illustrates the user interacting with an address book user interface, shown on the displays of the invention, Dual HMD and VR Device, by using the wireless device application made for use with the invention, Dual HMD and VR Device, in accordance with some embodiments.

FIG. 108 illustrates an address book contact inserted into the address field of a new message user interface, as a result of the user selecting that recipient from the address book user interface, in accordance with some embodiments.

FIG. 109 illustrates a user interface shown on the displays of the invention, Dual HMD and VR Device which shows a single address book contact, in accordance with some embodiments.

FIG. 110 illustrates a user using the wireless device application made for use with the invention, Dual HMD and VR Device, to select the single address book contact which is shown on the displays of the invention, Dual HMD and VR Device, in accordance with some embodiments.

FIG. 111 illustrates an address book contact inserted into the address field of a new message user interface, as a result of the user selecting that recipient from the single address book contact user interface, in accordance with some embodiments.

FIG. 112 illustrates an address book user interface shown on the displays of the invention, Dual HMD and VR Device, in accordance with some embodiments.

FIG. 113 illustrates an address book user interface shown on the displays of the invention, Dual HMD and VR Device, in accordance with some embodiments.

FIG. 114 illustrates a single address book contact user interface shown on the displays of the invention, Dual HMD and VR Device, in accordance with some embodiments.

FIG. 115 illustrates the single address book contact in the recipients field of the new message user interface which is shown on the displays of the invention, Dual HMD and VR Device, in accordance with some embodiments.

FIG. 116 illustrates a user using the wireless device application made for use with the invention, Dual HMD and VR Device, to press the enter button on the keyboard shown within that application to move to the next textfield within the new message user interface, in accordance with some embodiments.

FIG. 117 illustrates the user moving to the next textfield within the new message user interface as a result of the result of the user pressing the enter button in the wireless device application made for use with the invention, Dual HMD and VR Device, in accordance with some embodiments.

FIG. 118 illustrates the keyboard within the wireless device application made for use with the invention appearing on the displays of the invention Dual HMD and VR Device as a result of the user interacting with the text area in accordance with some embodiments.

FIG. 119 illustrates the keyboard within the wireless device application made for use with the invention appearing within the wireless device application made for use with the application Dual HMD and VR Device as a result of the user interacting with the text area in accordance with some embodiments.

FIG. 120 illustrates a user using the wireless device application made for use with the invention, Dual HMD and VR Device, to select a text field within the new message interface shown on the displays of the invention, Dual HMD and VR Device, in accordance with some embodiments.

FIG. 121 shows the user pushing a button on the keyboard shown within the wireless device application made for use with the invention, Dual HMD and VR Device, to change the keyboard layout in accordance with some embodiments.

FIG. 122 shows a user interface for adding multimedia to a message, shown on the displays of the invention, Dual HMD and VR Device 100 in accordance with some embodiments.

FIG. 123 shows a user interface for adding multimedia to a message, shown on the displays of the invention, Dual HMD and VR Device 100 in accordance with some embodiments.

FIG. 124 shows a user interface for adding multimedia to a message, shown on the displays of the invention, Dual HMD and VR Device 100 in accordance with some embodiments.

FIG. 125 shows a user interface for adding multimedia to a message, shown on the displays of the invention, Dual HMD and VR Device 100 in accordance with some embodiments.

FIG. 126 illustrates a user using the wireless device application made for use with the invention, Dual HMD and VR Device, to select a button within the user interface for adding multimedia to a message shown on the displays of the invention, Dual HMD and VR Device, in accordance with some embodiments.

FIG. 127 shows a user interface for adding multimedia to a message, shown on the displays of the invention, Dual HMD and VR Device 100 in accordance with some embodiments.

FIG. 128 illustrates a user using the wireless device application made for use with the invention, Dual HMD and VR Device, to interact with the user interface for adding multimedia to a message shown on the displays of the invention, Dual HMD and VR Device, in accordance with some embodiments.

FIG. 129 shows a user interface for adding multimedia to a message, shown on the displays of the invention, Dual HMD and VR Device 100 in accordance with some embodiments.

FIG. 130 illustrates a user using the wireless device application made for use with the invention, Dual HMD and VR Device, to interact with the user interface for adding multimedia to a message shown on the displays of the invention, Dual HMD and VR Device, in accordance with some embodiments.

FIG. 131 illustrates a user using the wireless device application made for use with the invention, Dual HMD and VR Device, to interact with the user interface for adding multimedia to a message shown on the displays of the invention, Dual HMD and VR Device, in accordance with some embodiments.

FIG. 132 shows a user interface for adding multimedia to a message, shown on the displays of the invention, Dual HMD and VR Device 100 in accordance with some embodiments.

FIG. 133 illustrates a user using the wireless device application made for use with the invention, Dual HMD and VR Device, to interact with the user interface for adding multimedia to a message shown on the displays of the invention, Dual HMD and VR Device, in accordance with some embodiments.

FIG. 134 shows a user interface for adding multimedia to a message, shown on the displays of the invention, Dual HMD and VR Device 100 in accordance with some embodiments.

FIG. 135 illustrates a user using the wireless device application made for use with the invention, Dual HMD and VR Device, to interact with the user interface for adding multimedia to a message shown on the displays of the invention, Dual HMD and VR Device, in accordance with some embodiments.

FIG. 136 illustrates multimedia successfully added to a message which is being composed shown on the displays of the invention, Dual HMD and VR Device, in accordance with some embodiments.

FIG. 137 illustrates a user using the wireless device application made for use with the invention, Dual HMD and VR Device, to interact with the user interface for creating multimedia to a message shown on the displays of the invention, Dual HMD and VR Device, in accordance with some embodiments.

FIG. 138 shows a user interface for creating multimedia to add to a message, shown on the displays of the invention, Dual HMD and VR Device 100 in accordance with some embodiments.

FIG. 139 illustrates a user using the wireless device application made for use with the invention, Dual HMD and VR Device, to interact with the user interface for creating multimedia to a message shown on the displays of the invention, Dual HMD and VR Device, in accordance with some embodiments.

FIG. 140 illustrates a user interface shown on the displays of the invention, Dual HMD and VR Device 100 which prompts the user to interact to capture a photo from the camera or cameras included with the invention, Dual HMD and VR Device, in accordance with some embodiments.

FIG. 141 shows a user interface for adding multimedia to a message, shown on the displays of the invention, Dual HMD and VR Device 100 in accordance with some embodiments.

FIG. 142 illustrates a user using the wireless device application made for use with the invention, Dual HMD and VR Device, to interact with the user interface for adding multimedia to a message shown on the displays of the invention, Dual HMD and VR Device, in accordance with some embodiments.

FIG. 143 illustrates a user using the wireless device application made for use with the invention, Dual HMD and VR Device, to interact with the user interface for creating multimedia to be added to a message shown on the displays of the invention, Dual HMD and VR Device, in accordance with some embodiments.

FIG. 144 illustrates a user using the wireless device application made for use with the invention, Dual HMD and VR Device, to interact with the user interface for creating multimedia to be added to a message shown on the displays of the invention, Dual HMD and VR Device, in accordance with some embodiments.

FIG. 145 illustrates multimedia successfully added to a message which is being composed shown on the displays of the invention, Dual HMD and VR Device, in accordance with some embodiments.

FIG. 146 illustrates a user using the wireless device application made for use with the invention, Dual HMD and VR Device, to interact with the user interface for sending a message shown on the displays of the invention, Dual HMD and VR Device, in accordance with some embodiments.

FIG. 147 illustrates a user interface for listing all active conversations shown on the displays of the invention, Dual HMD and VR Device, in accordance with some embodiments.

FIG. 148 illustrates a message notification shown on the displays of the invention, Dual HMD and VR Device, in accordance with some embodiments.

FIG. 149 illustrates a message notification shown on the displays of the invention, Dual HMD and VR Device, in accordance with some embodiments.

FIG. 150 illustrates a user interface which results after opening a message notification shown on the displays of the invention, Dual HMD and VR Device, in accordance with some embodiments.

FIG. 151 shows the user interacting with the user interface which results after opening a message notification shown on the displays of the invention, Dual HMD and VR Device, by using the wireless device application made for use with the invention, Dual HMD and VR Device, in accordance with some embodiments.

FIG. 152 illustrates the keyboard launching as a result of the user using the wireless device application made for use with the application to interact with a text area within the user interface which results after opening a message notification shown on the displays of the invention, Dual HMD and VR Device, in accordance with some embodiments.

FIG. 153 illustrates the keyboard within the wireless device application created for use with the invention, Dual HMD and VR Device, launching as a result of user using the wireless device application made for use with the application to interact with a text area within the user interface shown on the displays of the invention Dual HMD and VR Device, in accordance with some embodiments.

FIG. 154 illustrates a user interface which results after opening a message notification shown on the displays of the invention, Dual HMD and VR Device, now additional showing the user's reply to the message that they received in accordance with some embodiments.

FIG. 155 illustrates a user interface which results after opening a message notification shown on the displays of the invention, Dual HMD and VR Device, now additional showing the user's reply to the message that they received in accordance with some embodiments.

FIG. 156 illustrates the user interacting with the wireless device application created for use with the invention, Dual HMD and VR Device, to scroll content downward, in accordance with some embodiments.

FIG. 157 illustrates content on the displays of Dual HMD and VR Device being scrolled down as a result of the user interacting with the wireless device application created for use with the invention, Dual HMD and VR Device, to scroll content downward, in accordance with some embodiments.

FIG. 158 illustrates a user=interface for the VR aspect of the invention, Dual HMD and VR Device, in accordance with some embodiments.

FIG. 159 illustrates the user interacting with the wireless device application created for use with the invention, Dual HMD and VR Device, interact with a user interface for the VR aspect of the invention in accordance with some embodiments.

FIG. 160 illustrates a user interface for the VR aspect of the invention, in accordance with some embodiments.

FIG. 161 illustrates the user interacting with the wireless device application created for use with the invention, Dual HMD and VR Device, interact with a user interface for the VR aspect of the invention, in accordance with some embodiments.

FIG. 162 illustrates how the VR worlds and games are shown on the displays of the invention, Dual HMD and VR Device, in accordance with some embodiments.

FIG. 163 illustrates the user using their eye as a method of interacting with on screen content while using the VR aspect of the invention, Dual HMD and VR Device, in accordance with some embodiments.

FIG. 164 illustrates the VR aspect of the invention responding as a result of the user using their eye as a method of interacting with on screen content while using the VR aspect of the invention, Dual HMD and VR Device, in accordance with some embodiments.

FIG. 165 illustrates on screen content within the VR aspect of the invention, Dual HMD and VR device, in accordance with some embodiments.

FIG. 166 illustrates the user moving their head while wearing the invention and immersed in the VR aspect of the invention, to interact with the VR aspect of the invention, Dual HMD and VR Device, in accordance with some embodiments.

FIG. 167 illustrates the VR aspect of the invention, Dual HMD and VR Device, reacting to the user moving their head while wearing the invention to interact with the VR aspect of the invention, Dual HMD and VR Device, in accordance with some embodiments.

FIG. 168 illustrates a prompt with in the VR aspect of the invention, Dual HMD and VR Device, in accordance with some embodiments.

FIG. 169 illustrates the user interacting with the wireless device application created for use with the invention, Dual HMD and VR Device, to move forward within a VR world or game, in accordance with some embodiments.

FIG. 170 illustrates the VR world or game, as a result of the user's interactions with the wireless device application created for use with the invention, Dual HMD and VR device, moving forward, on the displays of the invention, Dual HMD and VR Device, in accordance with some embodiments.

FIG. 171 illustrates what the VR world or game does when the user is done interacting with the touch screen of the wireless device application created for use with the invention, Dual HMD and VR Device, in accordance with some embodiments.

FIG. 172 illustrates a text input field within a VR environment shown on the displays of the invention, Dual HMD and VR Device, in accordance with some embodiments.

FIG. 173 illustrates the user interacting with the wireless device application created for use with the invention, Dual HMD and VR device, to select the text input field within the VR environment, in accordance with some embodiments.

FIG. 174 illustrates a keyboard appearing as a result of the user interacting with the wireless device application created for use with the invention, Dual HMD and VR device, to select the text input field within the VR environment, in accordance with some embodiments.

FIG. 175 illustrates an overhead view of the user's position within the VR environment, in accordance with some embodiments.

FIG. 176 illustrates an example VR environment in accordance with some environments.

FIG. 177 illustrates the user's interactions with a gamepad shown in the wireless device application created for use with the invention, Dual HMD and VR Device, being mirrored onto the displays of the invention, Dual HMD and VR Device, in accordance with some embodiments.

FIG. 178, illustrates the user interacting with a gamepad shown in the wireless device application created for use with the invention, Dual HMD and VR Device, in accordance with some embodiments.

FIG. 179 illustrates what the user sees on the displays of the invention, Dual HMD and VR Device, while immersed in a VR environment in accordance with some embodiments.

FIG. 180, illustrates the user interacting with the wireless device application created for use with the invention, Dual HMD and VR Device, to change their position within the VR environment in accordance with some embodiments.

FIG. 181, illustrates the user interacting with the wireless device application created for use with the invention, Dual HMD and VR Device, to change their position within the VR environment in accordance with some embodiments.

FIG. 182, illustrates the user interacting with the wireless device application created for use with the invention, Dual HMD and VR Device, to change their position within the VR environment in accordance with some embodiments.

FIG. 183, illustrates the user interacting with the wireless device application created for use with the invention, Dual HMD and VR Device, to change their position within the VR environment in accordance with some embodiments.

FIG. 184 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 185 illustrates an overhead view of the user's position within the VR environment, in accordance with some embodiments.

FIG. 186, illustrates the user interacting with the wireless device application created for use with the invention, Dual HMD and VR Device, to change their position within the VR environment in accordance with some embodiments.

FIG. 187 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 188 illustrates an overhead view of the user's position within the VR environment, in accordance with some embodiments.

FIG. 189, illustrates the user interacting with the wireless device application created for use with the invention, Dual HMD and VR Device, to change their position within the VR environment in accordance with some embodiments.

FIG. 190 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 191 illustrates an overhead view of the user's position within the VR environment, in accordance with some embodiments.

FIG. 192, illustrates the user interacting with the wireless device application created for use with the invention, Dual HMD and VR Device, to change their position within the VR environment in accordance with some embodiments.

FIG. 193 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 194 illustrates an overhead view of the user's position within the VR environment, in accordance with some embodiments.

FIG. 195, illustrates the user interacting with the wireless device application created for use with the invention, Dual HMD and VR Device, to change their position within the VR environment in accordance with some embodiments.

FIG. 196 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 197 illustrates an overhead view of the user's position within the VR environment, in accordance with some embodiments.

FIG. 198, illustrates the user interacting with the wireless device application created for use with the invention, Dual HMD and VR Device, to change their position within the VR environment in accordance with some embodiments.

FIG. 199 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 200 illustrates an overhead view of the user's position within the VR environment, in accordance with some embodiments.

FIG. 201, illustrates the user interacting with the wireless device application created for use with the invention, Dual HMD and VR Device, to change their position within the VR environment in accordance with some embodiments.

FIG. 202 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 203 illustrates an overhead view of the user's position within the VR environment, in accordance with some embodiments.

FIG. 204, illustrates the user interacting with the wireless device application created for use with the invention, Dual HMD and VR Device, to change their position within the VR environment in accordance with some embodiments.

FIG. 205 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 206 illustrates an overhead view of the user's position within the VR environment, in accordance with some embodiments.

FIG. 207, illustrates the user interacting with the wireless device application created for use with the invention, Dual HMD and VR Device, to change their position within the VR environment in accordance with some embodiments.

FIG. 208 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 209 illustrates an overhead view of the user's position within the VR environment, in accordance with some embodiments.

FIG. 210, illustrates the user interacting with the wireless device application created for use with the invention, Dual HMD and VR Device, to change their position within the VR environment in accordance with some embodiments.

FIG. 211 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 212 illustrates an overhead view of the user's position within the VR environment, in accordance with some embodiments.

FIG. 213, illustrates the user interacting with the wireless device application created for use with the invention, Dual HMD and VR Device, to change their position within the VR environment in accordance with some embodiments.

FIG. 214 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 215 illustrates what the user currently sees on the displays of the invention, Dual HMD and VR Device, while immersed in a VR environment, in accordance with some embodiments.

FIG. 216, illustrates the user interacting with the wireless device application created for use with the invention, Dual HMD and VR Device, to change their position within the VR environment in accordance with some embodiments.

FIG. 217 illustrates an overhead view of the user's position within the VR environment, in accordance with some embodiments.

FIG. 218 illustrates the change in the user's position on the displays of the invention, Dual HMD and VR Device, as a result of the user interacting with the wireless device application created for use with the invention, Dual HMD and VR Device, to change their position within the VR environment in accordance with some embodiments.

FIG. 219 illustrates an overhead view of the user's position changing within the VR environment, in accordance with some embodiments.

FIG. 220 illustrates the user breaking contact with the touch screen of the wireless device which the wireless device application created for use with the invention, Dual HMD and VR Device, in accordance with some embodiments.

FIG. 221 illustrates what the user sees on the displays of the invention, Dual HMD and VR Device, within the VR environment as a result of the user breaking contact with the touch screen of the wireless device which the wireless device application created for use with the invention, Dual HMD and VR Device, in accordance with some embodiments.

FIG. 222 illustrates what the user currently sees on the displays of the invention, Dual HMD and VR Device, while immersed in a VR environment, in accordance with some embodiments.

FIG. 223 illustrates an overhead view of the user's current position within the VR environment, in accordance with some embodiments.

FIG. 224, illustrates the user interacting with the wireless device application created for use with the invention, Dual HMD and VR Device, to change their position within the VR environment in accordance with some embodiments.

FIG. 225, illustrates the user interacting with the wireless device application created for use with the invention, Dual HMD and VR Device, to change their position within the VR environment in accordance with some embodiments.

FIG. 226 illustrates an overhead view of the user's position changing within the VR environment, in accordance with some embodiments.

FIG. 227 illustrates the user breaking contact with the touch screen of the wireless device which the wireless device application created for use with the invention, Dual HMD and VR Device, in accordance with some embodiments.

FIG. 228 illustrates an overhead view of the user's position changing within the VR environment, in accordance with some embodiments.

FIG. 229 illustrates what the user sees on the displays of the invention, Dual HMD and VR Device, within the VR environment as a result of the user breaking contact with the touch screen of the wireless device which the wireless device application created for use with the invention, Dual HMD and VR Device, in accordance with some embodiments.

FIG. 230 illustrates another embodiment of the invention, Dual HMD and VR Device, in accordance with some embodiments.

FIG. 231 illustrates another embodiment of the invention, Dual HMD and VR Device, in accordance with some embodiments.

FIG. 232 illustrates another embodiment of the invention, Dual HMD and VR Device, in accordance with some embodiments.

FIG. 233 illustrates another embodiment of the invention, Dual HMD and VR Device, in accordance with some embodiments.

FIG. 234 illustrates another embodiment of the invention, Dual HMD and VR Device, in accordance with some embodiments.

FIG. 235 illustrates another embodiment of the invention, Dual HMD and VR Device, in accordance with some embodiments.

FIG. 236 illustrates another embodiment of the invention, Dual HMD and VR Device, in accordance with some embodiments.

### DETAILED DESCRIPTION OF THE INVENTION

Attention is now directed towards embodiments of the invention, which is a device, that is a wearable multifunction device that is capable of being both a Head Mounted Display (referred to herein as HMD) and Virtual Reality (referred to herein as VR) device.

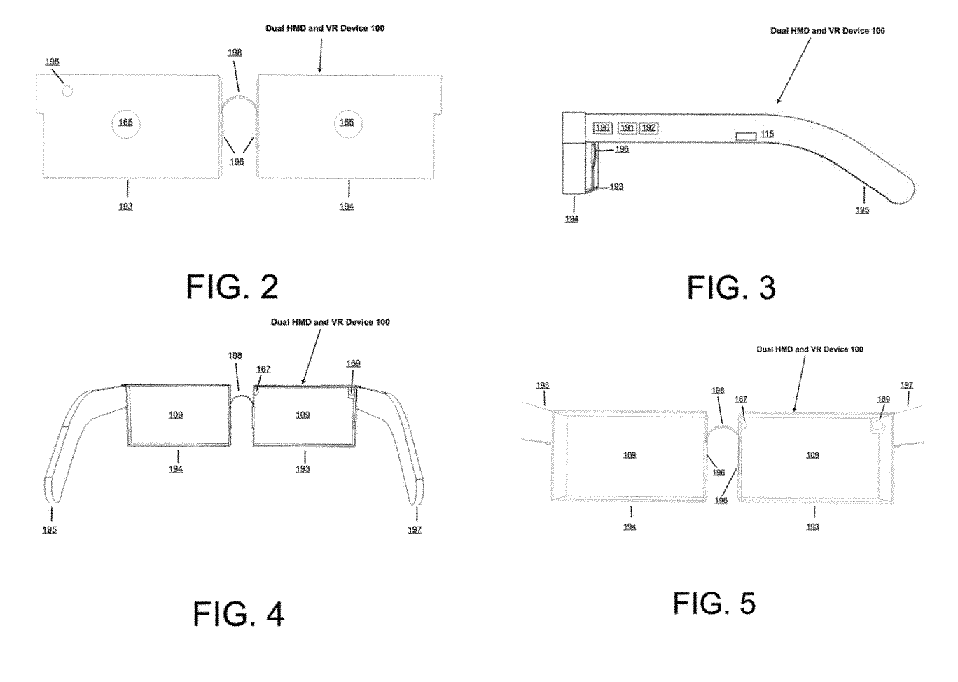

FIGS. 2-7 illustrates an embodiment of one version of the invention Dual HMD and VR Device 100.

This embodiment of the version of the invention Dual HMD and VR Device 100, consists of multiple cases case 193, case 194, case 195, case 197, and case 198 (which may be known in some embodiments as a nose bridge) (case 198 (which may be known in some embodiments as a nose bridge) may be referred to in some embodiments as a bridge), as this case is similar to a bridge on a pair of eyeglasses, which interconnect to form the outer casing of the Dual HMD and VR Device 100. These interconnecting cases allows the hardware and software components to be able to connect to one another regardless of what case they are stored in. For example, a printed circuit board in case 197 could potentially connect to a camera that is included in case 193 via wires, ribbon cables, and the like.

It should be obvious to one skilled in the art that although in this embodiment, there is discussion of cases being interconnected, that this casing, depending on the material of the casing and manufacturing processed used, can in some embodiments be one single case instead of multiple interconnecting cases.

It should also be noted that the parallel lines that are on both case 195 and case 197 in FIG. 2B and FIG. 2E are not specific parts, but are lines which help to illustrate the structure of each case.

Attention is now directed towards FIG. 2. FIG. 2 shows the front of Dual HMD and VR Device 100, which comprises the front side of case 193 and 194. The front side of both case 193 and case 194 measure between a half inch to two inches high and measuring between a half inch to two and a half inches wide. The front side of case 193 comprises camera(s) 195 and light sensor(s) 166. The front side of case 194 comprises camera(s) 165. In this embodiment, case 193 and case 194 each has one camera. Camera(s) 165 are positioned based off of the average distance between the pupils in humans, which is known as being 62 to 64 mm. Thus, the camera(s) 165 on case 193 and case 194 are positioned 62 to 64 mm apart from each other. It should be noted that unique cases may exist as humans are not all similarly proportionate that the positioning of the cameras may have to differ from these numbers to accommodate the specific pupillary distance of the user.

Also, in some embodiments, depending on the specifications of the cameras, the measure between the positions of the two cameras may change, as well. This will be discussed later on within the disclosure.

Other embodiments may exist with different amounts of cameras. FIG. 8 shows another version of the embodiment of the invention Dual HMD and VR Device that was illustrated in FIGS. 2-7, which has only a single camera. The position of this camera has to do with it's specifications, this will be discussed later on within this disclosure. Later on with in this disclosure, software for embodiments which have different amounts of camera(s) 195 will be discussed.

Case 198, which interconnects with case 193 and case 194, and nose pad(s) 196 can also be viewed from this position. Case 198 and nose pad(s) 196, in this embodiment, are positioned on the reverse side of the device. The depth of case 193 and 194 will be discussed later on within this disclosure.

Attention is now directed towards FIG. 3. FIG. 3 shows the left side of Dual HMD and VR Device 100, which gives a view of the left side of case 194 and the left side of case 195. From this position, the left side of nose pad(s) 196, and case 193 can also be seen. The depth of case 194 is between a sixteenth of an inch and an inch and a half. The depth of case 193 is between a sixteenth of an inch and an inch and a half. In most embodiments the measurements of case 193 and 194 will be identical.

Case 195, is considered to begin at the point in the drawling just before button 190 which you can see that case 195 interconnects into case 194. Case 195 measures between six to eight and a half inches in length from the beginning of the case to the end of the case. Case 195 measures between a half inch to two inches high. Case 195 comprises buttons 190, 191, and 192. How buttons 190, 191, and 192 operate and their purpose will be discussed later on in the disclosure. Case 195 also comprises external port 115. External port 115 will be discussed in more depth later on within the disclosure. It should also be apparent that case 195 and case 197 are comparable to an aspect of eyeglasses which is referred to as the temples.

Attention is now directed to FIG. 4. FIG. 4 gives a view of the reverse or back side of Dual HMD and VR Device 100, which comprises the back and left side of case 195, the inside of case 194, case 198 (which may be known in some embodiments as a nose bridge), nose pad(s) 196, the inside of case 193, and the back and right side of case 197. It should be noted that the insides of case 193 and case 194, as well as case 198 (which may be known in some embodiments as a nose bridge) and nose pad(s) 196 will be discussed later on in the disclosure with accompanying drawing, FIG. 5, which is an enlarged view of this area of the device.

Attention continues to be directed at FIG. 4. Case 195 measures between one sixteenth of an inch and one inch in width. Case 197 measures between one sixteenth of an inch and one inch in width.

Attention is now directed to FIG. 5, which is an enlarged view of the reverse side of case 193, case 194, nose pad(s) 196, case 198 (which may be known in some embodiments as a nose bridge), and shows cases 195 and 197 interconnecting to cases 194 and 193. The measurements of all of these cases except case 198 (which may be known in some embodiments as a nose bridge) and nose pad(s) 196 have already been described, thus this section will serve the purpose of discussing case 198 (which may be known in some embodiments as a nose bridge), nose pad(s) 196, and what is contained inside case 193 and 194.

Within case 194 and case 193, display(s) 109 resides. In this embodiment, case 194 and case 193 contain a single display which measures between a half inch to two inches high and measures between a half inch to two and a half inches wide. This measurement is the same as the measurement given for the front side of case 194 and case 193. In this embodiment, display(s) 109 takes up the entire face of the section of the case in which it resides on. It should be noted, that the components supplementary light source for optical sensor(s) 167 and optical sensor(s) 169 in case 193, which will be discussed later on in the disclosure, rest in front of the screen. In this embodiment, supplementary light source for optical sensor(s) 167 is attached to the side of case 193, and optical sensor(s) 169 rests slightly on display(s) 109 while also resting against case 193, on an angle. Embodiments can exist where the positioning of these components differ from what has just been described.

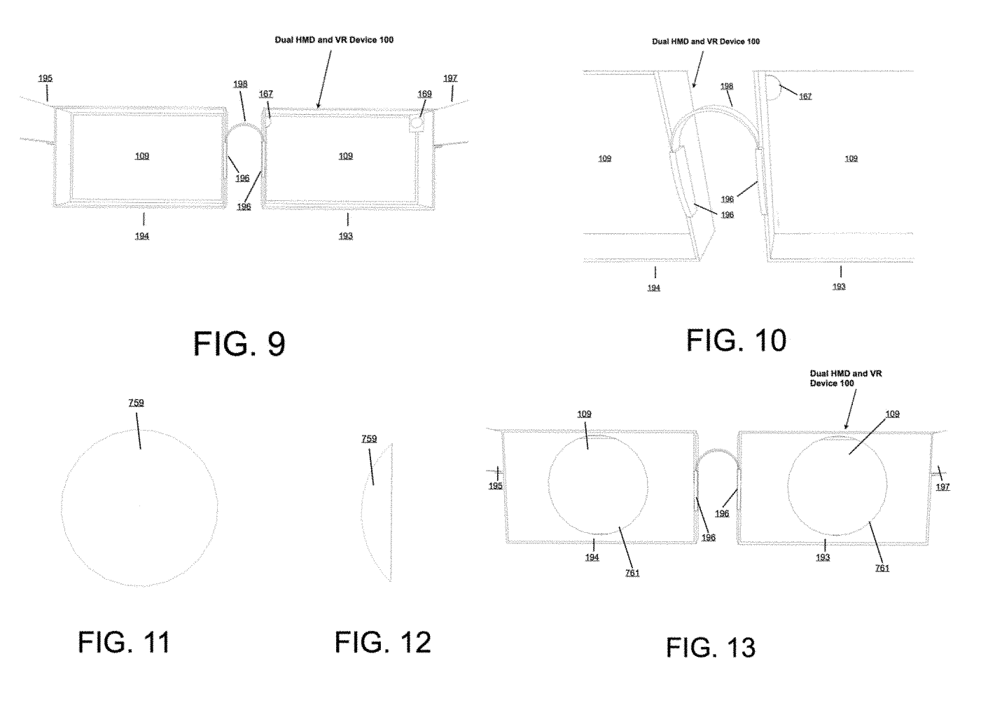

In some embodiments, the display(s) 109 may not take up the entire face of the section of the case it resides on. FIG. 9 illustrates this, serving as a non limiting example. In FIG. 9, it is clear that the display(s) 109 does not take up the entire face of the section of the case it resides on as the boundaries of display(s) 109 are clearly illustrated and a thin boarder is visible around the display(s) 109, which is area of the face of the case that the display resides on which is not covered by the display(s) 109. Later on in the disclosure, other versions of the invention are discussed which contain different embodiments of display(s) 109, such as custom shaped displays.

Attention now returns back to FIG. 5. Attention is now simultaneously directed toward FIG. 5 and FIG. 7. FIG. 5, which gives an overhead view of Dual HMD and VR Device 100, which serves the purpose of displaying the positioning of case 198 (which may be known in some embodiments as a nose bridge). A discussion regarding case 198 (which may be known in some embodiments as a nose bridge) will now occur.

As shown in FIG. 10, case 198, which is clearly visible in previous drawings, serves the purpose of being a nose bridge and nose pad assembly. Case 198 measures between one forth inch and one half inch high at it's highest point, which would be directly in the center. To one familiar with a nose bridge, the nose bridge decreases in height on either side FIG. 10 shows an isolated view of case 198, which is visible in previous drawings. Case 198 is connected to case 193 and case 194. Case 198 serves as a nose bridge and nose pad assembly. Case 198 measures between one forth inch and one half inch high at it's highest point, which is directly in the center. Case 198 measures between one half inch and one inch in width. Case 198 measures between one fourth inch and one half inch in depth. Nose pad(s) 196 measure between a quarter inch to one and a quarter inch high. Nose pad(s) 196 measure between one sixteenth of an inch to one half inch in width. It may be applicable, in some designs of this component of the invention, to make case 198 a custom size to accommodate a user's specific needs based on the curvature of their nose. It should be obvious to those skilled in the art that in some embodiments case 198, which is a nose bridge and nose pad assembly, may not be implemented as a separate case which connects case 193 and case 194 as seen here, but case 193, case 194, and case 198 may be manufactured to be one single case. This is similar to the previous discussion regarding how the invention may not be composed of separate connecting or interlocking cases, and may be one custom shaped case.

It should be obvious, with the inclusion of nose pad(s) that the user will wear this device on their face. Although the user will look at this device using their bare eyes, any face worn device of this nature may or may not need lenses. Thus other embodiments of Dual HMD and VR Device 100 which have optical lenses or other optical devices that the user look's through to see display(s) 109 will now be discussed.

In some embodiments, the user may wear a contact lens or contact lenses on each eye such as the contact lens 759 shown in FIG. 11 which is a view of the contact lens that when worn faces away from the eye, and FIG. 12 which is a side view of the aspect contact lens that when worn faces away from the eye, when using Dual HMD and VR Device 100. These contact lenses measure between one tenth of an inch and two inches in diameter.

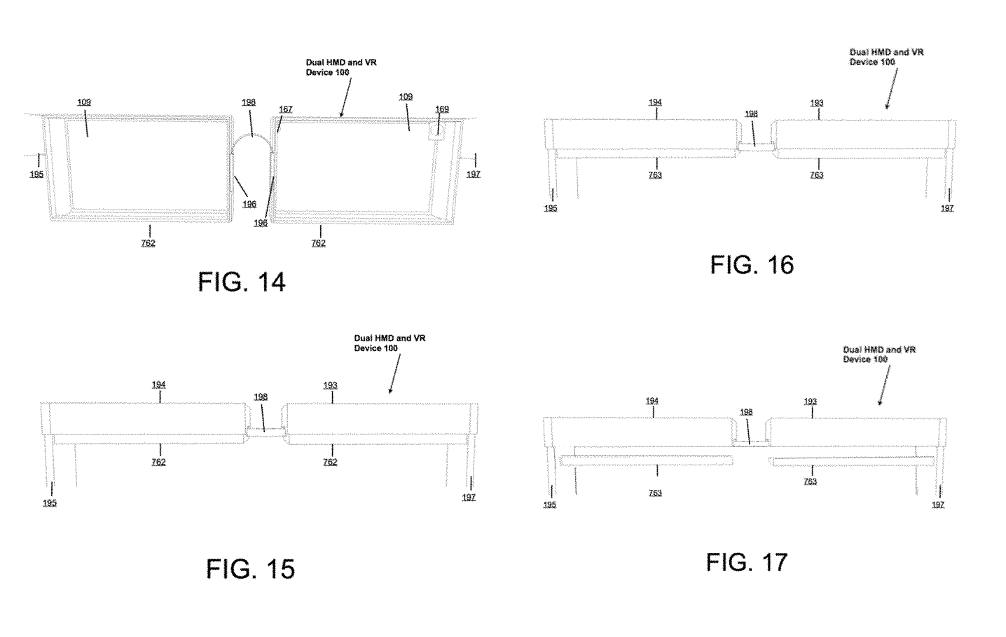

FIG. 13 illustrates another version of embodiment of Dual HMD and VR Device 100 which was illustrated in FIGS. 2-7, which includes one or optical lenses 761, which are positioned in front of display(s) 109. As seen in FIG. 13, the user would look through the optical lenses 761 to view display(s) 109. These embodiments include supplementary light source for optical sensors 167 and optical sensor(s) 164, they are unable to be seen in these illustrations due to the lens. In some embodiments, they may be a custom shape, not the expected circular shape and in some embodiments not covering up the screen a bit like in the previous example, as shown in non limiting example, FIGS. 14 and 15 which shows a front and overhead view of optical lenses 762 which are a rectangular shape.

In other embodiments, these lenses may be removable, and be able to be removed and attached or reattached to the device as the user sees fit using any method which is appropriate for objects have the ability to be removed, attached, or reattached to and from other objects. It should be obvious to one skilled in the art that many ways can be devised to create a method of removing and attaching optical lenses to Dual HMD and VR Device 100. FIGS. 16 and 17 illustrates an overhead view non limiting example, where the optical lenses 763 are encased in a casing which allows optical lenses 763 to press fit on and off of Dual HMD and VR Device 100.

In some embodiments, a user may wear a contact lens or lenses, like the ones that were illustrated above, on their eyes in concert with the version of the of the embodiment of Dual HMD and VR Device 100 which includes one or permanent or removable, optical lenses that was just illustrated above.

Attention is now directed back to FIG. 5. Optical sensor(s) 169 are included to allow movements of the iris' of the eyes to be able to control Dual HMD and VR Device 100. Supplementary light source for optical sensor(s) 167 works in concert with optical sensor(s) 167 to distribute an even amount of light in the area so that the iris' can clearly be seen by the optical sensor(s) 169, allowing iris' to be clearly identified by software stored in Memory 101 of Dual HMD and VR Device 100, that translates iris movements into methods of controlling Dual HMD and VR Device 100.

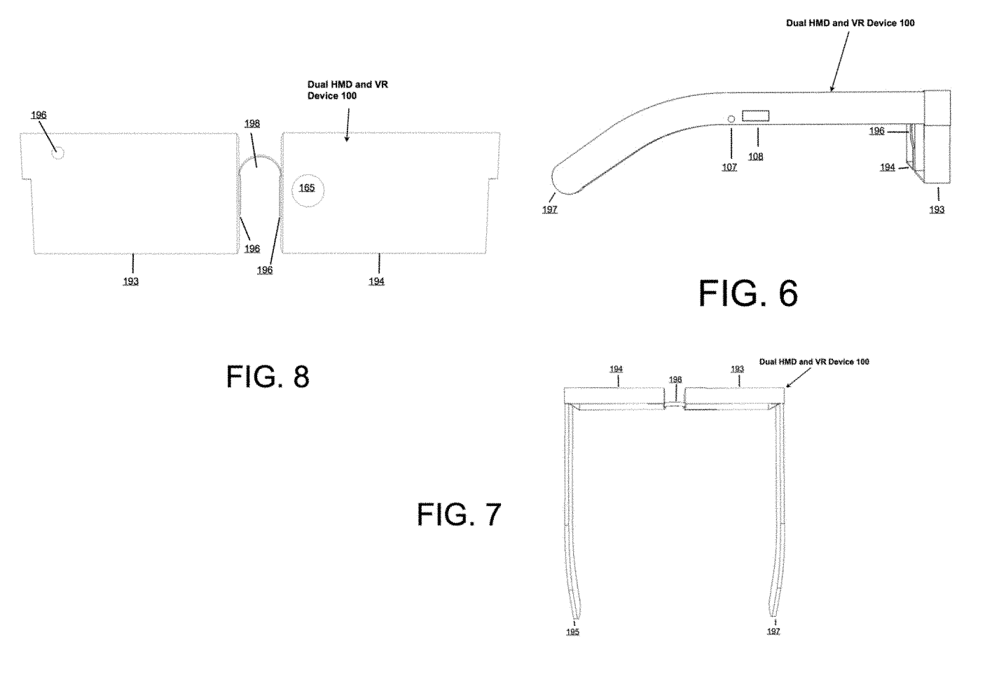

Attention is now directed to FIG. 6, which gives a view of the right side of Dual HMD and VR Device 100, which gives a view of the right side of case 193 and the right side of case 197. From this position, the right side of nose pad(s) 196, and case 194 can also be seen. As previously stated, The depth of case 193 is between a sixteenth of an inch and an inch and a half. Case 197 comprises headphone jack 107 and microphone 108.

The discussion will now be dedicated to describing the hardware and software components in more depth and how they work together to form the invention, a wearable multifunction device that is capable of being both a Head Mounted Display (referred to herein as HMD) and Virtual Reality (referred to herein as VR) device, known as Dual HMD and VR Device 100.

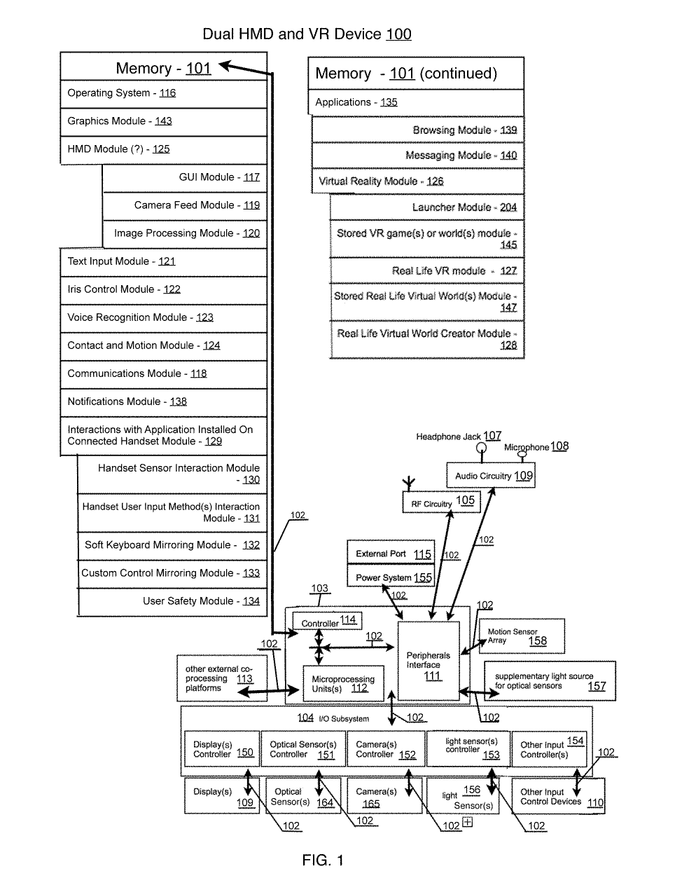

Attention is now directed completely towards the block diagram shown in FIG. 1. Contained within case 193, case 194, case 195, case 197, and case 198 (which may be known in some embodiments as a nose bridge) are various hardware and software components, including memory 101 (which is one or more computer readable storage format), a memory controller 114, one or more microprocessing units 112 which may connect to one or more external co-processing platforms 113, a peripherals interface 111, a power system 155, RF circuitry 105, audio circuitry 109, motion sensor array 158, an input/output (I/O) subsystem 104, display controller 150, light sensor(s) controller 153, camera controller 152, and other input or output control devices 110 and a controller for other input or output devices 154. These components communicate over one or more communication buses, signal lines, and the like 102. The components which have just been discussed may be solely implemented in hardware such as on a printed circuit board, or may be a combination of hardware and software, including one or more signal processing or specific integrated circuits.

Memory 101 may include random access memory or non-volatile memory, for example, one or more flash memory devices or other non-volatile solid state memory devices. The memory controller 114 controls access to the memory by other components for example, the microprocessing unit(s) 112, other external co-processing platforms 113, and the peripherals interface 111.

Peripherals interface 111 pairs input and output of peripherals of the device to microprocessing unit(s) 112 and memory 101. Microprocessing unit(s) 112 execute or run software programs and sets of instructions stored in the memory for performing device functions and for the processing of data.

103 demonstrates that in some embodiments, the memory controller 114, memory 101, microprocessing units 112, and the peripherals interface 111, may be implemented on a single chip. 103 represents a single chip.

RF circuitry 105, receives and sends electromagnetic signals, converts electronic signals to and from electromagnetic signals, communicates with communications networks, and communicates with other communications devices via these signals. RF circuitry 105 includes known circuitry for performing these functions, which may include but is not limited to antenna(s) or an antenna system, amplifier(s), a tuner, oscillator(s), RF transceiver, a digital signal processor, memory, and the like.

RF circuitry 105 can communicate with networks including but not limited to, the Internet (also referred to as the World Wide Web), an intranet, wireless network(s), a wireless local area network (LAN), a metropolitan network (MAN), and other devices via wireless communication(s). The wireless communications may use but are not limited to any one or a combination of the following standards, technologies, or protocols: Bluetooth (registered trademark), wireless fidelity (Wi-Fi) (non-limiting examples: IEEE 802.11a, IEEE 802.11b, IEEE 802.11g and or IEEE 802.11n), near field communications (NFC), email protocols (non-limiting examples: internet message access protocol (IMAP) and or post office protocol (POP)), instant messaging (non-limiting examples: extensible messaging and presence protocol (XMPP) and or Short Message Service (SMS)), or any other communication protocol including communication protocols which have not yet been invented as of the filing date of this disclosure.

RF circuitry 105, uses Bluetooth (registered trademark) to allow other devices, such as Bluetooth (registered trademark) enabled handsets to connect to the device as an other input control device, to interact with and control the content shown on display(s) 109. Other non limiting examples of devices that can connect to this device via Bluetooth to control content shown on display(s) 109 includes VR gloves or fitness trackers. In some embodiments this may occur using Bluetooth (registered trademark) tethering. Through this connection, the Bluetooth (registered trademark) device which is connected to Dual HMD and VR Device 100 gains access to the device's user input, control, or interaction methods and sensors or modules which can be used to control the device. Non limiting examples of these existing sensors are an integrated motion unit, magnetometer, and gyroscope.

In a non limiting example, sensors within VR gloves can be used to move or manipulate objects in a VR game.

In another aspect of the invention, an application which users can download on to their Bluetooth enabled handset extends the functionalities that the handset can have with the device. This application is described later on in the disclosure.

RF circuitry 105, allows devices, such as Bluetooth enabled handsets which are connected via Bluetooth to act as other external co-processing platforms 113 which work in unison with the microprocessing unit(s) 112.

Microprocessing unit(s) 112, will transmit a processing task and associated data to RF circuitry 105, which will transmit the task and data via Bluetooth to a connected Bluetooth enabled device. The Bluetooth enabled device will transmit the processed data back to RF circuitry 105, which will then transmit the processed data to microprocessing unit(s) 112 to be used or distributed throughout the device.

In other embodiments, RF circuitry 105 may include a subscriber identity module (SIM) card. Other embodiments of RF circuitry 105 which use a subscriber identity module or (SIM) card, may use but are not limited to any one or a combination of the following standards, technologies, or protocols as well as the standards, technologies, or protocols which have already been mentioned in the embodiment which does not include a subscriber identity module or (SIM) card: an intranet in conjunction with a wireless network such as a cellular network, Global System for Mobile Communications (GSM), Enhanced Data GSM Environment (EDGE), high-speed downlink packet access (HSDPA), wide band code division multiple access (W-CDMA), code division multiple access (CDMA), time division multiple access (TDMA), voice over internet protocol (VoIP) and Wi-MAX.

Audio circuitry 109 in conjunction with headphone jack 107 and microphone 108 establishes an audio input/output interface between the user and the device. Audio circuitry 109 coverts audio data, received from peripherals interface 111, into an electrical signal which is transmitted to the headphone jack 107 which, when headphones are connected, the speaker or speaker(s) within the headphones converts the electrical signal into audible sound waves. The headphone jack 107, also establishes an audio interface between audio circuitry and removable audio input/output peripherals. Non-limiting examples include headphones or headphones with input such as an integrated microphone. Audio circuitry 109 also receives electrical signals converted by the device's microphone 108 from sound waves. Audio circuitry 109 coverts the electrical signal into audio data and transmits this audio data to the microprocessing unit(s) 112 to be processed. Microprocessing unit(s) 112, may transmit or receive audio data to/from the memory 101 and RF circuitry 105.

I/O subsystem 104, pairs the input output peripherals, for example the display(s) on the Dual HMD and VR Device 100 to the peripherals interface 111. The I/O subsystem 104 includes a display(s) controller 150, optical sensor(s) controller 151, camera(s) controller 152, light sensor(s) controller 153, and other input controller(s) 154. The other input controller(s) 154, transmit and receive electronic signals to and from other input or control devices 110. A non-limiting example of other input or control devices are input push buttons 190, 191, and 192 which are shown in FIG. 2A. These buttons can have pre-assigned functions, such as pressing a button turns the camera that tracks iris movements on and off (the tracking of iris movements will be described later on in the disclosure) or pressing a button activates voice recognition, so the user can speak a command (again, this feature will be described later on in the disclosure). Users can customize the behavior of these buttons, by assigning multiple presses of specific buttons to trigger specific functions. For example, a user can assign that when button 191 is pressed twice, an application, specified by the user, launches. Pressing and holding button 192, will power the device on or off.

The display controller 150 receives electrical signals, which are transmitted to the display(s) 109, which turns the electrical signals into visual output to the user. Non limiting examples of the visual output of this device consist of all or any combination of the following: text, images, video, real time video feeds (to be described later in the disclosure), graphical user interfaces (GUIs), and graphical virtual worlds (to be described later in the disclosure).

The output of the display(s) 109, at times consists of only graphical virtual world environments such as games. The output of the display(s) 109, at times consists of only a real life virtual reality world. This method involves the use of real life virtual reality module 127 and will be described later on in the disclosure. The output of the display(s) 109, at times consists of a live video feed of the outside world, with a GUI layered over it in which users can interact with. This method involves the use of the device's camera(s) controller 152, camera(s) 165, camera feed module 119, and GUI module 117 and will be described later in the disclosure.

Display(s) 109, use AMOLED (active matrix organic light emitting diode) technology. In other embodiments, the displays may use LCD (liquid crystal display technology), LPD (light emitting polymer technology), other display technologies, or any technology that has not yet been invented as of the filing date of this disclosure.

The Dual HMD and VR Device 100 includes a power system 155, which may include a power management system, a single power source or more than one power source (non limiting examples: battery, battery(s), recharging system, AC (alternating current), power converter or inverter), or other hardware components that attribute to power generation and management in wearable multifunction devices. In some embodiments, solar cell(s), panel(s), or other suitable devices which allow ambient light to be converted to electric power exist on or within Dual HMD and VR Device 100. In these embodiments, power connection circuitry is adapted to allow the flow of power from the solar cell(s) or solar panel(s) to one or more power sources (non limiting examples: battery(s) and recharging system) and prevent the flow of power from the power source to the solar cell(s) or solar panel(s). In these embodiments, solar power is used to supplement battery power, however, embodiments may exist where the Dual HMD and VR Device 100 is powered only by solar power. Solar power will be discussed again, later on within this disclosure.

The Dual HMD and VR Device 100, includes an external port 115, which works in conjunction with the power system 155, to either power the device, charge a battery or batteries that may exist within the device, or to power the device and charge battery(s) that may exist within the device simultaneously.

Communications module 118, stored in memory 101, allows external port 115 to be able to be used to communicate with other devices (such as memory devices containing additional applications or games) which are connected to it, and also includes software components for managing data acquired from the external port 115, from devices connected to the external port, or from RF circuitry 105. External port 115, in this embodiment, is a Micro On-The-Go (OTG) Universal Serial Bus (USB). External port 115, in other embodiments, may be a Micro Universal Serial Bus (USB), Universal Serial Bus (USB), other external port technologies that allow the transfer of data, connection of other devices, and charging or powering of a device, or other suitable technology(s) that have not yet been invented as of the filing date of this disclosure.

The Dual HMD and VR Device 100, also includes optical sensor(s) controller 151 and optical sensor(s) 164. Optical sensor(s) 164 which are paired in I/O subsystem 104, may include phototransistors such as a complementary metal-oxide semiconductor (CMOS). In this embodiment, the device has a single optical sensor, which is paired with a supplementary light source for optical sensors, 157. In most devices, discussion of an optical sensor would be for the sake of a camera as most optical sensors are referenced as “receiving light from the environment, which is projected through a lens or lenses, and coverts the light to data which represents an image”. The optical sensor(s) 164, included within this device have those capabilities however, they are located inside of the device and work with software or instructions to provide iris controlled movements to establish a method of controlling the device that allows the users to interact with content shown on display(s) 109 by moving their eyes and are not used for taking pictures.

The method in which the device uses to establish iris controlled movements as a method of controlling and interacting with the device will be described later on within this disclosure.

Optical sensor(s) 164, serve a different purpose from the camera(s) 165. Thus, camera(s) 165 are not referenced as optical sensor(s), but independently. This purpose will be discussed later on within the disclosure.

Camera(s) 165 receive light from the environment, which is projected through a lens or lenses, and coverts the light to data which represents an image. Camera(s) 165 may include phototransistors such as a complementary metal-oxide semiconductor (CMOS). Camera(s) 165 are located on the front of the device, on the opposite side the display(s) 109 and are positioned with distance between them that is based off of the known average horizontal distance between the centers of the pupils in humans, which is known as being 62-64 mm. It should be noted that unique cases will exist, since not all people are similarly proportionate, that may cause the positioning of the cameras to have to be changed to change due to the specific needs of the user. In this embodiment, two cameras are used.

Camera(s) 165, which are paired to a camera(s) controller 152 in I/O subsystem 104 may capture still images or video. Video and image data acquired from camera(s) 165, may be used in conjunction with other modules to perform functions or to acquire data. This will be described later on within the disclosure.

Connected to peripherals interface 111 is motion sensor array 158. Motion sensor array 158 can contain one or more sensors for detecting motion. Non limiting examples of motion sensors that may be included within motion sensor array 158 include: accelerometer(s), gyroscope(s), magnetometer(s), any other suitable motion detecting sensor, and any other motion detecting sensor technology(s) that currently exist at the filing date of this disclosure which have not been mentioned or motion detecting sensor technology(s) have not yet been invented as of the filing date of this disclosure.

Additionally, motion sensor array 158 may be paired with an input controller 154, within the I/O subsystem 104.

Light sensor(s) controller 153, which is included as a part of I/O subsystem 104, controls light sensor(s) 156. Light sensor(s) 156 detect the lighting conditions of the environment and translates this into data which may be sent to other parts of the device such as one or more software(s), programs(s), module(s) or any software or set of instructions which can be executed by the one or more microprocessing units which may then transmit this data to hardware components of the device to perform a function based off of the data collected. A method for what has just been described will be explained in more depth later on in the disclosure.

The discussion will now turn to the memory, what is stored in it, and how these components operate and work in conjunction with the aforementioned hardware.

Within Memory 101 is an Operating System 116. Operating System 116 has a graphical user interface, or GUI. Operating System 116 may be Darwin, Linux, Unix, OS X, Windows, Google Android, and other operating systems or operating systems which have not yet been invented as of the filing date of this disclosure.

Graphics Module 143, within Memory 101, comprises known software components for the rendering and display of graphics on display(s) 109. Graphics, in this context, is any object that can be displayed to a user. Non limiting examples include text, images, videos, and the like.

Within Memory 101 is HMD Module 125, which contains GUI module 117, and Camera Feed Module 119. These modules which contain software or instructions which work in conjunction with other modules and hardware components within the device to establish the HMD aspect of the device, HMD module 125. This aspect of the device, will now be explained.

HMD module 125 works in unison with Operating System 116. Camera Feed Module 119 contains software or sets of instructions which are executed by the one or more microprocessing unit(s) 112 to communicate with Camera(s) controller 152 and Camera(s) 165 which are within the I/O subsystem 104 to obtain a real time live video feed. In some embodiments, Camera Feed Module 119 contains software or a set of directions which adjusts the Cameras(s) 165 via the Camera(s) controller 152 to before shooting. A non limiting example includes instructions for the Camera(s) controller 152 to zoom in or out Camera(s) 165.

Another software or set of instructions which is contained in Camera Feed Module 119 which is a part of HMD module 125 is to display each real time video feed on the display within display(s) 109 that rests directly behind where the camera(s) 165 are situated on the outside of the device.

Another software or set of instructions which are contained within Camera Feed Module 119 which is a part of HMD module 125 is to display the real time video feed which is acquired from each camera which is situated on the front of the device, onto the display within display(s) 109 that camera(s) 165 sit directly in front of.

In a two camera embodiment, if one looks at Dual HMD and VR Device 100 from the front, as shown within FIG. 2, making note of the camera on case 194 which is the right side of the device, and then one flips the Dual HMD and VR Device 100 to the reverse side where display(s) 109 area, as shown within FIG. 3A, the video feed camera which is on the front of case 194 will be shown on the display that is included as a part of display(s) 109 which resides in case 194.

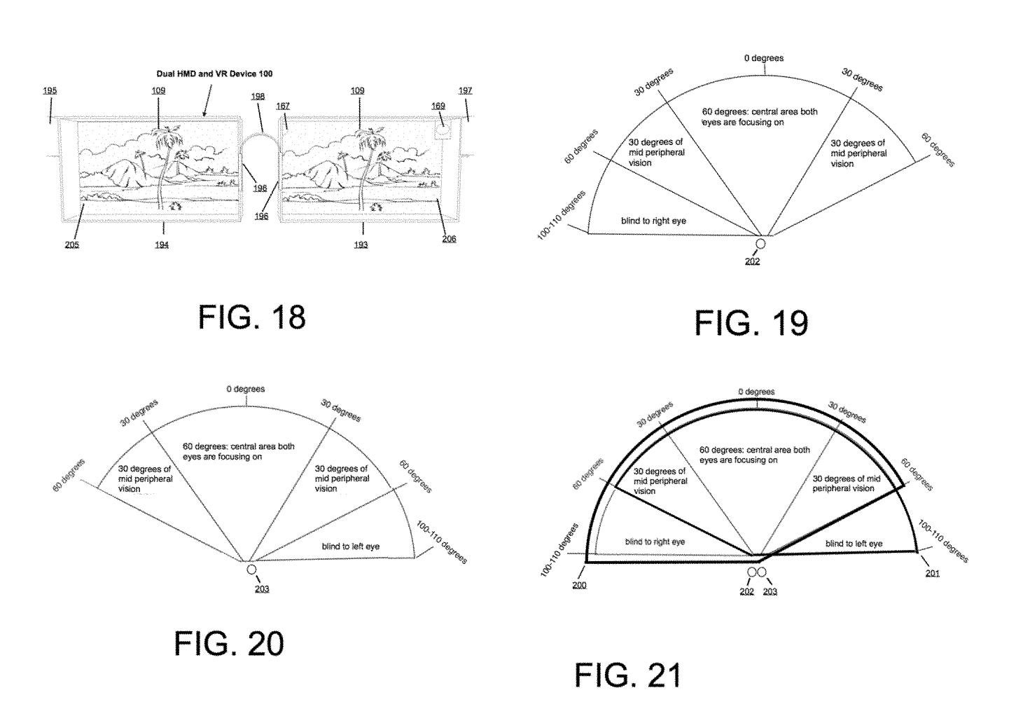

FIG. 18 shows the video feed 205 and video feed 206 which are a result of camera(s) 165, HMD module 125, and camera feed module 116 being shown on display(s) 109.

Camera Feed module 119, which is a part of HMD module 125, in some embodiments may contain software or instructions which are executed by microprocessing unit(s) 112 to stabilize the resulting video feed that is displayed on the camera feeds. For example, when a human moves their head to the right the eyes move themselves in the opposite direction. In this instance, if one was moving their head to the right, then the eyes would move to the left. For example, software or instructions, in some embodiments, may be included in Camera Feed module 118 to communicate with Motion Sensor Array 158 which is connected to peripherals interface 111 to detect when the user has turned their head and to manipulate the video feed to adjust itself to appear as though it is moving in the opposite direction that the user is moving their head. Thus, to the user's eyes, the video feed appears stabilized as they move like how what we see in the real world is automatically stabilized by our eyes.

At this point, it should be realized that the purpose of the camera(s) 165 is to reproduce the outside world accurately and in real time onto display(s) 109.

To those skilled in the art, it is known that the more pixels which are used to represent an image, the closer the result can resemble the original. Thus, in an embodiment of the invention where a display or displays are used which are of a high pixel per inch value, the more the video feeds obtained of the outside world can resemble exactly what the user sees with their own eyes.

In order to, reproduce the outside world accurately onto display(s) 109, we must ensure that camera(s) 165 produce the same field of view as the human eyes produce. This process will now be described.

First, this discussion will begin with a discussion about how the human eyes work. Humans, having two eyes, have what is known as binocular vision. Binocular vision is when creatures, such as humans, that have two eyes, use them together. This means that when the creature uses their eyes, both eyes simultaneously focus on whatever the creature is looking at and since they are focused on the same thing, both eyes see similar yet slightly differently angled image signals of what they are focused on. Each eye sees similar yet different image signals, due to the different position of each eye on the head.

In humans, the field of view of both eyes combined, horizontally is 200 to 220 degrees, including peripheral vision. Each eye has a front facing field of view of approximately 180 degrees independently, when the far peripheral vision is included. Far peripheral vision is the part of the vision located on the far side of the eye in which only one eye can see and the other eye cannot see. FIG. 19 illustrates the field of view of the left eye 202. FIG. 20 illustrates the field of view of the right eye 203. The forward facing visual field or field of view of each eye independently is approximately 120 degrees, excluding the far peripheral vision. In FIG. 20, the 120 degree forward facing field of view of left eye 202 is located within the area between the 60 degree mark on the left side of FIG. 20 and the 60 degree mark on the right side of FIG. 20. In FIG. 3C, the 120 degree forward facing field of view of right eye 203 is located within the area between the 60 degree mark on the left side of FIG. 20 and the 60 degree mark on the right side of FIG. 20.

The fact that binocular vision uses both eyes and obtains similar yet different image signals from each eye, means that there is a degree measure in which both eyes are able to see. This 120 degree area which makes up the forward facing visual field of field of view in humans is known as the area where binocular vision occurs. Therefore, this is the area in which both eyes are able to see. 60 degrees of this 120 degree area are dedicated to the central area that the eye is focusing on. This means that 60 degrees of the field of view of human eyes constantly see the same things. The other 60 degrees included within the 120 degree area are dedicated to mid peripheral vision, which is all of the vision which is visible to the eye outside of the central area that the eye is focusing on.

Thus, when the left eye 202 and the right eye 203 see similar image signals and send these similar yet somewhat different image signals to the brain, the brain merges or overlaps the similar yet differently angled image signals that have been received into one image, creating our field of view. The fields of view of the left and right eye merging to create our field of view is illustrated in FIG. 21. In FIG. 21, the field of view of the left eye 200 outlines the degrees and field of view in which left eye 202 sees, and the field of view of the right eye 201 outlines the degrees and field of view in which right eye 203 sees. It should be noted that the lines that make up the field of view of the left eye 200 do not rest directly on top of the lines that make up the field of view of the right eye 201 and the lines that make up the half circle graphic that illustrates the field of view of the eyes, so that they can be differentiated from those lines. The lines that make up the field of view of the left eye 200 should be considered to rest directly on top of the lines that make up the half circle graphic that illustrates the field of view of the eyes and the field of view of the right eye 200.

FIG. 21 along with 200 and 201 as a whole are used to illustrate the merging or overlapping in which the brain performs when similar yet different image signals are received from left eye 202 and right eye 203 to form human's field of view. After the brain merges the 60 degrees of the field of view from left eye 202 and the 60 degrees of the field of view from the right eye 203, the resulting field of view measures 60 degrees, which is illustrated in FIG. 21. The merging or overlapping of image signals is referred to as stereoscopy or stereoscopic vision.

Therefore, if two camera(s) 165 with a 60 degree angle of view are used to each display a video feed from each camera onto display(s) 109, camera(s) 165 would capture a combined field of view of roughly 60 degrees. This accurately emulates the field of view in which human's see, excluding the mid and far peripheral vision.

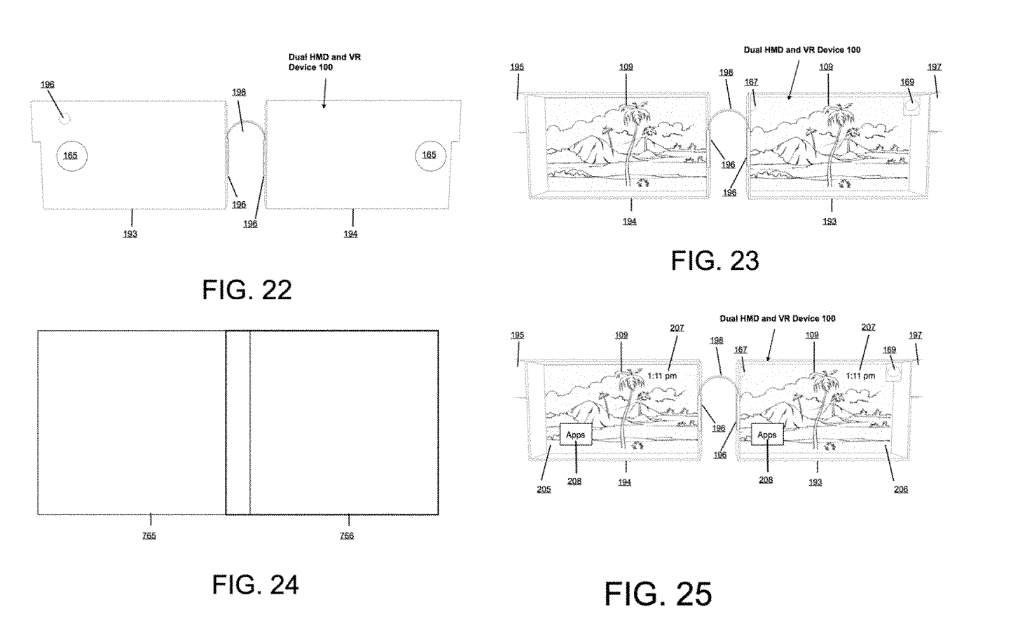

It should be noted that the field of view in which the device offers relies fully on the specification of the cameras. Thus the field of view can be less or more than what has been stated and can include the mid and far periphery if desired. The field of view of the camera(s) 165, in some embodiments, can affect the positioning of the camera(s) on Dual HMD and VR Device 100. In a non limiting example of a potential embodiment, if two 180 degree, fisheye style cameras were used on Dual HMD and VR Device 100, so that they could capture a large field of view, the device could be manufactured so that the camera(s) 165 Dual HMD and VR Device have more distance between them, as long as it is ensured that the fields of view of each camera slightly intersect, rather than being distanced away from each other only the pupillary distance in humans which is 62-64 mm. A non limiting example of this is shown in FIG. 22, notice the distance between camera(s) 165. FIG. 23 is a view of what is seen in each camera's field of view is shown on display(s) 109 for the embodiment of these two cameras, notice that since they are correctly positioned so their fields of view slightly intersect what the user sees in their field of view is flawless with no visual imperfections or inconsistencies.

As previously mentioned in this disclosure, camera(s) 165 can refer to either multiple cameras or a single camera. When Dual HMD and VR Device 100 is a single camera embodiment, software or instructions are included within Camera Feed Module 119 which include instructions to manipulate the real time video feed that is captured by the single camera to generate two similar but different views of the real time video feed to be shown to each eye, instructions to adjust the cameras (example: zoom), instructions to display each view generated from the single camera video feed on a separate display.

FIG. 24 serves to illustrate how the live video feed is separated into two separate but intersecting field's of view so that each view is shown on a separate display included in display(s) 109 and still creates a flawless field of view for the user. Square 765 is from the left most camera, square 766 is from the right most camera, and the section where they overlap is where their field of view intersects. Since in the region of intersection, both views show the same or similar view when they are displayed on display(s) 109, the image merging power of the brain works to merge the images into one flawless scene.

It should be noted that in some embodiments, software or instructions are included within Camera Feed Module 119 to display each view taken from the single camera video feed on a display of display(s) 109 which relates to each field of view's position. A non limiting example of this would be, that a view taken from the left most area of the field of view in which the single camera acquires would show on the display of display(s) 109 which rests in front of the user's left eye. Another non limiting example of this would be, that a view taken from the right most area of the field of view in which the single camera acquires would show on the display of display(s) 109 which rests in front of the user's right eye.

Graphics Module 143 works with Operating System 116 and with the GUI Module 117 which is stored within HMD Module 125 to display graphics and a graphical user interface for the user to interact with and so that applications can be run on top of the camera feed which is shown on display(s) 109. GUI Module 117 contains software or instructions to show an identical view of the Operating System's 116 graphical user interface or graphics, on top of each camera feed which appears as a result of the Camera Feed Module 119 on each display of display(s) 109.

FIG. 25 shows a non limiting example of an identical GUI which comprises current time 207 and application button 208 layered over video feed 205 and video feed 206 which are a result of camera(s) 165, HMD module 125, and camera feed module 116 on display(s) 109.

The emphasis on identically and accurately positioning the GUI on both screens, is so that when the brain receives image signals from the eyes and merges what is displayed on screen, the GUI will be represented clearly without any issues within the user's field of view.

Now that it is understood, that the Operating System's 116 graphical user interface or any graphics, are shown identically on top of each camera feed which appears as a result of the Camera Feed Module 119 on each display of display(s) 109, only one side of Dual HMD and VR Device 100 will be shown on each drawling at a time, to allow the features of the drawings to be shown in a higher amount of detail. Therefore, when looking at these drawings, it is understood that the exact same thing is being shown on the display which is a part of display(s) 109 which is located opposite side of Dual HMD and VR Device 100 that is not being shown.

GUI Module 117 has software or instructions to position the GUI of Operating System 116 along the z-axis so it appears to be floating in front of the user and is not blocking or obtruding their view in anyway. Simply put, the operating system's GUI layers on top of the video feed to allow unobtrusive interaction with applications and other forms of content shown on display(s) 109 which may be included in the Memory 101, Operating System 116, Applications 135 and the like, that can run while still allowing the user to be able to see.

In order to achieve this, GUI module 117 has software or instructions to work in unison with Graphics Module 143 and Operating System 116 to add transparency or opacity to applications, GUIs, images, videos, text, and any object that can be displayed to the user shown on the display(s) 109 to allow the users to be able to see the outside world while performing tasks.

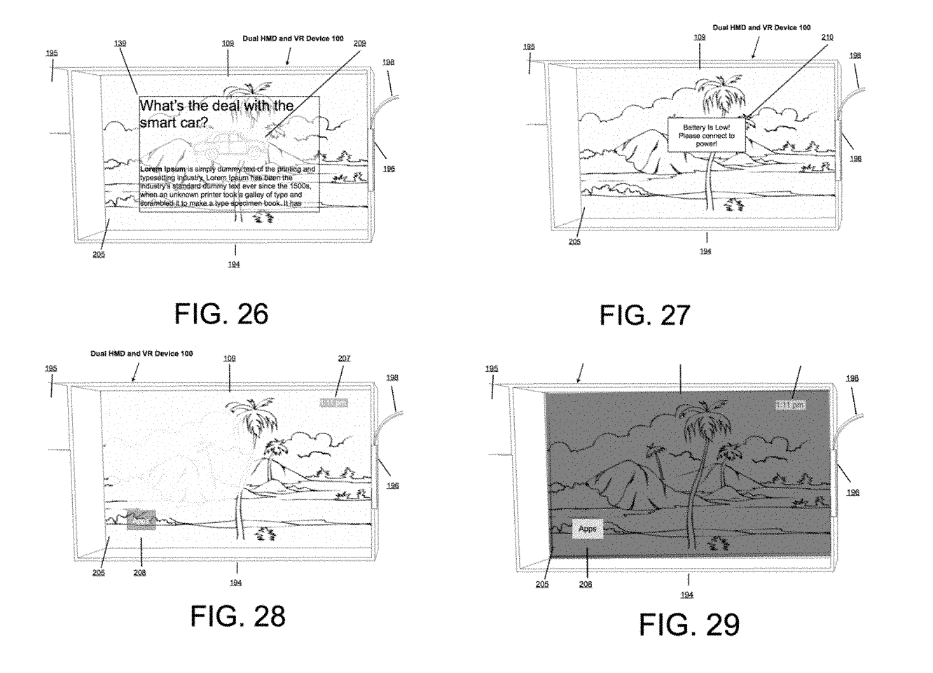

A non limiting example of how this feature works, is Browsing Module 139, which is stored as an application within Applications 135 on the device. Browsing Module 139 contains software or instructions to work in unison with GUI Module 117 and Graphics Module 143 render all webpage backgrounds to be transparent, and to render images to have varying levels of transparency, thus allowing the user to still be able to see the outside world while browsing the web, as shown in FIG. 26. In FIG. 26 the user is using Browsing Module 139 to read a blog post that is on the internet. If one looks closely at Browsing Module 139 it is clear that the background of browsing module 139 is just transparent enough that the video feed 205 can still be seen. Image 209, which is a car for sample purposes, is clearly somewhat transparent as you can see the trunk of the palm tree which is a part of video feed 205 when focusing on image 209.

It should be noted that not all objects displayed by GUI module 117 or Graphics Module 143, will be transparent or opaque. Some objects may have solid backgrounds, as shown in FIG. 27. FIG. 27 shows alert box 210, which clearly has a solid background and is alerting the user of a low battery.

Software and instructions are also stored with in GUI Module 117 to transmit a signal to the light sensor controller 153, to periodically obtain data on the lighting conditions of the outside environment from light sensor(s) 156 and for light sensor controller 153 to send the data obtained from light sensor(s) 156 on the lighting conditions of the outside environment back to the GUI module 117. Once GUI module 117 receives data about the lighting conditions of the outside environment, software and instructions within GUI module 117 changes the color scheme of the GUI depending on the lighting of the outside environment; the GUI's color scheme will become darker in a bright environment and lighter in a dark environment.

In a non limiting example, FIG. 28, shows that video feed 205 has a lot of saturated bright light towards the left and coming near the center of display(s) 109. This could potentially be the result of the user being in an area of the environment which is filled with bright sunlight. GUI module 117 has received data about the lighting conditions of the outside environment, from light sensor(s) 156 and light sensor controller 153. Software and instructions stored within GUI module 117 have changed the color scheme of the example GUI which comprises current time 207 and application button 208, to have white fonts on shaded semi-transparent backgrounds so that the GUI items are able to be seen even when bright light is penetrating the outside environment captured by camera(s) 165 and displayed on display(s) 109 by use of software and instructions stored in HMD Module 125 and Camera Feed Module 119.

In a non limiting example, FIG. 29, shows that video feed 205 is showing a lot of darkness onto display(s) 109. This could potentially be the result of the user being in an area of the environment that is dark or getting dark, such as the beginning of night fall or the rapid turn over from a clear sky to a dark sky when a severe storm is impending. GUI module 117 has received data about the lighting conditions of the outside environment, from light sensor(s) 156 and light sensor controller 153. Software and instructions stored within GUI module 117 have changed the color scheme of the example GUI which comprises current time 207 and application button 208, to have black fonts on white shaded semi-transparent backgrounds so that the GUI items are able to be seen even when darkness encompasses the outside environment captured by camera(s) 165 and displayed on display(s) 109 by use of software and instructions stored in HMD Module 125 and Camera Feed Module 119.

GUI module 117 also contains software or instructions to dispatch the data that it receives from the light sensor(s) controller 156 and light sensor(s) 153 in regards to the lighting conditions of the outside environment to the display(s) controller 150 which changes the brightness of the display(s) 109 in accordance with the lighting conditions of the outside environment at the same rate in which the human eye adjusts itself to light. This is done to aid in preserving the health of the eyes.

Using Camera(s) 165 allows the implementation of Image Processing Module 120 which is included in HMD module 125, which serves the purpose of allowing HMD applications can be specially configured to access the Image Processing Module 120 to process images and video, returning data to the user. This data returned to the user is displayed on the display(s) 109. This process will now be described.

Image Processing Module 120 includes software(s) or sets of instructions that look for details or specific items that are within the real time video feed that result from Camera Feed Module 119 and Camera(s) 165, when applications which are specially configured to access Image Processing Module 120 request that a specific detail or item is to be searched for. It should be noted that in this discussion “images” are defined as anything that can be classified as or are image(s), video(s), or graphic(s). Once Image Processing Module 120 detects the specific detail or item from the video feed that is a result of Camera Feed Module 119 and Camera(s) 165 Image Processing Module 120 processes the detail or item by accessing a library or database that is located within the application that has sample images which consist of various details or items that have a value or string of data attached to them. Image Processing Module 120 works in unison with the application to determine which sample image the detail or item retrieved from Camera Feed Module 119 and Camera(s) 165 most closely resembles and then once the detail or item is matched to a sample image in the library or database the application which originally requested the image processing, display(s) the value or string of data attached to the item or detail on display(s) 109. In some embodiments, the library or database that is stored in the application, is not stored in the application, rather it is stored in a server, cloud, and or the like which is accessed by the application over the internet, intranet, a network or network(s), and the like.

In a non limiting example, an HMD application exists on Dual HMD and VR Device 100, which contains software(s) or instructions to constantly run in the background, accessing Image Processing Module 120 and instructing it to recognize when the video feed that is a result of Camera Feed Module 119 and Camera(s) 165 stays fixated on an object bearing a product label for a few seconds or more. After this time increment passes, the HMD application in conjunction with Image Processing Module 165 searches a library or database stored on the internet which contains sample images of various product labels which have a string or value attached to them which contains alternate prices for the item at other marketplaces or stores.

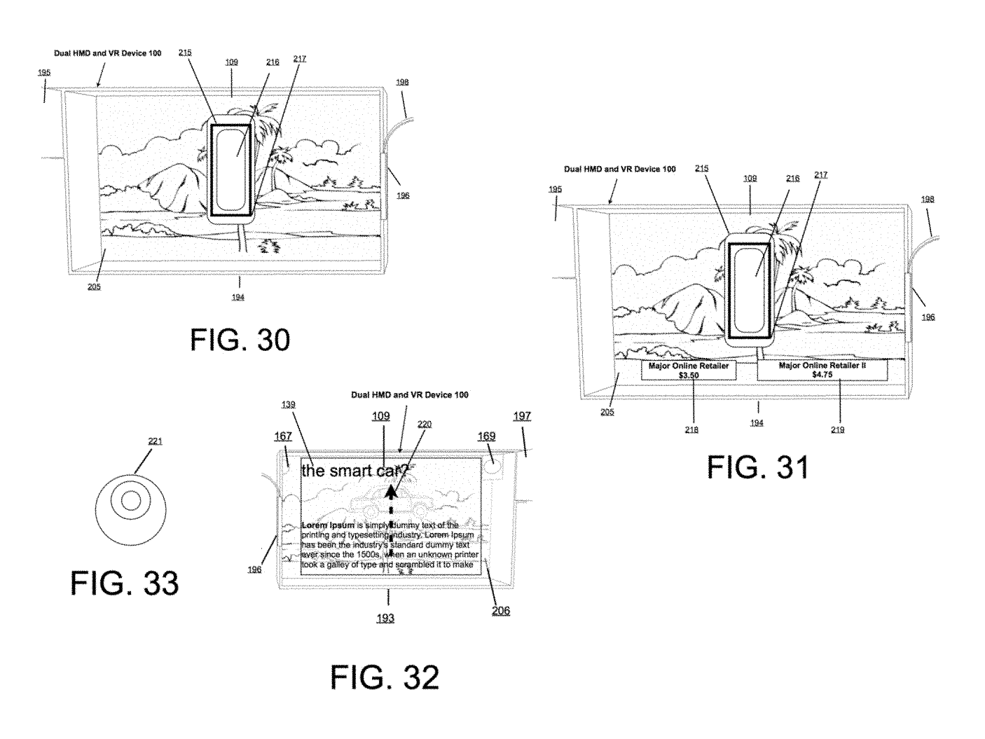

FIG. 30 shows product 215 which contains a label 216 that appears within the video feed that results from Camera Feed Module 119 and Camera(s) 165 that is displayed on display(s) 109. The HMD application which is running in the background detects the label 216 on product 215, and shows the user that it has detected the label 216 by generating box 217 and displaying box 217 on top of the video feed, encompassing the area of the video feed which contains the product label.

Once the acquired image or video file of the label from the outside world is matched with a sample image within the database, the string or value containing alternate prices for the item at other marketplaces or stores are retrieved by the HMD application from the internet and then displayed on display(s) 109.

FIG. 31 shows the alternate prices of product 215, alternate price 218 and alternate price 219, which were retrieved using the process described above onto display(s) 109 on top of the video feed that results from Camera Feed Module 119 and Camera(s) 165. In some embodiments, box 217 may not be used. The device, Dual HMD and VR Device 100 simply may detect objects and data without needing to put a box around detected objects and data.

It should be noted that the libraries or databases can be already existing libraries or databases which are used as they are or adapted for use with the Dual HMD and VR Device 100 or these libraries or databases can be custom created for the specific application by developers and stored either within the application or over the internet, intranet, a network or network(s), and the like to be accessed by the application.

By now it has likely been recognized that the discussion of the disclosure thus far has discussed the hardware components, some software components, and how the HMD aspect of Dual HMD and VR Device 100 works. The VR aspect is stored in within Dual HMD and VR Device 100 in Applications 135 within Memory 101. The Dual HMD and VR Device 100, when turned on, is in the HMD aspect of the device. The VR aspect is launched by the user launching the VR aspect of the device by launching it from within applications 135 while in the HMD aspect of the device. The process of accessing and launching the VR aspect of the device will be described in more depth later on within this disclosure.

The discussion will now turn to the various methods of interacting with controlling the device and how software and hardware components work in unison to establish these methods.

Iris movements and blinks of the eyelids can be used to control or interact with objects, graphics, user interface(s) and the like that are shown on display(s) 109. The hardware and software components and how they work together to allow iris movements to be used as a control method will now be described.

Iris Control Module 122, contained in Memory 101, contains software or instructions to send a signal to Optical Sensor(s) Controller 151 to constantly access Optical Sensor(s) 164, which are positioned so that they clearly see the users eye, to obtain a real time video feed of the user's eye. Iris Control Module also contains software or instructions to power on supplementary light source for optical sensor(s) 157 to flood the area with light that cannot be seen by the human eye to make sure the Iris of the eye is clearly visible. Optical Sensor(s) Controller 151 transmits the video feed obtained by Optical Sensor(s) 164 to Iris Control Module 122. Iris Control Module 122 contains software or instructions to analyze the obtained video feed and to locate where the user's Iris is. Once located, Iris Control Module 122 then contains software or instructions to track and detect how the Iris moves (by the user moving their eye around), software or instructions to analyzed the obtained video feed to detect when eyelids blink or remain closed, and software or instructions to turn iris movement and closes and blinks of the eyelids into ways of controlling or interacting with on screen content. In some embodiments, additional instructions are included in Iris Control Module 122 to allow a button on the Dual HMD and VR Device 100 be able to be pressed to activate or deactivate Iris Control Module 122, so the user can move their eyes without having to worry about accidentally triggering a device function or interacting with what is shown on display(s) 109 if the user does not intend to. This also avoids constant tracking of the Iris which could potentially not be energy efficient.

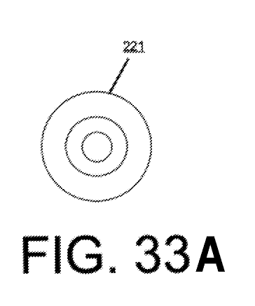

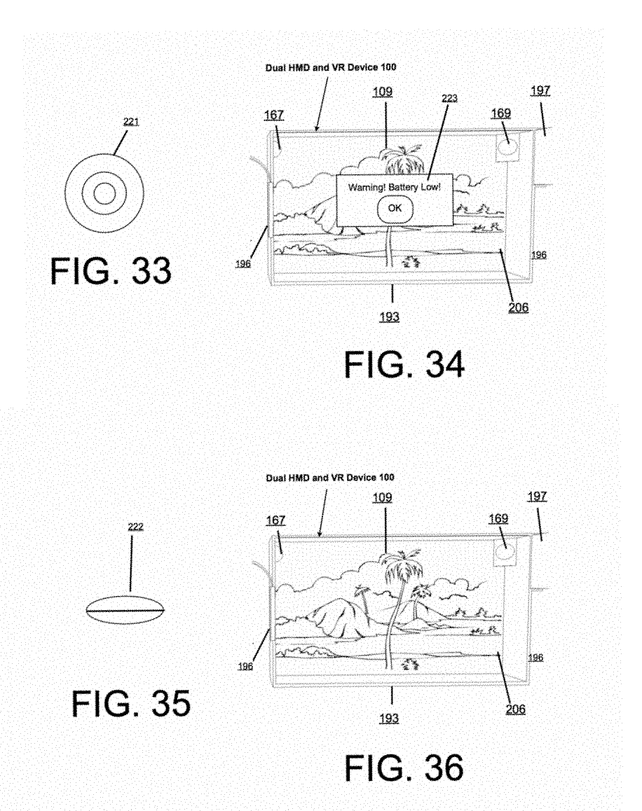

A non limiting example of using Iris movements to control what is shown on display(s) 109 is to scroll content left or right, or up or down. FIG. 32 shows browsing module 139, which will be used in this example. FIG. 33A shows the eyeball of user who is wearing Dual HMD and VR Device 100. FIG. 33 shows the user moving their eyes 221 upwards. Optical Sensor(s) 164 realizes that the user has moved their eyes 221 upwards and begins to transmit the video feed obtained by Optical Sensor(s) 164 to Iris Control Module 122. Iris Control Module 122 then detects and tracks the movement of the Iris and then translates the movement into scrolling the content in browsing module 139 upward, as shown in FIG. 32. Dashed arrow 220 in FIG. 32 is to illustrate the upwards movement of the content in response to the eye's movement. It is apparent, by comparing the browsing module 139 in FIG. 26 and the one in FIG. 32 that the content did move due to the user moving their eyes 221 upward.

A non limiting example of using the closing and movement of eyelids to control what is shown on display(s) 109 is to interact with a dialog box 223, like the one in FIG. 34, while the user has their eyes 221 open, as the user does in FIG. 33. An integrated aspect of Operating System 116 could be that blinks detected by Iris Control Module 122 could indicate a “Yes” or “OK” when dialogue boxes are shown on display(s) 109 while a user blinks.

FIG. 35 shows the user's eyelids 222 in a closed or blinking position. Optical Sensor(s) 164 realizes that the user has closed or blinked their eyelids 222 and begins to transmit the video feed obtained by Optical Sensor(s) 164 to Iris Control Module 122. Iris Control Module 122 then detects that the user has blinked or closed their eyelids 222. In response, Iris Control Module 122 contains software or instructions to communicate with Operating System 116, alerting it that the user has said “OK” to the dialog box. In response, Operating System 116 contains software or instructions to remove the dialog box from the screen as shown in FIG. 36.

In some embodiments, Iris Control Module 122 contains software or instructions to be activated automatically without prompting by the user, in embodiments that require the user to prompt the Iris Control Module to activate by using a button to activate or deactivate it, so that the user can quickly interact with on screen objects.

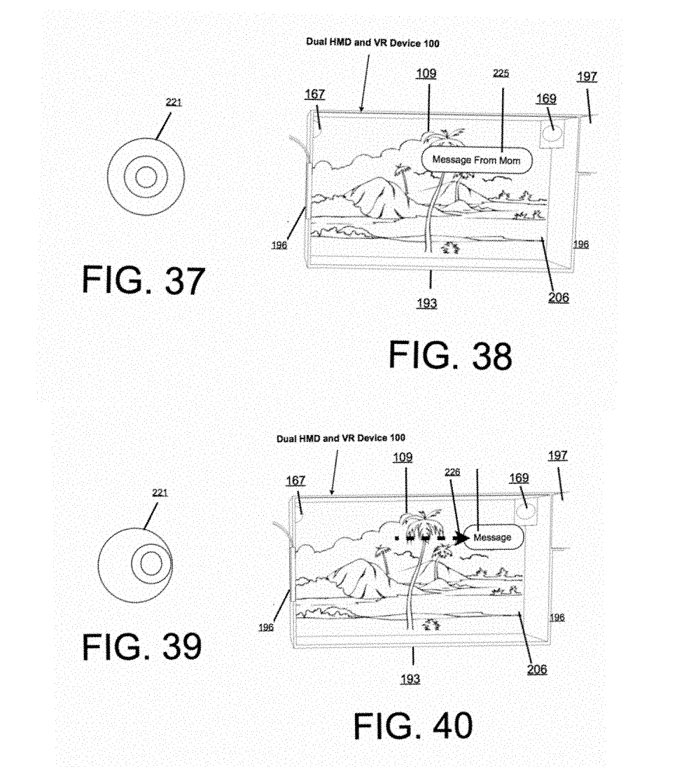

A non limiting example of automatic activation of Iris Control Module 122 is when a notification is received by the device, such as notification 225 in FIG. 38, the Notifications Module 138 contains a set of instructions to activate Iris Control Module 122 so the user can move their eyes left or right to open the notification that has just appeared. FIG. 37 and FIG. 38 shows the notification 225 appearing and the user's eye 221 in a normal position. As shown in FIG. 39 and FIG. 40, when the user moves their eyes 221 to the right, Optical Sensor(s) 164 realizes that the user has moved their eyes 221 to the right and begins to transmit the video feed obtained by Optical Sensor(s) 164 to Iris Control Module 122. Iris Control Module 122 then detects and tracks the movement of the Iris and then translates the movement into moving the notification 225 to the right. The movement of notification 225 in the right direction is illustrated by dashed arrow 226. Once notification 225 is moved to the right and is no longer shown on the screen, the message that notification 225 was alerting the user about, would then appear on screen.

Once the user interacts with the notification, Iris Control Module 122 deactivates. Notifications and Notifications Module 138 will be described later on in the disclosure.

Spoken words or commands by the user can be used to control the device or interact with objects, graphics, user interfaces, and the like shown on display(s) 109. The hardware and software components and how they work together to allow spoken words or commands by the user to be used as a control method will now be described.

Voice Recognition Module 123, which is contained in Memory 101, contains software or instructions to allow the user to push a button to activate Voice Recognition Module 123 and software or instructions to send a signal to Audio Circuitry 106 to activate microphone 108 when a button is pressed to activate Voice Recognition Module 123. Once the command or phrase is spoken, Voice Recognition Module 123 translates the human audible sound waves that are a result of the user speaking the command or phrase into electrical signals and transmits these signals to Microprocessing Units 112 to carry out the command or interaction with the Dual HMD and VR Device 100.

A non limiting example of this feature, is a user pushing button 191 which is shown in FIG. 3 to activate Voice Recognition Module 123. After the user says “View My Address Book” Voice Recognition Module 123 sends the request by way of electronic signals to Microprocessing Unit(s) 112. Microprocessing Unit(s) 112 launch the address book and displays address book 227 on display(s) 109, as shown in FIG. 10.

Notifications Module 138 displays various notifications on display(s) 109 on Dual HMD and VR Device 100. This is a result of notifications module 138 working in conjunction with various applications installed on the device, which dispatch notifications to notifications module 138 to display the notifications on display(s) 109. This process will now be described.

First, “notifications” will be defined. Notifications can be text based alerts or alerts that include text and images. Notifications may be accompanied by a sound or alert tone when notifying the user. Notifications are alerts which notify the user of something that is occurring, either an application event such as the user's high score being beaten in a VR game or a non application event such as an AMBER alert. These examples, should be considered non limiting.

Notifications Module 138 contains software or instructions to receive notifications that are transmitted to Notifications Module 138 from applications which are stored in application 135 within memory 101 of Dual HMD and VR Device 100 or from the Operating System 116. When an alert is transmitted from an application to Notifications Module 138, it is being transmitted via a software based algorithm or other means which involves the transmission of data to the notifications module 138. Once the notification is received by notifications module 138, notifications module 138 contains software or instructions to work with Graphics Module 143 and GUI Module 117 and Operating System 116 to generate a notification dialog box with the text and image of the notification, to display the notification on display(s) 109 either layered over top of the video feed provided by camera feed module 119 and camera(s) 165 or over a graphical virtual world or real life virtual world, and to allow the user to use any one of the aforementioned user input, control, or interaction methods to interact with the notification to either close the notification or to open the application in which the notification is sent from.

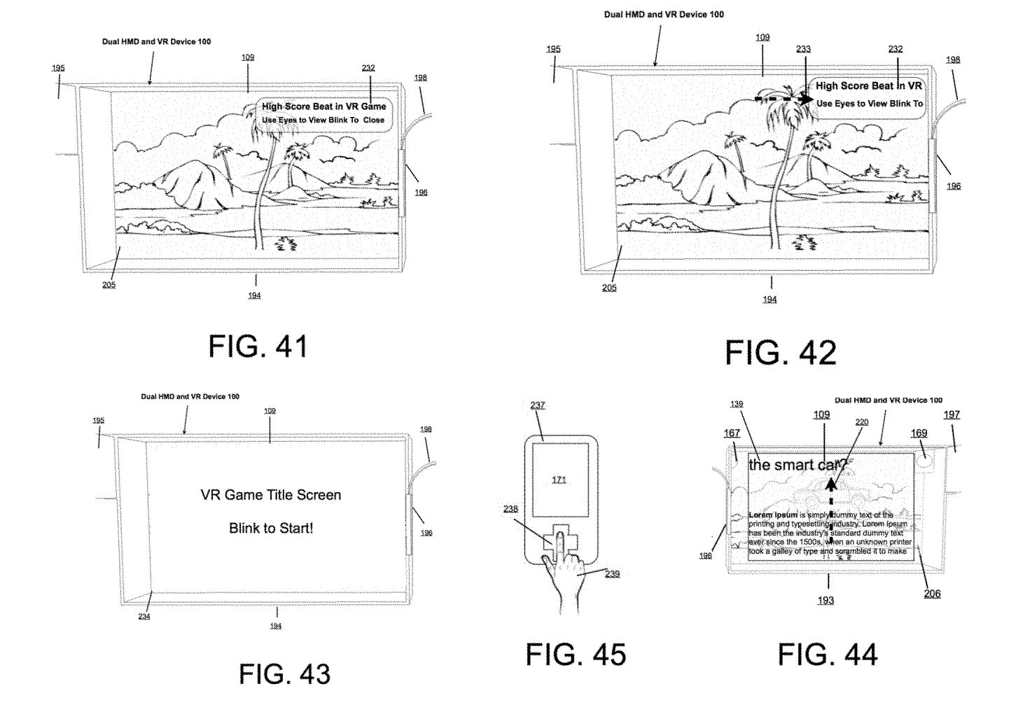

A non limiting example of this is shown in FIG. 41 As seen in FIG. 41, a notification 232 is layered over the video feed provided by camera feed module 119 and camera(s) 165 on display(s) 109 saying that the user's current high score in the VR aspect of the device has just been beat.

Since the VR aspect of the device is an application or set of applications within the device as previously disclosed, the notification 232 instructs the user to activate iris movements and move their eyes to launch the application or to blink to close the notification 232. In FIG. 42, the user moves their eyes to the right, and the notification 232 begins to move off screen. Once the notification is completely off screen, the VR game application 234 launches as shown in FIG. 43.

It should be noted that notifications can use any one of the previously mentioned methods and methods that will be mentioned later on in this disclosure to control or interact with the device to interact with notifications.

Speciality application for handset 171, is another aspect of the invention which is an application that when downloaded and installed onto a Bluetooth (registered trademark) enabled handset that is connected to Dual HMD and VR Device 100 wirelessly via a connection that is established between the handset using the handset's RF circuitry and the device's 100 RF circuitry 108, adds additional methods for the user to interact with or to control Dual HMD and VR Device 100. When it is discussed that a Bluetooth (registered trademark) enabled handset is connected to Dual HMD and VR Device 100, it is connected via Bluetooth (registered trademark) tethering as it has been stated earlier in the disclosure that Bluetooth (registered trademark) is included within RF circuitry 108 within Dual HMD and VR Device 100. When Speciality application for handset 171 is installed onto a Bluetooth (registered trademark) enabled handset which is connected to Dual HMD and VR Device 100 the Speciality application for handset 171 works in conjunction with the Interactions with Connected Handset Application Module 129 stored within memory 101 on Dual HMD and VR Device 100 as well as other modules or items which are a part of memory 101 on Dual HMD and VR Device 100. This application, how it works with Dual HMD and VR Device 100 and the additional methods in which it provides for the user to interact with or control Dual HMD and VR Device 100 will now be described.

Speciality application for handset 171 works in conjunction with handset user input method(s) interaction module 131 which is stored in memory 101 on Dual HMD and VR Device 100 to allow a handset's user input, control, or interaction methods to become methods of controlling or interacting with Dual HMD and VR Device 100. This process will now be described.

Speciality application for handset 171, which is downloaded or installed onto a connected Bluetooth (registered trademark) handset, contains software or instructions to transmit when a user presses a button or button(s) on the connected handset, triggers a sensor or sensor array with in the handset (non limiting example: motion sensor such as accelerometer), or taps, swipes, touches, uses a multi touch gesture, or uses any method that includes interacting with a touch screen or touch sensitive surface that may be included as part of the connected handset, to the handset user input method(s) interaction module 131 which is stored in memory 101 within Dual HMD and VR Device 100 via the Bluetooth (registered trademark) connection that has been established between the handset and Dual HMD and VR Device 100. Once the method in which the user is interacting with the connected handset is transmitted to the handset user input method(s) interaction module 131, handset user input method(s) interaction module 131 translates via software or instructions contained within handset user input method(s) interaction module 131 the method that the user is using to interact with the connected handset into a method of controlling or interacting with Dual HMD and VR Device 100.

In a non limiting example, FIG. 45 shows a connected Bluetooth (registered trademark) enabled handset 237 with speciality application 171 open, where a user 239 is pushing an up button on a four way directional pad 238 on the Bluetooth enabled handset 237. Speciality application 171 transmits this interaction over it's connection to Dual HMD and VR Device 100 via Bluetooth to handset user input methods interaction module 131 which is stored on Dual HMD and VR Device 100 within the interactions with application installed on connected handset module 129. Handset user input methods interaction module 131 translates this movement into scrolling content which is shown on display(s) 109 in the upwards direction as shown in FIG. 12A. In FIG. 44 dashed arrow 220 illustrates the content scrolling upwards as a result of the user 239 pushing the up button on the four way directional pad 238 on the connected, Bluetooth enabled handset 237.

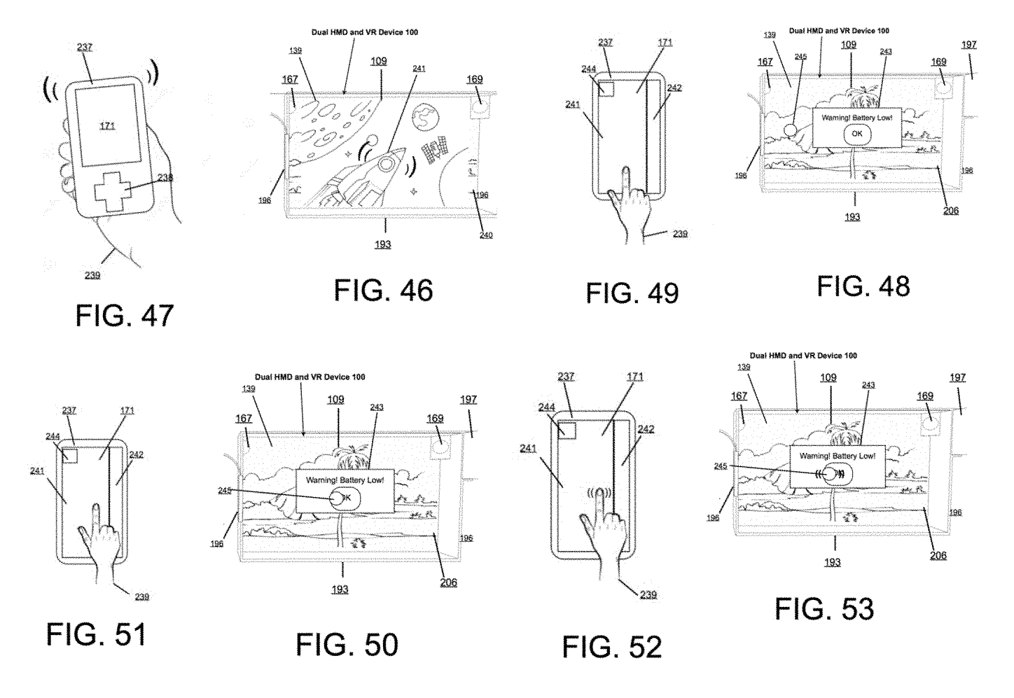

Another non limiting example is a connected Bluetooth (registered trademark) enabled handset with speciality application 171 open, as shown in FIG. 47. In FIG. 47 the handset has motion sensors within the handset 237. The user is moving the handset back and forth while playing a VR game 240. Speciality application 171 transmits this interaction over it's connection to Dual HMD and VR Device 100 via Bluetooth to handset user input methods interaction module 131 which is stored on Dual HMD and VR Device 100 within the interactions with the VR game 240 installed on connected handset module 129. As shown in FIG. 46, Handset user input methods interaction module 131 translates this movement into moving an object, rocket ship 241 in which the user is interacting with, within the VR game back and forth. This, and other VR control methods will be discussed later on in the disclosure when the Virtual Reality Module 126 is discussed.

Handset user interaction module 130, contains software or instructions to detect if the connected handset has a touch screen. If the connected handset does have a touch screen, Operating System 116, Graphics Module 143, and GUI Module 117 work together to generate a cursor which is shown on display(s) 109 in FIG. 48. As shown in FIG. 48, this cursor 245 typically is circular or a circle, but in some embodiments this cursor may be an arrow style cursor.

Speciality application for handset 171, as shown in FIG. 49 is split into two sections. One section 241 is for the user to use their finger to move and select items with the cursor by dragging their finger on the display and tapping. When it is detected that the user is using this method to control on screen content, handset user input method(s) interaction module 131 translates via software or instructions contained within handset user input method(s) interaction module 131 into a method of controlling or interacting with the device.

In a non limiting example, FIG. 50 and FIG. 51 shows the user using the connected handset to move the cursor 245 shown on display(s) 109 to the dialog box 243 shown on display(s) 109. In FIG. 52 and FIG. 53 When the cursor reaches the button within the dialog box 243, the user presses the touch screen surface with their finger to press the “OK” button on the dialog box 243. Once “OK” is pressed, dialog box 243 closes.

The second section 242 is for the user to drag their finger on to scroll content. When it is detected that the user is using this method to control on screen content, handset user input method(s) interaction module 131 translates via software or instructions contained within handset user input method(s) interaction module 131 into a method of controlling or interacting with the device. The reason why two areas are allocated one for using the cursor and one for dragging, is because when one uses a touch screen to move objects, such as a cursor, contact isn't broken with the touch screen while moving the object around. Whereas with scrolling, contact is broken with the screen each time one scrolls and sometimes it takes multiple scrolls to scroll the content to what one would like to see. Having two areas allocated for this, makes detection of these movements easier as well.

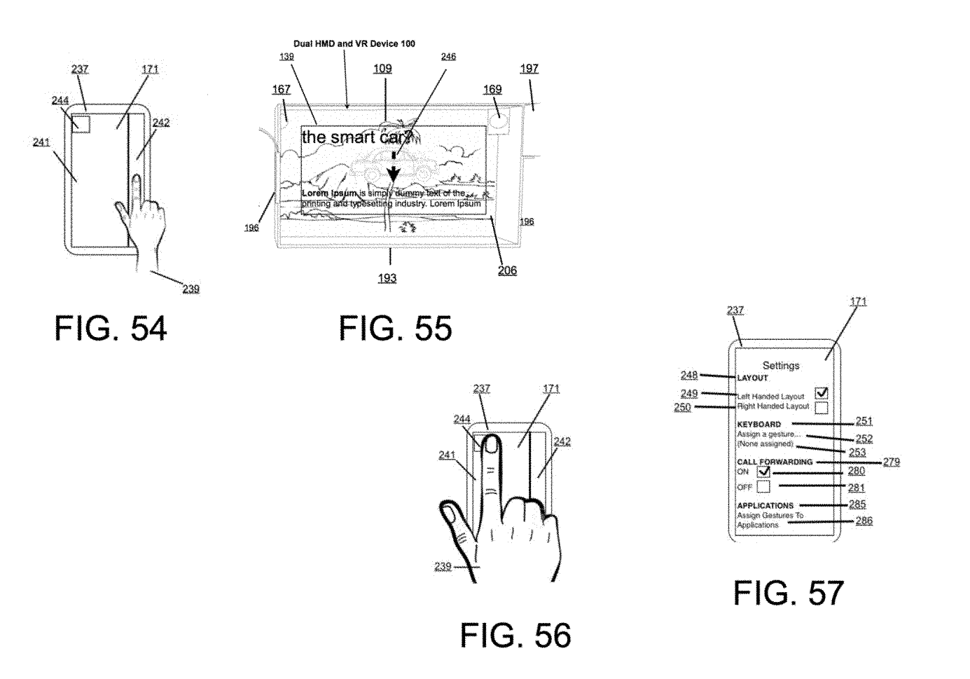

In a non limiting example, FIG. 54 shows the user dragging their finger 239 on the touch screen surface of the connected handset, to scroll content shown on display(s) 109 downward which is shown in FIG. 55. In FIG. 55 dashed arrow 246 illustrates the content in browsing module 139 being scrolled down.

The layout of speciality application for handset 171 can be changed to suit the dominant hand of the user.

As shown in FIG. 56, by tapping the settings icon 244, the settings area of specialty application for handset 171 is launched. Within the settings area of speciality application for handset 171, a user can select the layout 248 of the application that they prefer, either the left handed layout FIG. 57. In FIG. 57, check boxes are used to select which layout is used. In other embodiments, other selection methods such as switches, toggle buttons, buttons, and the like may be used.

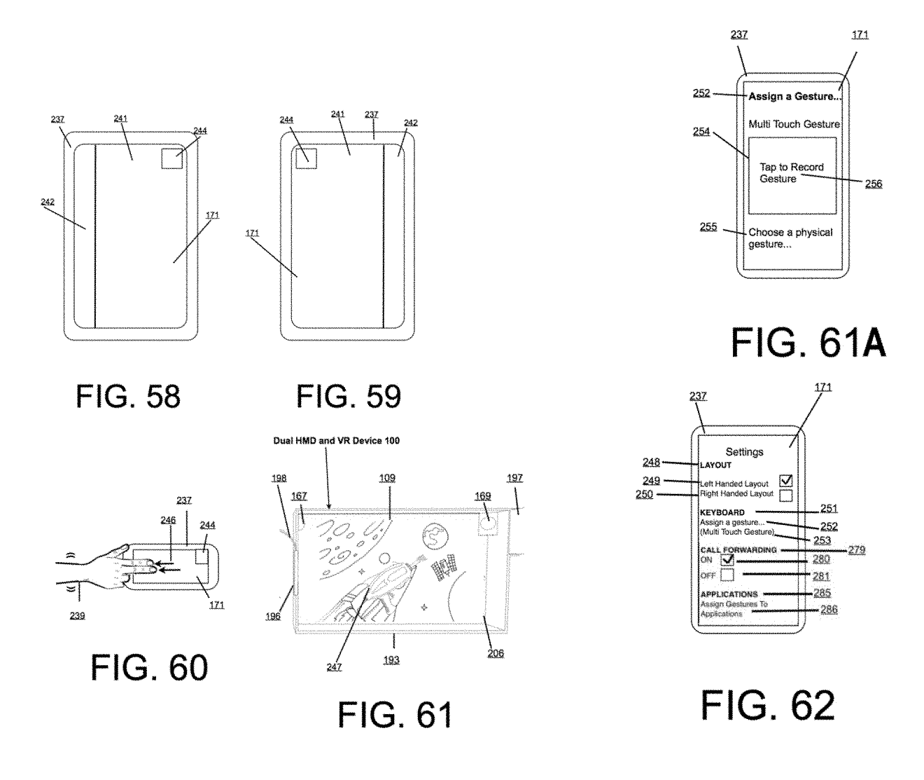

FIG. 58 shows the left handed application layout. FIG. 59 shows the right handed application layout. Each application layout comprises the following: settings button 244, section one 241, and section two 242. 237 is the number for the handset and 171 is the number of the application, speciality application for handset 171.

It should be noted that in some embodiments, this application can work when the display of the connected handset is dim or completely turned off, with the application containing software or instructions to only access the touch aspect of the display in these embodiments to translate the user's interactions with the touch screen into control methods without running down the connected handset's battery.

It should be noted that within speciality application for handset 171, multiple methods of user control and interaction with Dual HMD and VR Device 100 can be used simultaneously on a connected handset.

FIG. 60 and FIG. 61 show a non limiting example of multiple methods of user control and interaction with Dual HMD and VR Device 100 from within speciality application for handset 171 on a connected handset is: a user, while playing a VR shooter game on Dual HMD and VR Device 100, swipes their fingers 239 across the touch screen surface of the connected handset 237, in the direction arrows 246 are pointing, with speciality application for handset 171 opened as shown while simultaneously moving their arm, which is a part of 239, back and forth as shown in triggering the motion sensors which are a part of the connected handset.

Speciality application 171 contains software or instructions to transmit these simultaneous user interactions with the connected handset over the connected handset's connection with Dual HMD and VR Device 100 via Bluetooth to be received by handset user input methods interactions module 131 which is stored on Dual HMD and VR Device 100 within the interactions within the application installed on connected handset module 129 which is stored within memory 101. Handset user input methods interaction module 131 contains software or instructions to work with the VR shooter game to simultaneously translate the swipes across the touch screen of the connected handset into shots that are fired within the game, and the movements of the arm which trigger the connected handset's motion sensors to change the position of the gun which is firing the bullets in the VR shooter game shown on display(s) 109 on Dual HMD and VR Device 100 while simultaneously firing bullets by the user swiping the touch screen of the connected handset 237 in the direction shown by arrows 246.

It should have been observed that in FIG. 60, speciality application for handset 171 does not have it's normal layout. For VR gaming, speciality application for handset 171 has software or instructions to remove section one 241 and section two 242 while VR games are being played so that various user interactions can take place. The various functions, layouts, and control methods that speciality application for handset 171 provides for VR gaming will be discussed later on within this disclosure.

Speciality application for handset 171 contains software or instructions that allow the user to assign either interacting with the handset to trigger one of it's sensors or using a user input, control, or interaction method, or in some embodiments, using a multi touch gesture on the handset's touch screen display to bring up the handset's integrated soft keyboard. It should be noted that all of these user interaction methods can be referred to as “gestures.” Gesture was used in unison with Multi Touch because those skilled in the art will recognize that multi touch gestures is the phrasing that separates the act of simply touching a touch screen from the act of using multiple touches or touches in sequence to a touch screen to perform a specific function. Gestures can also be used in terms of the user physically interacting with the connected handset, such as picking up the connected handset and shaking it to trigger one of the connected handset's gestures. This is known as a physical gesture.

As shown in FIG. 56, by tapping the settings icon 244, the settings area of specialty application for handset 171 is launched. It should be noted that in some embodiments, the settings of the application are stored in the settings area within the operating system or other software which the bluetooth enabled handset has installed on it, that speciality appellation for handset 171 is launched within. Within the settings area of speciality application for handset 171, is the keyboard heading 251. This denotes that the settings beneath that heading are exclusively for regarding the handset's integrated soft keyboard and it's behaviors within speciality application for handset 171. Assign a gesture 252 can be tapped by the user to assign what gesture they want to use while in speciality application for handset 171 to bring up the handset's integrated soft keyboard.

In FIG. 61A the user has pressed assign a gesture 252 and another area appears within the settings area of speciality application for handset 171, assign a gesture 252, which allows the user to allocate either a multi touch gesture by using multi touch gesture box 254 or by choosing a physical gesture 255 as a way of bringing up the handset's integrated soft keyboard.

To allocate using a multi touch gesture for bringing up the handset's integrated soft keyboard, the user must tap, tap to record gesture 256 which is inside of multi touch gesture box 254. The user then uses their fingers and or thumbs on the touch screen surface of the connected handset to input what they would like the multi touch gesture to be that brings up the handset's integrated soft keyboard inside of multi touch gesture box 254. In some embodiments this gesture may be a single tap, multiple taps, a simultaneous multi finger tap (such as taping three fingers simultaneously on the touch screen surface of the handset), a single swipe, multiple swipes, a simultaneous multi finger swipe (such as three fingers swiping the touch screen simultaneously) and any known method or method created in the future that involves the users' fingers and thumbs interacting with a touch screen.

Software or instructions stored in speciality application for handset 171 records the multi touch gesture that the user creates. Once the multi touch gesture is created, as shown in FIG. 62, the Assign a Gesture 252 area of the settings area updates area 253, which says “(None Assigned)” to “(Multi Touch Gesture).”

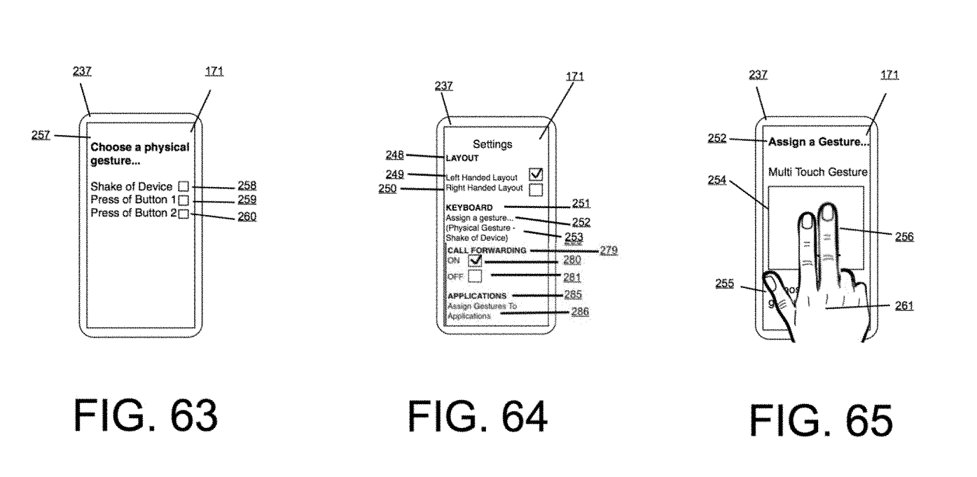

Attention is now directed back to FIG. 57. To allocate a physical gesture, for bringing up the handset's integrated soft keyboard, the user must tap choose a physical gesture 255. Upon tapping, choose a physical gesture 255, another area appears within the settings area of speciality application for handset 171 as shown in FIG. 63, choose a physical gesture 257. Software or instructions stored in speciality application for handset 171 scans and locates all of the possible buttons, user input, control, or interaction methods, and or sensors with in the handset that can be used in conjunction with speciality application for handset 171 and lists them in the choose a physical gesture 257 area of speciality application for handset 171 to bring up the integrated soft keyboard of the handset, as shown in FIG. 63. In FIG. 63, the user can choose any of the available buttons, user input, control, or interaction methods, or sensors that can be used in conjunction with speciality application for handset 171 by tapping checkboxes next to shake of device 258, press of button one 259, or press of button two 260. It should be noted that shake of device 258 is an example of a gesture that can be provided if a device has a motion detecting or tracking sensor such as a accelerometer. By shaking the device, the accelerometer would then be triggered, and as a result speciality application 171 would display the handset's integrated soft keyboard. In FIG. 63, check boxes are used to select which layout is used. In other embodiments, other selection methods such as switches, toggle buttons, buttons, and the like may be used.

Once the physical gesture is chosen, as shown in FIG. 64, the Assign a Gesture 252 area of the settings area updates area 253, which says “(None Assigned)” to “(Physical Gesture—Shake of Device).”

FIG. 65 shows the user 261 assigning a simultaneous three finger tap multi touch gesture. FIG. 65 shows the user 262 performing the simultaneous three finger tap multi touch gesture in section one 241 of speciality application for handset 171. It should be noted that in most embodiments the user will perform the multi touch gesture in section one 241 of speciality application for handset 171. However, embodiments may exist where it doesn't matter where the user performs the multi touch gesture on the touch screen, as long as speciality application for handset 171 is open, the handset's integrated soft keyboard will appear.

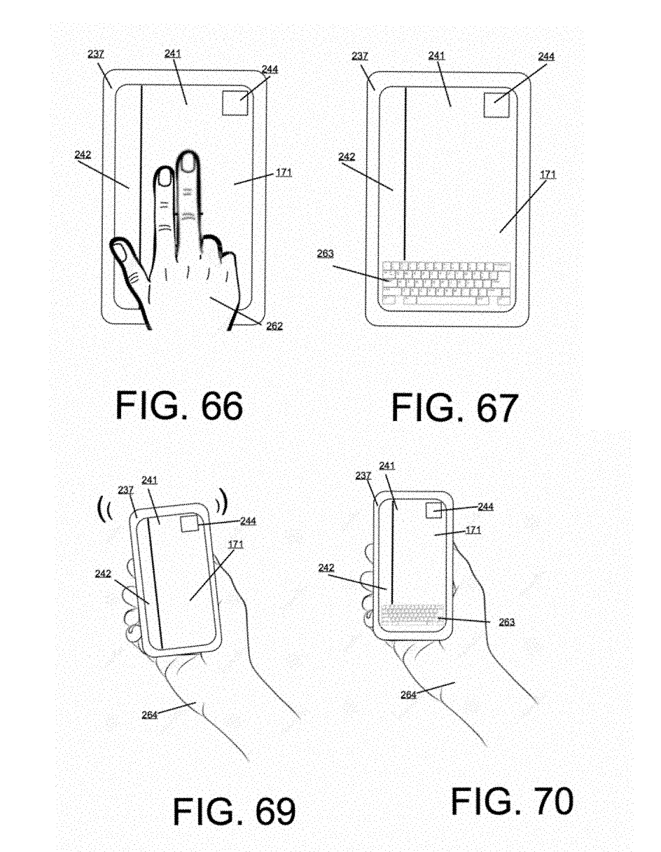

FIGS. 66 and 67 shows the handset's integrated soft keyboard 263 appearing as a result of the user 262 performing the simultaneous three finger tap multi touch gesture in section one 241 of speciality application for handset 171. It should be noted that not every handset has the same soft keyboard layout, so many embodiments will exist with different soft keyboard layouts. As shown in FIG. 68, speciality application for handset 171 allows the orientation of the integrated soft keyboard to change when the user changes the orientation of the handset, when the handset contains an integrated motion sensor or sensor array, which triggers the handset's integrated motion sensor or sensor array. Most bluetooth enabled handsets which contain a integrated motion sensor or sensor array, contain software or instructions to change the orientation of applications and items shown on the display or touch screen surface of the handset.

In an embodiment where the handset contains an integrated motion sensor or sensor array and the user has assigned shaking the handset as the gesture to bring up the integrated soft keyboard, FIG. 69 illustrates the user 264 shaking the handset. FIG. 70 illustrates the integrated soft keyboard 263 coming up as a result of the user 264 shaking the handset in FIG. 69.

As shown in the figures above, when the integrated soft keyboard comes up on the screen, the area used to use the connected handset to provide a cursor to interact with on screen objects and to provide scrolling becomes smaller due to the presence of the keyboard, however the user can use both the keyboard along with the cursor and scrolling available for them to use to control or interact with Dual

HMD and VR Device 100. This is similar to how when we use a computer, we have access to using both a keyboard and mouse, either one at a time or simultaneously.

Speciality application for handset 171 works in conjunction with text input module 131 which is stored in memory 101 and soft keyboard mirroring module 132 which is stored in interactions with applications installed on connected handset module 129 within memory 101 on Dual HMD and VR Device 100 to allow a user to use text input as a means of interacting with or controlling Dual HMD and VR Device 100 and to allow the user to be able to see where they are typing while wearing Dual HMD and VR Device 100 by mirroring the handset's integrated soft keyboard and the user's interactions with the integrated soft keyboard onto display(s) 109. This process will now be described.

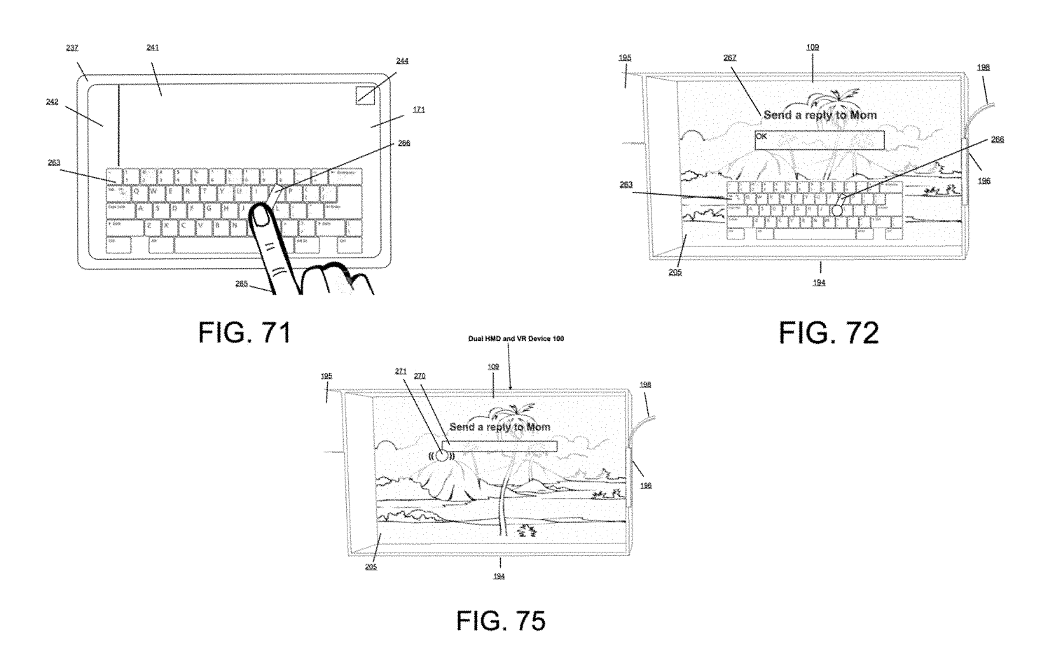

When a soft keyboard 263 is displayed on speciality application for handset 171, on a handset that is connected to the Dual HMD and VR Device 100, such as the integrated soft keyboard 263 that is open within speciality application for handset 171 as shown in FIG. 71 (FIG. 16 is an enlarged view of a bluetooth enabled handset) soft keyboard mirroring module 132 has software or instructions to transmit a mirroring of the integrated soft keyboard layout which appears in speciality application for handset 171 when the user brings up the keyboard. This mirroring would be transmitted over the connection established between Dual HMD and VR Device 100 and the connected handset to be received by soft keyboard mirroring module 132. Once the keyboard layout is shown on display(s) 109, speciality application 171 includes software or instructions to detect and track the user's thumbs or fingers as they drag them across the integrated soft keyboard displayed on the connected handset's touch screen surface to type and instructions to transmit the tracking of the user's thumbs and fingers as they drag them across the integrated soft keyboard on the connected handset's touch screen over the connection established between Dual HMD and VR Device 100 and the connected handset to be received by soft keyboard mirroring module 132.

Once received by soft keyboard mirroring module 132, soft keyboard mirroring module 132 contains software or instructions to mirror the tracking of the user's thumbs and fingers as the user taps or drags with their fingers or thumbs and or otherwise interacts with the touch screen to type on the touch screen directly on top of the soft keyboard 263 layout which is shown on display(s) 109. As shown in FIG. 71, the user 265 has dragged their finger from the O key to the K key as illustrated by the tracking line 266. In FIG. 72, tracking line 166 is shown directly over the soft keyboard 263 layout, on the exact same area it is on, on the handset's integrated soft keyboard 263 within speciality application for handset 171.

Soft keyboard mirroring module 132 contains software or instructions to transmit text or other data as it is being typed to text input module 121 which allows for text to be typed into various aspects of Dual HMD and VR Device 100, such as in applications. In FIG. 72, the letters “OK” which were typed by the user by using the integrated soft keyboard of the handset from within speciality application for handset 171, are inputted in sample messaging application 267. Text input module 121 has software or instructions that work in conjunction with software or instructions within graphics module 143 for typed text to be displayed on display(s) 109 as it is being typed.

Notice how the user can see what they are typing on the keyboard in real time, and thus they need not look down at a keyboard to enter text.

Soft keyboard mirroring module 132 also contains software or instructions to bring up a keyboard every time the user interacts with a text input area.

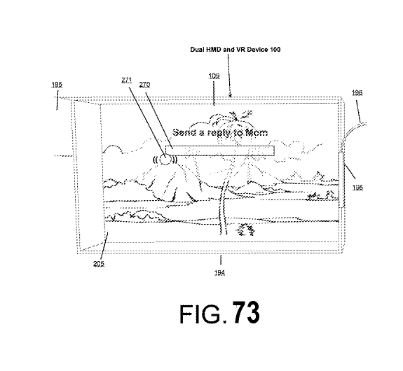

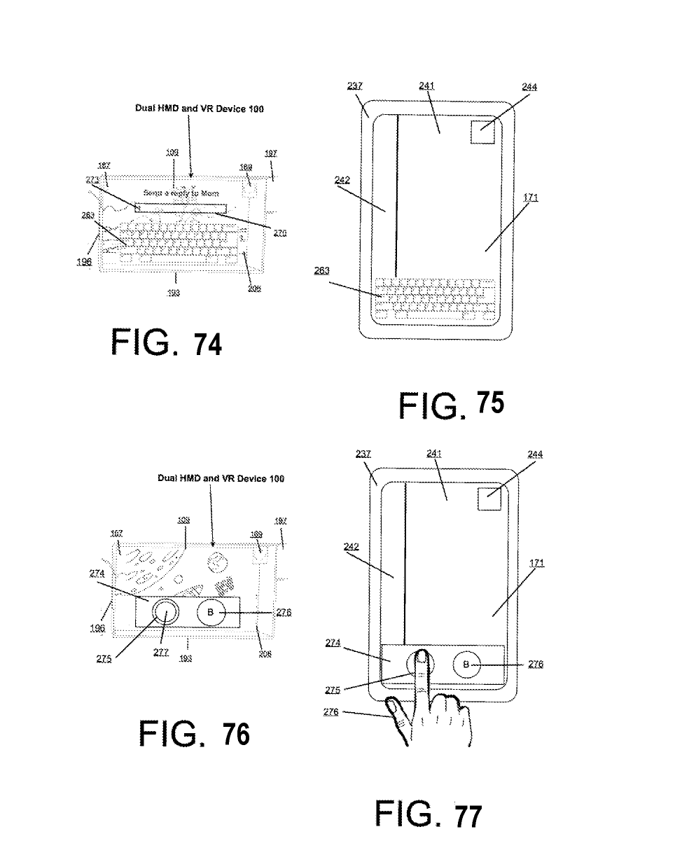

In a non limiting example, in FIG. 73 the user uses the function of the speciality application for handset 171 which provides a cursor to drag cursor 271 to text input box 270 and then taps the touch screen surface of the connected handset while speciality application for handset 171 is open, which selects text input box 270. As shown in FIGS. 74 and 77, when text input box 270 is selected, soft keyboard mirroring module 132 contains software or instructions to bring up the connected handset's integrated soft keyboard 263 within speciality application for handset 171, to show the keyboard layout of the integrated soft keyboard 263 on display(s) 109 of Dual HMD and VR Device 100, to present a text input cursor 273 within text input box 270 and is ready to transmit the user's interactions with the soft keyboard 263 within speciality application for handset 171 over the connection established between Dual HMD and VR Device 100 and the connected handset to be mirrored on top of the layout of the integrated soft keyboard 263 on display(s) 109.

Custom Control Mirroring Module 133, stored within Interactions with Application Installed On Connected Handset Module 129 in Memory 101, sends an image to speciality application for handset 171 which, along with instructions, software, and handset user input method(s) interaction module 131 stored within interactions with application installed on connected handset module 171 in memory 101 allows applications and the like made for Dual HMD and VR Device 100 to have custom input controls which are transmitted to and displayed on the touch screen of a connected handset that has speciality application for handset 171 open and mirrors the user's interactions with the custom input control onto the display(s) 109 so the user can see where their thumbs are fingers are positioned on the custom input control shown on the touch screen of a connected handset which has speciality application for handset 171 open. This process will now be described.

Applications created for Dual HMD and VR Device 100 can have custom input controller layout image(s) stored within them. An application, sends a custom input controller layout image to Custom Control Mirroring Module 133. Custom Control Mirroring Module 133 transmits this image to a connected handset where speciality application for handset 171 is open on the connected handset which has a touch screen. When received, this image is displayed in speciality application for handset 171 and speciality application for handset 171 has software or instructions to track, detect, and transmit various taps, swipes, drags, and the like and where on the custom input controller layout image they occur over the connection between the handset and Dual HMD and VR Device 100 to handset user input method(s) interaction module 131 which works with the application to detect and recognize what area of the custom input controller layout image was touched or interacted with and translates that into a means of interacting with or controlling the application within Dual HMD and VR Device 100. The custom input controller layout image is also shown in the application and is displayed on display(s) 109.

As previously stated speciality application for handset 171 tracks, detects, and transmits various taps, swipes, drags, and the like which are performed by the user anywhere on the custom input controller layout image. Handset user input method(s) interaction module 121 contains instructions to display the tracking of the user's thumbs and fingers as they tap, swipe, drag, and the like with their thumbs and or fingers on the connected handset's touch screen, onto display(s) 109 on top of the custom input controller layout image which is shown in the application on display(s) 109.

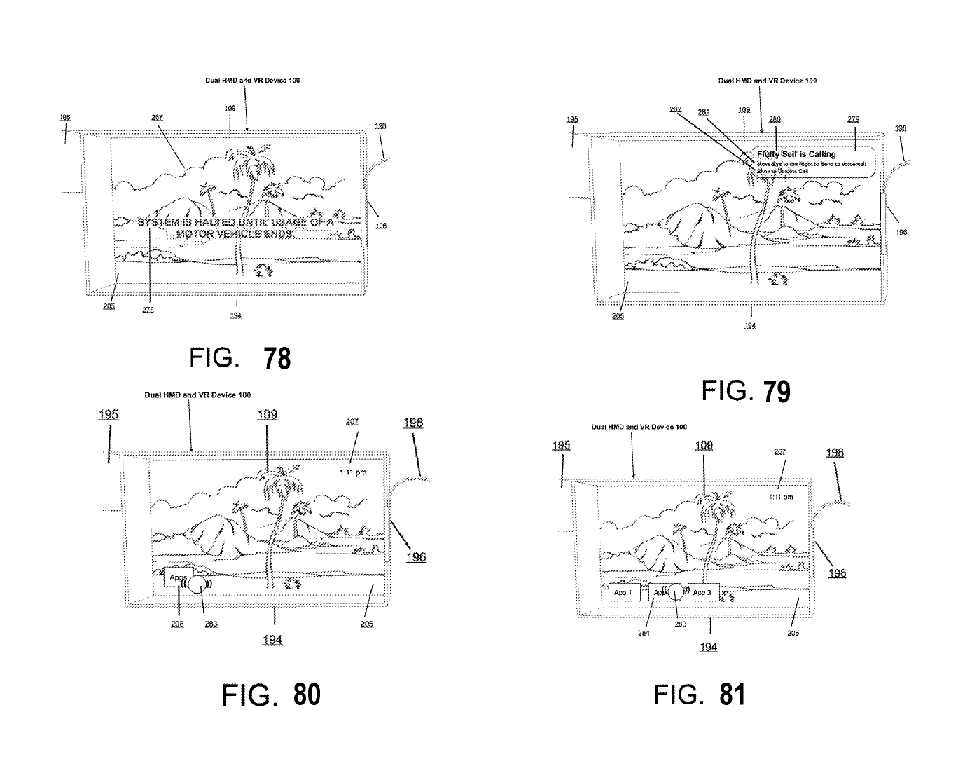

In a non limiting example, FIG. 76 shows a custom input controller layout image which happens to resemble a video game control pad, for playing the video game shown on display(s) 109. Custom Control Mirroring Module 133, stored within Interactions with Application Installed On Connected Handset Module 129 in Memory 101, sends an custom input controller layout image 274 over the bidirectional communication link established between Dual HMD and VR Device 100 and the bluetooth enabled handset to speciality application for handset 171. As shown in FIG. 77, the user 276 is tapping button 275. In FIG. 78, the tracking of the user tapping on button 275 is shown over button 275 by tracking identifier 277. When user 276 taps button 275, speciality application for handset 171 transmits over the connection between the handset and Dual HMD and VR Device 100 to handset user input method(s) interaction module 131 which works with the application (in this example, the game application) which detects that button 275 has been tapped and thus causes the application to perform whatever function is to be performed upon pressing button 275.

It should be noted that this method shouldn't be restricted to game pads. One skilled in the art will quickly recognize that many different style control methods can be created such as buttons, sliders, and the like, to be easily used with a touch screen handset connected to Dual HMD and VR Device 100.

User Safety Module 134, which is within Interactions with Application Installed

On Connected Handset Module 129 stored in memory 101, accesses the location services and or global positioning system that is within a connected handset to determine if the user is operating a motor vehicle. If the user is operating a motor vehicle, User Safety Module 134 contains instructions to curtail the device's functionality to reflect safety issues. This process will now be described.

Speciality application for handset 171 contains software or instructions to periodically access the location services or global positioning system module of the connected handset to obtain data on where the user has traveled or is currently traveling, by detecting a change in the location services or global positioning system coordinates. If the user is traveling, speciality application for handset 171 contains software or applications to request continued data from the location services or global positioning system module of the handset, and executes software and instructions to determine, by the rate of speed, which is obtained by analyzing the time it takes the user to travel from one destination to another, whether or not they are operating a motor vehicle. Once it is determined that the user is operating a motor vehicle, speciality application for handset 171 transmits a signal to User Safety Module 134 stored in interactions with application installed on the connected handset module 129 in memory 101 of Dual HMD and VR Device 100, over the connected handset's connection to Dual HMD and VR Device 100, that alerts the User Safety Module 134 to the fact that the user is operating a motor vehicle.

If it is detected that the user is operating a motor vehicle, as shown in FIG. 78 User Safety Module 134 contains software or instructions to display an alert 278 on display(s) 109 which informs the user that certain functionalities will now be curtailed until it is detected that the user is no longer operating a motor vehicle. It should be noted that the text of this alert may differ in some embodiments from the text “System is halted until usage of a motor vehicle ends.” This alert remains on display(s) 109 and User Safety Module 134 contains software or instructions to halt all device functionalities besides the display of the video feed which is a result of camera feed module 119 within HMD module 125 within memory 101 and camera(s) 165. In some embodiments, a dialog box or other notification may come up requesting the user to use any of the aforementioned user interaction or control methods to specify if the user is a passenger or not.

When it is detected by the speciality application for handset 171 on the connected handset that the user is no longer operating a motor vehicle, speciality application for handset 171 transmits a signal, over the connection established between Dual HMD and VR Device 100 that the user is no longer operating a motor vehicle to user safety module 134 stored in interactions with application installed on connected handset module 129 in memory 101 of Dual HMD and VR Device 100. User Safety Module 134 includes software or instructions, that once the signal from speciality application for handset 171 is received, all functionalities of the device are reactivated and resume as normal.

Speciality application for handset 171 also uses the connection between the connected handset and Dual HMD and VR Device 100 to allow users to receive notifications about calls received on the connected handset, in an embodiment where the connected handset is a contains an aspect allowing it to function as a phone, and provides the user with various methods to use Dual HMD and VR Device 100 to interact with calls received on a connected handset. This process will now be described.

As shown in FIG. 64, Speciality application for handset 171 contains an option within it's settings menu that can be turned on or off, called Call Forwarding 279. When Call Forwarding 279 is turned on 280, speciality application for handset 171 contains software or instructions to request access to the software associated with the telephone aspect of the connected handset, including the software which allows calls to be answered, rejected, sent to voicemail or otherwise interact with received calls, to send and receive data between speciality application for handset 171 and the software associated with the telephone aspect of a connected handset which also has telephone capabilities. Speciality application for handset 171 also contains software or instructions to simultaneously request access to send and receive data between the main address book of the connected handset or the address book which is associated with the telephone aspect of the connected handset and speciality application 171. Once speciality application for handset 171 gains access to these items, software and instructions run which detect when a telephone call has been received and is waiting for the user to answer, reject, send to voicemail or otherwise interact with the call. Once speciality application for handset 171 detects that a telephone call has been received and is waiting for the user to answer, reject, send to voicemail or otherwise interact with the call, speciality application for handset 171 contains software or instructions to send data regarding the received call including the name of the caller, phone number, and if available an image of the caller if the caller is stored as an contact with in the address book and has an image associated with their contact info in the address book to Notifications Module 138.

As shown in FIG. 79, Once received by Notifications Module 138, Notifications Module 138 contains software or instructions to work with Graphics Module 143, GUI Module 117, and Operating System 116 to generate a notification 279 containing, the name of the caller or their phone number 280, if available an image of the caller if the caller is stored as a contact within the address book and has an image associated with their contact info in the address book, and instructions to use any one of the aforementioned control methods to either send the call to voicemail 281 or close the notification 282. In this embodiment, iris controlled movements are used to control or interact with the notification. In other embodiments, the notification could provide the user with the option to send a message reply or pick a message reply to be sent from a set of predetermined messages to send to the caller.

If the user chooses to decline the call, Notifications Module 138 sends data to speciality application for handset 171, over the bi-directional communication link established between Dual HMD and VR Device 100 and the connected handset, which informs speciality application for handset 171 that the user has decline the call. Once this is received, Speciality application for handset 171, contains software or instructions to send a command to the telephone aspect of the connected handset to reject the call.

If the user chooses to send the call to voice mail, Notifications Module 138 sends data to speciality application for handset 171, over the bi-directional communication link established between Dual HMD and VR Device 100 and the connected handset, which informs speciality application for handset 171 that the user has chosen to send the call to voice mail. Once this is received, specialty application for handset 171 contains software or instructions to send a command to the telephone aspect of the connected handset to send the call to voicemail.

It should be noted that any received calls can be answered on the connected handset just by answering the call by using the method the user would normally use to answer calls by directly interacting with the connected handset. It should also be noted, that this feature does not silence the ringer or alert tone that sounds when the connected handset rings unless the user silences these functions on the connected handset, but can silence the ringer or alert tone in some embodiments.

The discussion of speciality application for handset 171 and connected handsets will end for now but will resume later on in the disclosure to describe how these features work with the VR realm of the device, more specifically Virtual Reality Module 126, Real Life Virtual Reality Module 127, and Real Life Virtual Reality Creator Module 128 which are stored in memory 101 of Dual HMD and VR Device 100.

The discussion will now turn to applications 135. Applications 135, is a module stored in the memory 101 of Dual HMD and VR Device 100 in which applications for Dual HMD and VR Device 100 are stored to be executed by the one or more microprocessing unit(s) 112, which are referred to as individual modules in the block diagram of Dual HMD and VR Device 100, as shown in FIG. 1. These individual modules should be referred to separate applications.

It should be noted that the VR aspect(s) of the device should be considered as being an application or applications. This also includes VR games, VR environments, or VR worlds.

To launch or execute an application, the user uses one of the aforementioned user input, control, or interaction methods to interact with a button or icon that is a part of the GUI that is displayed on display(s) 109 which is layered on top of the video feed which results from Camera Feed Module 119 and Camera(s) 165 to open up the applications 135 module. FIG. 80, in a non limiting example, shows the user using the function of the speciality application for handset 171 which provides a cursor to drag cursor 283 to the icon (which in some embodiments may be just an image or an image with text) apps 208 and once the cursor is over the apps 208 icon, the user taps to open the area where applications 135 are stored.

The user then uses one of the aforementioned user input, control, or interaction methods to interact with a button or icon that is a part of a GUI displayed on display(s) 109 which represents one of the applications stored in the applications 135 module, to select it to be launched or executed. FIG. 81, in a non limiting example, shows the user using the function of the speciality application for handset 171 which provides a cursor to drag cursor 283 over an application icon 284 (which in some embodiments may be just an image or an image with text) once the cursor is over application icon 284 the user taps to launch or execute the application.

Once selected the operating system 116 contains software or instructions to send a signal to microprocessing unit(s) 112 to launch or execute the application which has been selected by the user to be launched or executed. Depending on the purpose of the application, the application may or may not interact with additional hardware or software components.

Once launched, HMD Applications on Dual HMD and VR Device 100 can be interacted with and controlled by the use of the user input, control, or interaction methods that were described above. VR applications, on Dual HMD and VR Device 100 however, can use the same user input, control, or interaction methods but also has additional methods that will be described later on within the disclosure. Applications may be added to Dual HMD and VR Device 100 in the expected methods that many applications are added to portable multifunction devices. These methods include but are not limited to: connecting the device to a computer and transferring downloaded applications to the device and downloading applications onto the device through an application market place application which exists on the device.

It should be apparent to one skilled in the art, that since Dual HMD and VR Device 100 is an internet enabled device, Dual HMD and VR Device 100 is clearly capable of downloading more than just applications from the internet. Non limiting examples include: audio files, video files, electronic documents, ebooks, and the like.

Gestures can be allocated to bring up different applications. As shown in FIG. 64, in the settings area of speciality application for handset 171, under the applications 285 heading, assign gestures to applications 286 exists. If the user taps assign gestures to applications 286, another area, assign gestures to applications 286, appears on screen as shown in FIG. 82. In FIG. 82, speciality application for handset 171 contains software or instructions to acquire over the connection established between Dual HMD and VR Device 100 and the connected handset and display a listing of every application that is stored within Memory 101 of Dual HMD and VR Device 100 within the assign gestures to applications 286 area that is within the settings area of speciality application for handset 171.

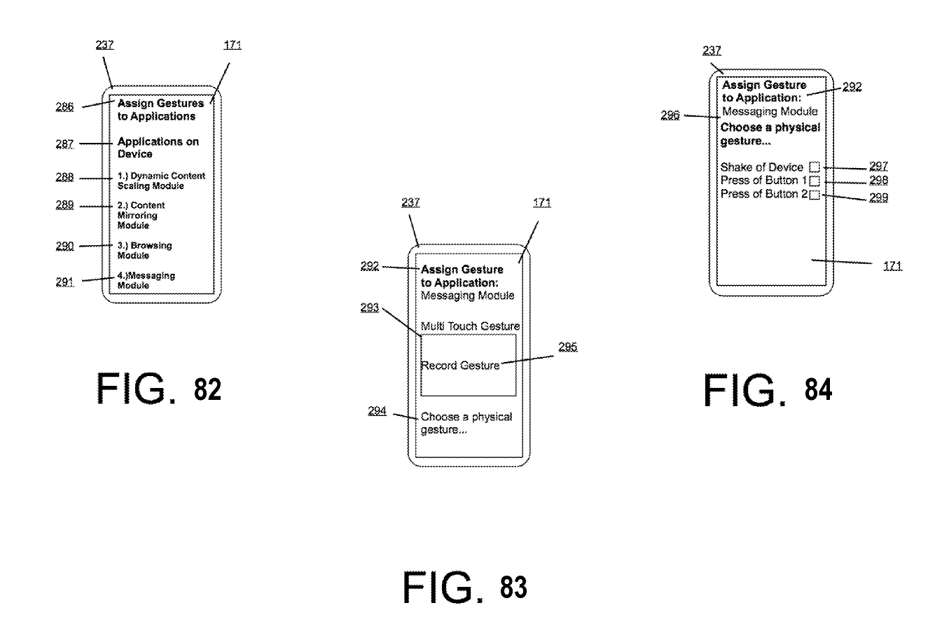

In FIG. 82, the user can select any one of the listed applications on the device, to allocate a gesture to it. In a non limiting example, the user selects the fourth option, by tapping Messaging Module 291. Messaging Module 291 in the menu represents Messaging Module 140 stored in memory 101 of Dual HMD and VR Device 100. FIG. 83 shows the area where the user can allocate a gesture for bringing up Messaging Module 140. This area of the settings area, uses the same methods as the area of the settings area where the user allocates a gesture for bringing up the integrated soft keyboard. The user can tap to record gesture 295 which is inside of multi touch gesture box 293 to allocate a multi touch gesture to bring up Messaging Module 140. The user then uses their fingers and or thumbs on the touch screen surface of the connected handset to input what they would like the multi touch gesture to be that brings up the handset's integrated soft keyboard inside of multi touch gesture box 293. In some embodiments this gesture may be a single tap, multiple taps, a simultaneous multi finger tap (such as taping three fingers simultaneously on the touch screen surface of the handset), a single swipe, multiple swipes, a simultaneous multi finger swipe (such as three fingers swiping the touch screen simultaneously) and any known method or method created in the future that involves the users' fingers and thumbs interacting with a touch screen.

The user can tap choose a physical gesture 294 to allocate a physical gesture to bring up messaging module 140. Upon tapping, choose a physical gesture 294, another area appears within the settings area of speciality application for handset 171 as shown in FIG. 84, choose a physical gesture 296. Software or instructions stored in speciality application for handset 171 scans and locates all of the possible buttons, user input methods, and or sensors with in the handset that can be used in conjunction with speciality application for handset 171 and lists them in the choose a physical gesture 296 area of speciality application for handset 171 to bring up the integrated soft keyboard of the handset, as shown in FIG. 86. In FIG. 86, the user can choose any of the available buttons, user input methods, or sensors that can be used in conjunction with speciality application for handset 171 by tapping checkboxes next to shake of device 297, press of button one 298, or press of button two 299. It should be noted that shake of device 297 is an example of a gesture that can be provided if a device has a motion detecting or tracking sensor such as a accelerometer. In FIG. 86, check boxes are used to select which gesture is used. In other embodiments, other selection methods such as switches, toggle buttons, buttons, and the like may be used.

In a non limiting example, the user allocates a multi touch gesture for bringing up Messaging Module 140. As shown in FIGS. 87 and 88, when the user 300 performs the multi touch gesture on the connected handset, Messaging Module 140 launches is displayed on display(s) 109.

Now the applications included within applications 135 will be discussed. These included applications are not meant to be considered the full extent of what applications can be included, added, downloaded, created, or used with the device. As evidenced on the many devices that exist today, such as internet enabled cell phones, applications can be developed and created to serve a variety of purposes. This discussion will consist of explaining the purpose of the application and how it operates. The process of launching or executing the application need not be explained as that was described earlier within this disclosure.

The discussion will now turn to applications specifically for the HMD aspect of the device. The HMD applications included within applications 135 include: Messaging Module 140.

It should be noted that HMD applications are applications which are layered over the video feed of the real world which is provided by Camera Feed Module 119 and Camera(s) 165. This process was described earlier within the disclosure. It should be noted that some applications can be layered over both the VR aspect and HMD aspect of the device.

Messaging Module 140 is an application that works in conjunction with Speciality Application for handset 171, in an embodiment where the connected handset has the capability to send and receive messages of various forms, using the connection between the connected handset to allow users to send messages through messaging applications and or protocols which are associated with and stored on the connected handset and to receive notifications about and respond to messages which are received on the connected handset through messaging applications and or protocols stored within the connected handset.

To access the Messaging Module 140 application, the user navigates to applications 135 as described above and launches or executes the Messaging Module 140 application. Messaging Module 140 contains software or instructions to send a request over the bi-directional communication link between Dual HMD and VR Device 100 and the connected handset to Speciality Application for Handset 171 to detect any and all messaging applications or protocols within the connected handset, to obtain access to send and receive data between speciality application for handset 171 and each messaging application or protocol within the connected handset, and to obtain access to the connected handset's main address book or the address book of each application or protocol.

Non limiting examples of the messaging applications or protocols which can potentially be stored in a connected handset and interact with speciality application for handset 171 and Dual HMD and VR Device 100 include: email protocols (non-limiting examples: internet message access protocol (IMAP) and or post office protocol (POP)), instant messaging (non-limiting examples: extensible messaging and presence protocol (XMPP) and or Short Message Service (SMS)), or any other communication protocol including communication protocols which have not yet been invented as of the filing date of this disclosure.

Once this data is acquired, Speciality application 171 contains applications or instructions to send data to Messaging Module 140 this data includes combined data from each messaging protocol or application stored and the main address book of the connected handset or address books associated with each messaging application or protocol to supply Messaging Module 140 with the following data: data regarding what messaging applications or protocols that are available to send and receive messages, and data regarding the messaging application or protocol used, the timestamp of, the contents of (which may include text and multimedia such as images, audio, or video), the senders of, and recipients of recent messages or conversations within the messaging applications or protocols on the on the connected handset. In some embodiments this may include the messaging application's application icon or protocol's icon along with the application name or protocol name.

As shown in FIG. 86, once received, Messaging Module 140 contains software or instructions to work with Graphics Module 143, GUI Module 117, Operating System 116 to generate, and layer over the video feed of the outside world provided by Camera Feed Module 119 and Camera(s) 165, a graphical virtual world, or a real life virtual world, a window or dialogue box 356 containing a listing of all of the addresses, phone numbers, user names, or address book contacts 357 that have recently sent or received messages to the user on the connected handset along with the messaging application or protocol 359 in which the conversation took place, which are sorted in descending order according to the timestamps 361 of the messages 358 so that the most recent conversations are shown on top. In FIG. 86, the applications or protocols 359 which are being used are the short message service and AIM, or America Online Instant Messenger Protocol.

Button 360 when interacted by using any one of the user input, control, or interaction methods, allows a user to create a new message onto display(s) 109. Button 362 when interacted by the user using any one of the user input, control, or interaction methods allows the user to separate conversations by application. This will be described later on in the disclosure.

If the list of conversations extends off screen, the user can use any one of the aforementioned user input, control, or interaction methods to scroll up or down to see more of the listed conversations.

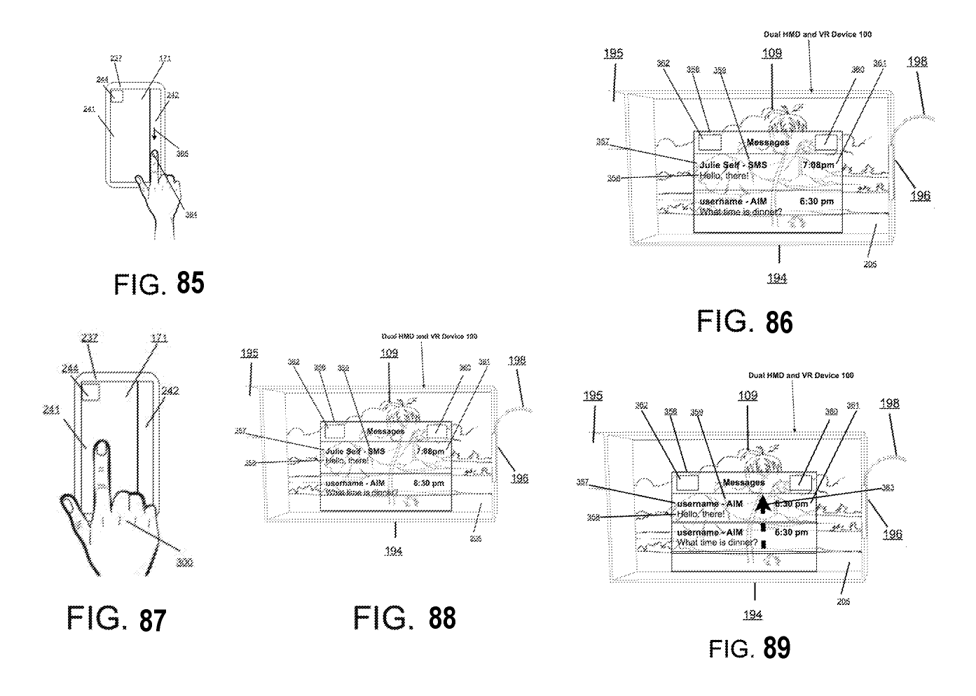

In a non limiting example, FIG. 85 shows the user dragging their finger 239 over the second section 242 of speciality application for handset 171, on the touch screen surface of the connected handset, while speciality application for handset 171 is open. Arrow 325 illustrates that the user is dragging their finger in a downward position. FIG. 89 shows the messages within window or dialogue box 356 are scrolling upward as shown by dashed arrow 363 as a result of the user moving their finger in the downward position so more messages can be seen.

In another non limiting example the user could activate iris controlled movements and scroll up or down to see more of the listed conversations by moving their eyes up and down.

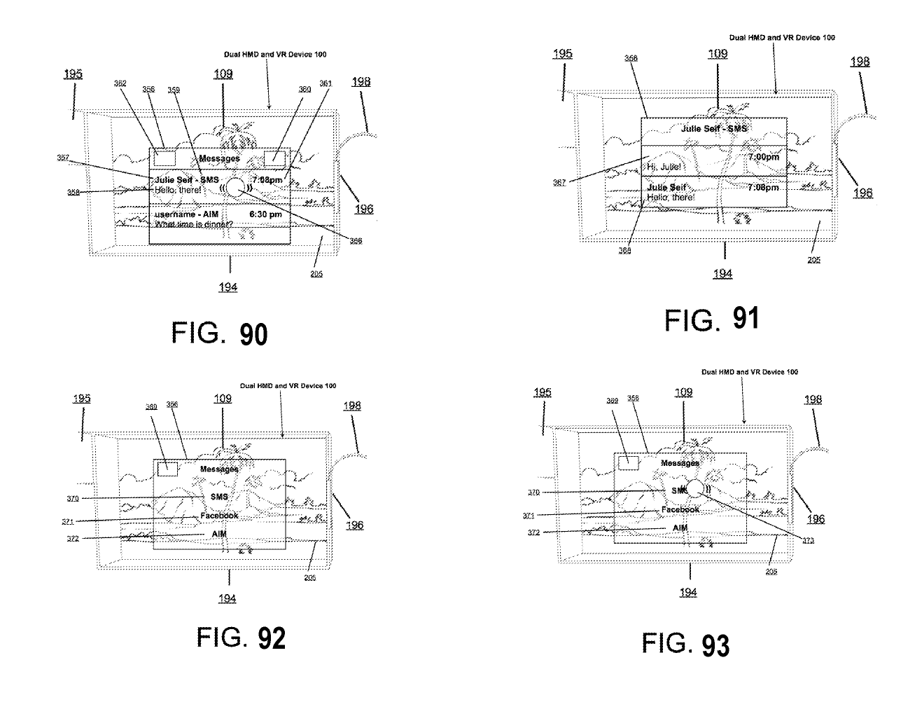

The user can select any of the conversations and read it's contents. When the messages extend off of the screen, in a lengthy conversation, the user can use any one of the aforementioned control methods to see more messages. In a non limiting example, FIG. 90 shows, by using the function of the speciality application for handset 171 which provides a cursor the user dragging cursor 366 over arrow 325 and then once the cursor is over arrow 325 the user taps or otherwise interacts with the touch screen surface of the connected handset which has speciality application for handset 171 installed on it and currently open to select the first message in the messages window or dialog box 356. In response to this, as shown in FIG. 91, messages window or dialog box 356 shows more messages in the conversation between the user 367 and Julie Seif 368 as well as a text input box 900 for the user to interact with and send the user a message if they desire. The user can press the back button to return to the listing of active conversations.

When a user, uses one of the user input, control, or interaction methods to interact with the button 360, shown in FIG. 90, which is allocated to compose a new message, Messaging Module 140 contains software or instructions to work with Graphics Module 143, GUI Module 117, Operating System 116 to generate a list using that data, as shown in FIG. 92 which, lists all of the messaging applications or protocols available on display(s) 109. In this embodiment, the user has accounts or phone numbers associated with their connected handset to send messages via SMS 370, Facebook 371, and AIM 372. Button 369 in the upper left corner is a back button, which upon being interacted with will take the user back to the previous screen where all of the messages are shown.

Messaging Module 140 contains software or instructions to allow the user to select, from this list which messaging application or protocol they'd like to send messages on using any one of the aforementioned user control methods.

In a non limiting example, FIG. 93, shows the user by using the function of the speciality application for handset 171 which provides a cursor to drag cursor 373 over SMS 370 and then once the cursor is over SMS 370 the user taps or otherwise interacts with the touch screen surface of the connected handset which has speciality application for handset 171 installed on it and currently open to confirm that they would like to send a message via the SMS protocol.

In another non limiting example, the user could activate voice recognition and say “Short Message Service” to select the short messaging service protocol.

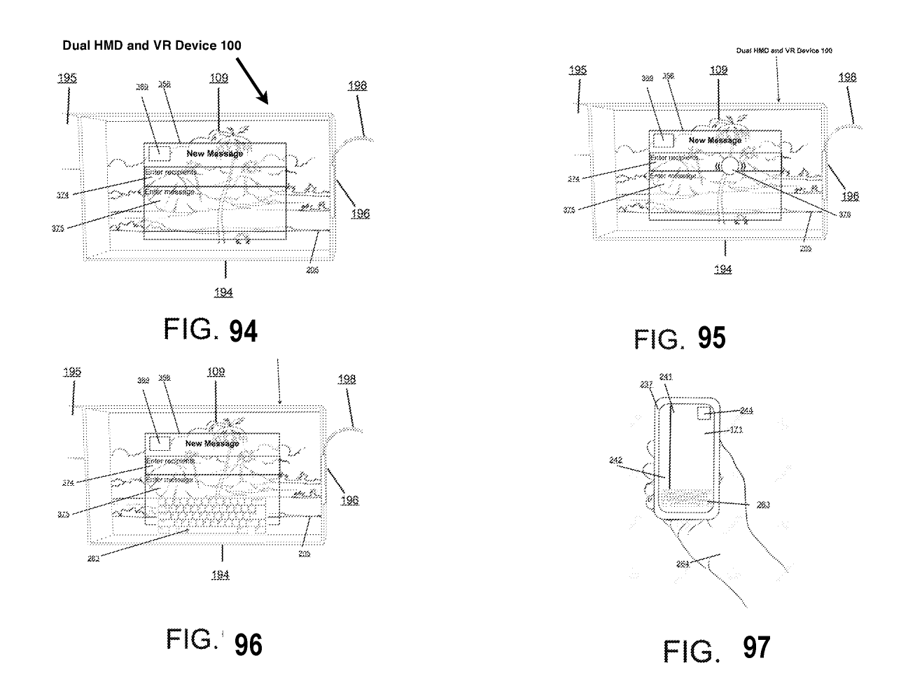

When the messaging application or protocol is selected by the user, Messaging Module 140 contains instructions to work with Operating System 116, Graphics Module 143, GUI Module 117, and Text Input Module 121 to generate a window or dialogue box as shown in FIG. 94 which contains two text areas. The first text area, recipients 374, is an area for the user to input the name, user name, email address, phone number, and or the like of a recipient or recipients of the message by using any one of the aforementioned user input, control, or interaction methods. The second area, message 375, is an area for the user to input the message they want to send. Button 369, will take the user back to the previous screen, FIG. 93, if interacted with. It should be noted that in all of the drawings in which button 369 appears in button 369 will take the user back to the are in which they were before they entered the area that they are currently in within the drawling.

Simultaneously, when the messaging application or protocol is selected Messaging Module 140 contains software or instructions to command Speciality Application 171 working in communication with Messaging Module 140 to read and send information or data over the bi-directional communication link which is established between Dual HMD and VR Device 100 and the connected handset, from the connected handset's main address book or address book associated with the messaging application or protocol being used to Messaging Module 140. This process will now be described.

This information or data which is read and sent may consist of the following: name, user name, email addresses, phone numbers, images, and any other forms of data which are known to be associated with data stored in address books or data that will be stored in address books that has not yet been invented at the time of this disclosure. This information or data which is read and sent may also consist of single letters or groupings of letters which are inputted by the user.

In a non limiting example, illustrated in FIG. 95 the user uses the touch screen of the connected handset to move a cursor 376 which is shown on display(s) 109 over the text input area that is allocated for the recipient or recipient(s) 374, tapping the touch screen when the cursor is over the text area for the recipients 374. As shown in FIG. 96 and FIG. 97, the user selecting the text area for the recipients 374, brings up the handset's integrated soft keyboard 263 and uses soft keyboard mirroring module 132 as described earlier in the disclosure allowing the user to input text, so the user can input the name, user name, email address, phone number, and or the like of a recipient or recipients.

While the user is inputting text into the text area for recipients 374, by using the connected handset's integrated soft keyboard from within speciality application for handset 171 and soft keyboard mirroring module 121, Messaging Module 140 sends the text which is being inputted in real time to speciality application 171 which contains software or instructions to read the text in real time which is being inputted and pair it with the text that is associated with various contacts stored within the main handset's address book or an address book associated with the messaging application or protocol being used such as name, user name, email addresses, phone numbers, and any other forms of data which are known to be associated with data stored in address books or data that will be stored in address books that has not yet been invented at the time of this disclosure, and send suggestions to Messaging Module 140, which contains software or instructions to work with Operating System 116, Graphics Module 143, and GUI Module 117, to show these suggestion(s) on display(s) 109 to the user as to which contact they are trying to input. The user can then use any one of the aforementioned input or control methods to select any of the suggestions provided.

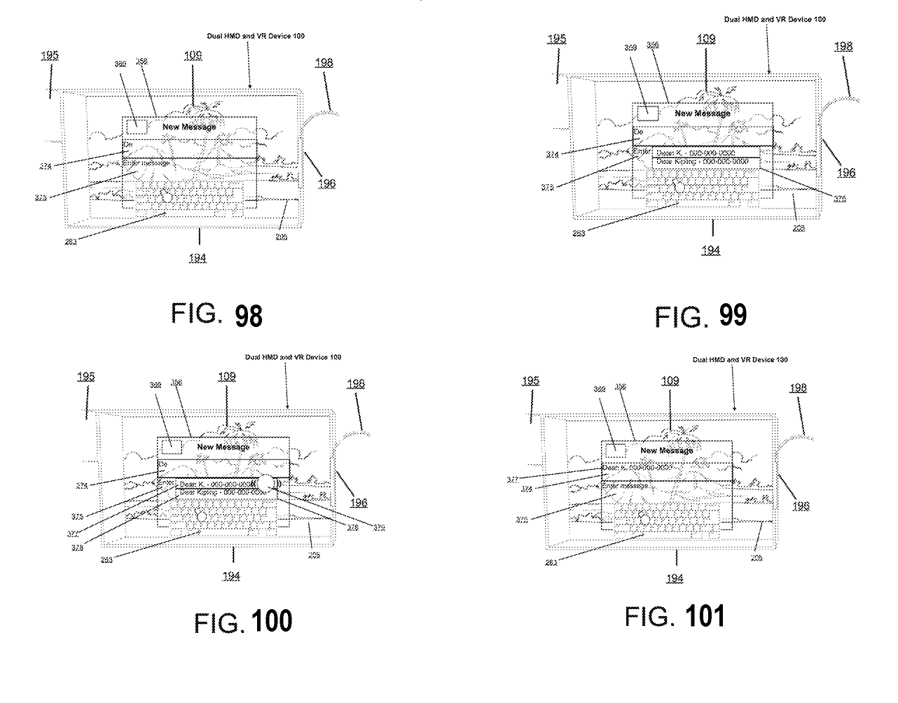

In a non limiting example, as the user uses the handsets integrated soft keyboard and soft keyboard mirroring module 132 to input text the user inputs the letters “De”, as shown in FIG. 98. Messaging Module 140 sends the text that is being inputted, in this case, the letters “De”, over the bi-directional link between the connected handset and Dual HMD and VR Device 100 to speciality application for handset 171 to be read by the software and instructions stored in speciality application for handset 171 to pair the letters with text that is associated with various contacts stored with in the main handset's address book or the address book of the messaging application or protocol being used. As shown in FIG. 99 once suitable suggestions of what contact the user is trying to input are found, they are sent over the bi-directional communication link created between Dual HMD and VR Device 100 and the connected handset to Messaging Module 140. Messaging Module 140 contains directions to show these suggestions 376 on display(s) 109.

Once a suggestion is selected, Messaging Module 140 contains software or instructions to insert the selected suggestion as the recipient 374 of the message. As shown in FIG. 100 by using the function of the speciality application for handset 171 which provides a cursor the user dragging cursor 379 over suggestion one 377 and then once the cursor is over suggestion one 377 the user taps or otherwise interacts with the touch screen surface of the connected handset which has speciality application for handset 171 installed on it and currently open to select suggestion one 377. As shown in FIG. 101 once the user selects suggestion one 377, suggestion one 377 is inputted as the recipient 374 of the message.

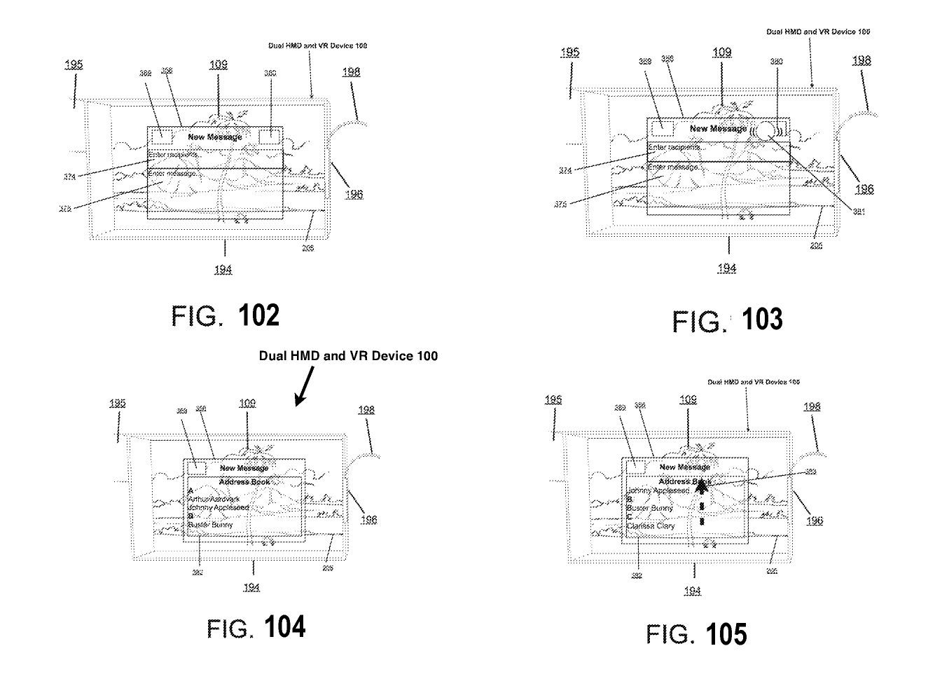

In some embodiments, button 380 shown in FIG. 102 exists. Button 380, can be interacted with by using any one of the user input, control, or interaction methods. Messaging Module 140 contains software or instructions that upon a user interacting with button 380, Messaging Module 140 sends a request to specialty application for handset 171 to send data containing the main device's address book or the address book associated with the messaging application or protocol. Once received, Messaging Module 140 contains software or instructions to work with Operating System 116, Graphics Module 143, GUI Module 117, and Text Input Module 121 to display the address book onto display(s) 109, allowing the user to use anyone of the aforementioned user input, control, or interaction methods to select a contact or contacts or search for a contact or contacts. Once selected, Messaging Module 140 closes the display of the address book on display(s) 109 and displays the two text input areas again with the contact or contacts entered into the recipient(s) area.

In a non limiting example, as shown in FIG. 103, the user uses the touch screen of the connected handset to move a cursor 381 which is shown on display(s) 109 over button 380. The user taps the touch screen with their finger when the cursor 381 is over button 380. As shown in FIG. 104, shortly after this occurs, the address book 382 for the messaging protocol currently in use appears within messages window or dialog box 356.

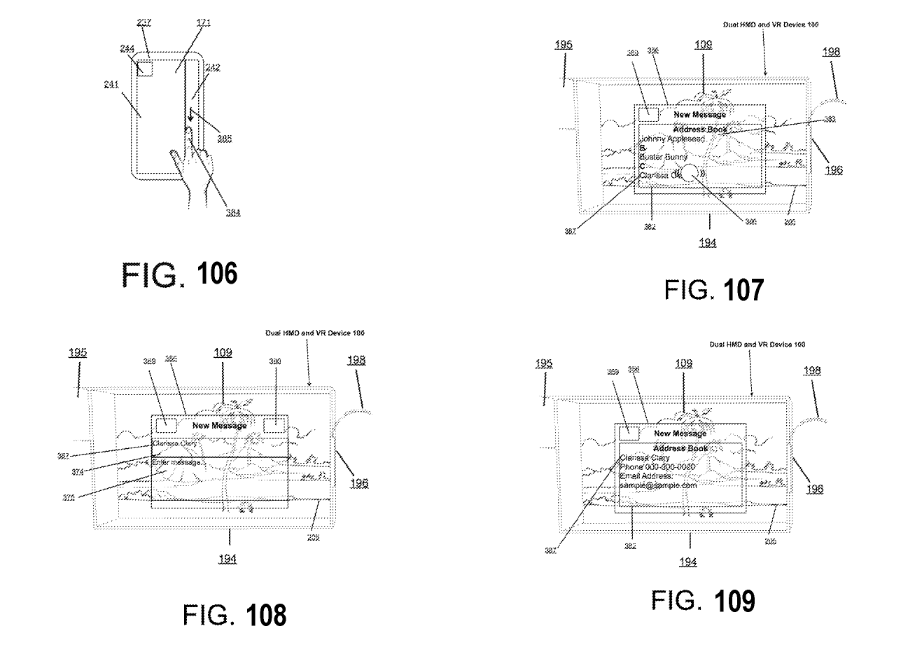

As shown in FIG. 106, FIG. 106 shows the user dragging their finger 384 over the second section 242 of speciality application for handset 171, on the touch screen surface of the connected handset, while speciality application for handset 171 is open. Arrow 385 illustrates that the user is dragging their finger in a downward position. FIG. 105 shows the address book 382 within window or dialogue box 356 are scrolling upward as shown by dashed arrow 383 as a result of the user moving their finger in the downward position so more address book contacts can be seen.

As shown in FIG. 107, The user scrolls through the address book until the user sees the name of the contact they want to look at, and the user by using the function of the speciality application for handset 171 which provides a cursor the user drags cursor 386 over the address book contact 387 they'd like to select. Then once the cursor is over contact 387 the user taps or otherwise interacts with the touch screen surface of the connected handset which has speciality application for handset 171 installed on it and currently open to select contact 387.

In some embodiments, as shown in FIG. 108, by selecting the contact 387, the address book 382 closes, and the contact 387 is set as the recipient 374 of the message. In some embodiments, the user can select more than one contact to be allocated as the recipient(s) 374 of the message.

In other embodiments, by selecting the contact, the contact's data appears on display(s) 109, within dialog box 356, as shown in FIG. 109.

When the contact's data appears on display(s) 109, within dialog box 356, the user by using the function of the speciality application for handset 171 which provides a cursor can select what aspect of the contact's data the user wants to send the message to.

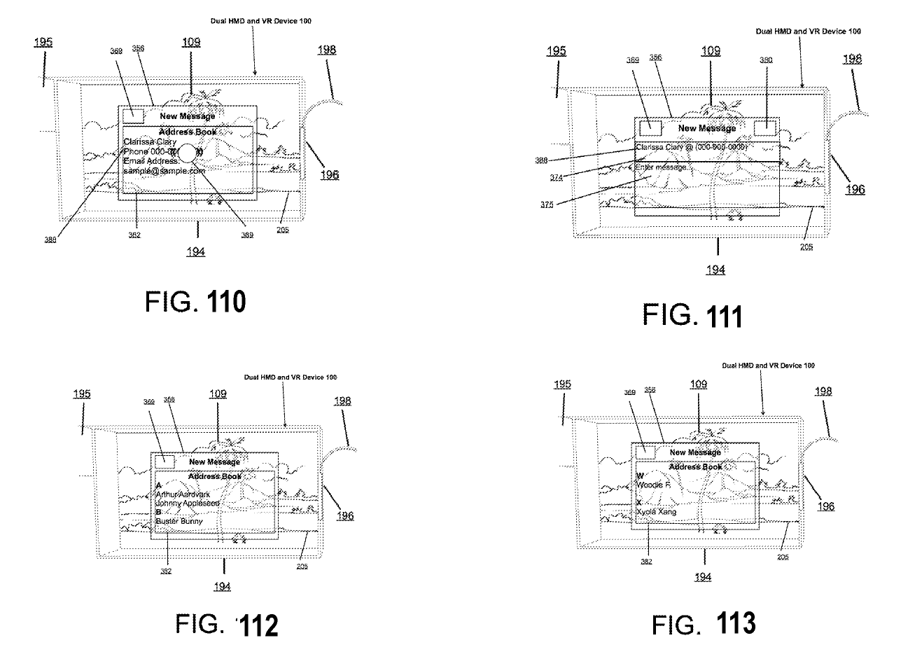

In a non limiting example, FIG. 110 shows, by using the function of the speciality application for handset 171 which provides a cursor on display(s) 109, the user dragging cursor 389 over phone 388 and then once the cursor is over phone 388 the user taps or otherwise interacts with the touch screen surface of the connected handset which has speciality application for handset 171 installed on it and currently open to select phone 388. As shown in FIG. 111, Messaging Module 140 has software or instructions that when an aspect of the users contact information is selected, in this example phone 388 is selected it is added to the recipients 374 box. In some embodiments, the user can specific aspects of more than one contact to be allocated as the recipient(s) 374 of the message.

Another non limiting example of inputting recipients into recipients box 374, is the user activating voice recognition to input a name into the text area allocated for the recipients, by saying “Send to: Mom.” Messaging Module 140 sends a request over the bi-directional communication link between Dual HMD and VR Device 100 and the connected handset to speciality application 171 for the main address book of the connected handset or the address book that is associated with the messaging app or protocol which is being used to be sent to Messaging Module 140 on Dual HMD and VR Device 100 to send Messaging Module 140 the details about the contact named “Mom” so “Mom” can be added as the recipient of the message.

It should be noted that these methods of adding and interacting with contacts associated with various messaging protocols can be used independently, but also can be used together, as a user may need to look up data on a contact in the address book before sending a message.

In a non limiting example, the user wants to look up data about a contact before adding the contact to the recipient 374 box. The user says “Address Book” and Messaging Module 140 sends a request over the bi-directional communication link between Dual HMD and VR Device 100 and the connected handset to speciality application 171 for the main address book of the connected handset or the address book that is associated with the messaging app or protocol which is being used to be sent to Messaging Module 140 on Dual HMD and VR Device 100. Once received, Messaging Module 140 contains software or instructions to show the address book 382 within dialog box 356, as shown in FIG. 112.

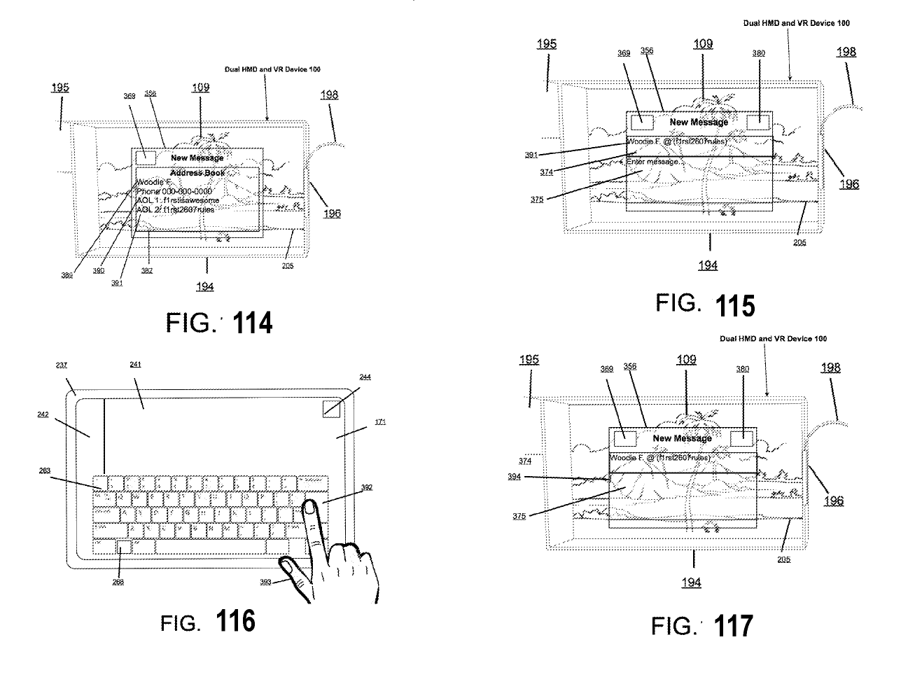

Messaging Module 140 contains instructions to allow the user to interact with it using any one of the aforementioned user input or control methods. The user activates voice recognition and says the letter “W” to bring up the “W” section of the address book as shown in FIG. 113. Once the contact the user wants is shown, the user than says “see details about Woodie” and the full details of the contact called ‘Woodie’ 389 are showed on display(s) 109 as shown in FIG. 114.

Depending on the messaging application or protocol being used, the user can choose a specific address or user name to send the message to that is shown in the full details of the contact. As shown in FIG. 114, the contact called ‘Woodie’ 389 has two AOL user names: AOL user name 390 and AOL user name 391. The user activates voice recognition and says “Send an IM to Woodie's second AOL username.”

As shown in FIG. 115, upon the user saying “Send an IM to Woodie's second AOL username” Woodie's second AOL user name, AOL user name 391 is added recipients box 374.

In another non limiting example, for the sending and receiving of SMS messages, some users may have multiple cellular phones, and therefore have multiple phone numbers listed in the address book under the same contact name, thus the user could say, “Send a message to Julie's work number.”

Alternatively, if the user does not have the address book displayed and knows that the user has multiple contact methods, such as multiple phone numbers, Messaging Module 140 has software or instructions to allow the users to be able to use voice recognition to command Messaging Module 140 to “Send a message to Julie's work number” without bringing up the address book. This would follow the same method as the above examples and as a result, would insert the contact information that would allow a message to be sent to Julie's work phone into recipients 374 box.

It should also be obvious to one skilled in the art that the user can also input a name, user name, address, phone number, or the like that is not stored in an address book into recipients 374 box as a recipient or recipients of the message.

There are a few different ways for the user to use the user input, control, or interaction methods to move to the second text input area, message 375, to compose a message. In a non limiting example, when the user is finished inputting message recipients into the recipients text area 374, by using the handset's integrated soft keyboard within speciality application for handset 171 and soft keyboard mirroring module 132, Messaging Module 140 contains software or instructions to allow the user 393, as shown in FIG. 116, by tapping the enter key 392 on the soft keyboard 263 to move the text input cursor 394 down into the second text input box, message 375, as shown in FIG. 117 so a message can be typed.

When the user is done typing their message, Messaging Module 140 contains software or instructions to send the message when the user either taps send on the handset's integrated soft keyboard in speciality application for handset 171 when the embodiment of the handset's integrated soft keyboard has a send key or the user taps the enter key on the handset's integrated soft keyboard in speciality application for handset 171. The various modules and procedures involved in sending the message will be described later on within this disclosure.

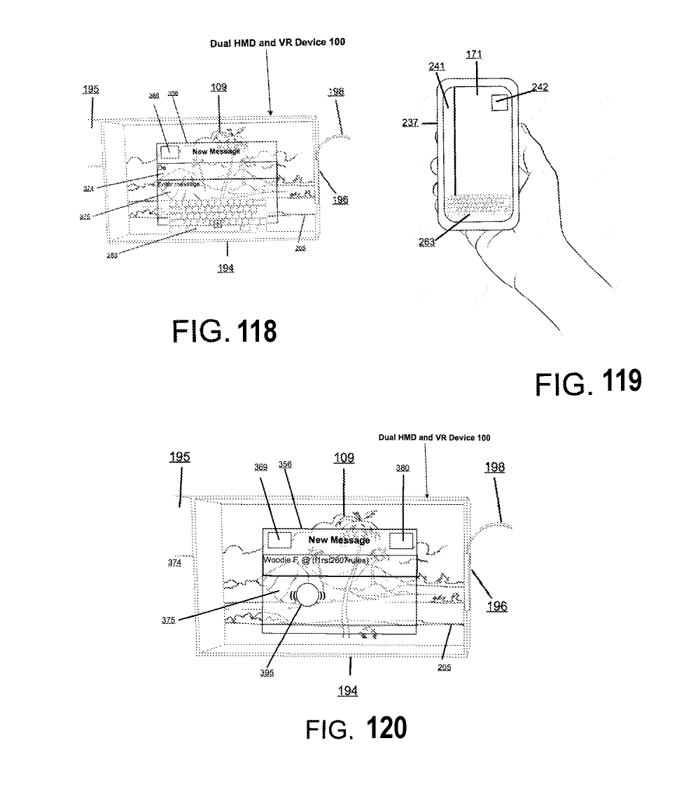

In another non limiting example, by using the function of the speciality application for handset 171 which provides a cursor 395 on display(s) 109, the user dragging cursor 389 over message 375 and then taps when the cursor 395 over the text area allocated for the messages 375 as shown in FIG. 118 by using the touch screen of a connected handset with specialty application for handset 171 open. As shown in FIG. 119 and FIG. 120, when the user taps on the text area for messages 375, the soft keyboard 263 in speciality application for handset 171 and soft keyboard mirroring module 132 on Dual HMD and VR Device 100 launch as previously described.

In another non limiting example, when the user has voice recognition activated, once done adding recipients, the user can say “Compose Message” to move the text input cursor from the recipients 374 text area to the messages 375 text area to begin dictating a message. When the user is done composing their message, Messaging Module 140 contains software or instructions to send the message when voice recondition is activated and the user says “send”. Once again, the various modules and procedures involved in sending the message will be described later on within this disclosure.

Many keyboard layouts on bluetooth enabled handsets which have messaging capabilities contain icons or buttons which when pressed, enable the user to attach various forms of multimedia to a message. Non limiting examples of multimedia are images, video, and audio. In some layouts, one button is allocated for each form of multimedia or a single button for attaching media of any kind is allocated. Speciality Application for Handset 171 works in unison with Messaging Module 140 to allow the user to utilize these allocated keys to attach multimedia contained in either the connected handset or within memory 101 of Dual HMD and VR Device 100 to messages. This process will now be described.

Speciality Application for Handset 171 contains software or instructions, to detect that when any button, even in a multiple button embodiment, on a soft keyboard button that is allocated for attaching or interacting with multimedia such as images, audio, video and the like is pressed.

When it is detected by Specialty Application for Handset 171 that a multimedia related button is tapped, Speciality Application for Handset 171 sends data to Messaging Module 140 that the button has been tapped and what form of multimedia the button is associated with (example: images), or if the button is associated with multiple forms of multimedia (example: images, photos, and audio). Once this is received by Messaging Module 140, Messaging Module 140 contains software or instructions to display a window or dialog box.

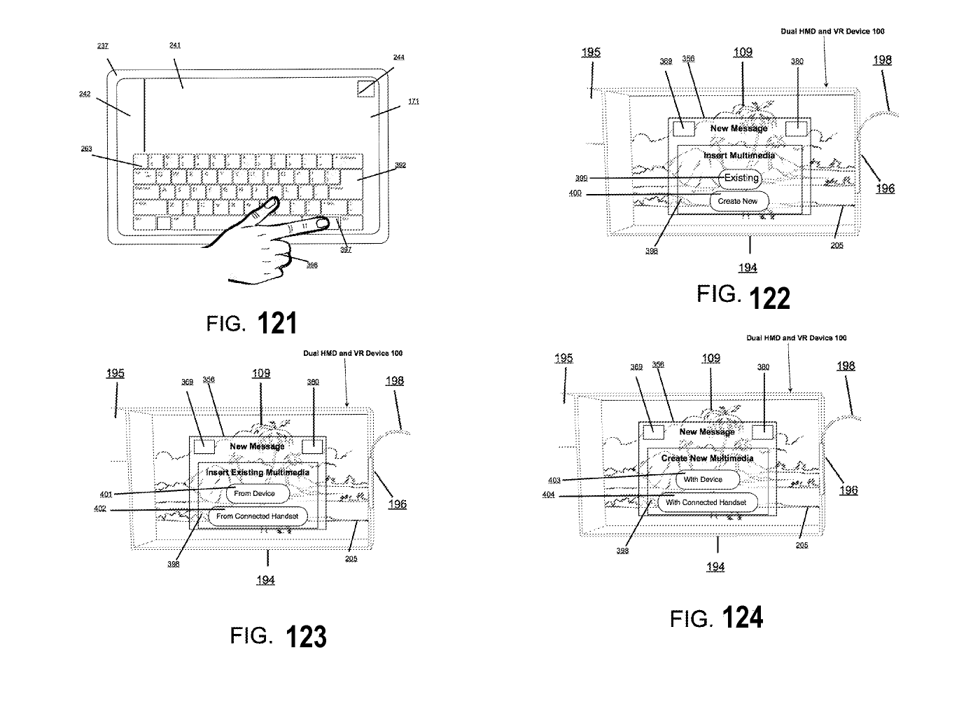

As shown in FIG. 121, upon pressing multimedia button 397 on the soft keyboard embodiment shown, a dialog box 398 appears within window or dialog box 356. In FIG. 122 dialog box 398, asks the user to select if they would like to obtain the multimedia from existing 399 multimedia or if the user would like to create new 400 multimedia.

The user can select any one of these methods by using any of the aforementioned user input, control, or interaction methods.

If the user selects existing multimedia 399, the user is prompted to choose multimedia, as shown in FIG. 123, stored either from within memory 101 of Dual HMD and VR Device 100 (this is option 401 in the drawling) or from the connected handset 402.

The user can select any one of these methods by using any of the aforementioned user input, control, or interaction methods.

If the user selects creating new multimedia 400 the user is prompted, as shown in FIG. 124, to choose between creating multimedia by using Dual HMD and VR Device 100 (this is option 403 in the drawling) or the connected handset 404 and it's protocols to create new multimedia.

The user can select any one of these methods by using any of the aforementioned user input, control, or interaction methods.

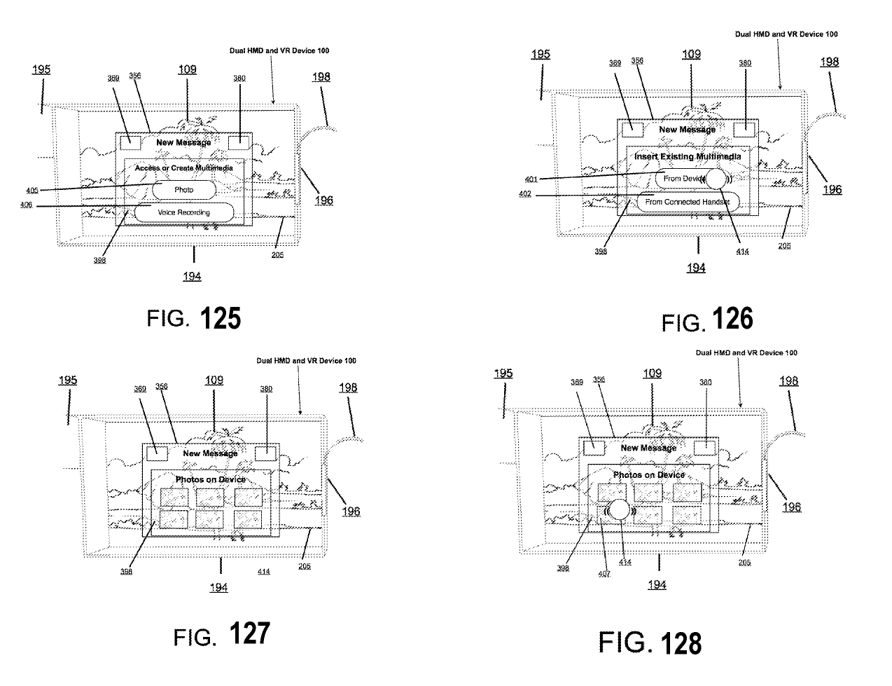

As shown in FIG. 125 In an embodiment where the multimedia button on the integrated soft keyboard of the handset is for multiple forms of multimedia, the dialog box 398 will prompt the user to select which form of multimedia they would like to access. Photo 405 and Voice Recording 406 serve as non limiting examples of various forms of multimedia that a bluetooth enabled handset is able to store and create. The user can select any one of these methods by using any of the aforementioned user input, control, or interaction methods. Once this is determined, the user will then be prompted as previously described to designate if they would like to obtain the multimedia from either the connected handset or from within memory 101 of Dual HMD and VR Device 100 or if the user would like to create new multimedia with either the connected handset using it's protocols for doing so, or by using Dual HMD and VR Device 100 to create new multimedia.

Now, it will be described as to what occurs based on the option that the user selects as to where they would like to obtain the multimedia from.

If the user selects to obtain the multimedia from multimedia that is already stored in memory 101 of Dual HMD and VR Device 100, Messaging Module 140 contains software or instructions to communicate with memory controller 114 to request access to read and send items from memory 101. Once access is granted to read and send from memory 101, Messaging Module 140 contains software or instructions to work with, Operating System 116, Graphics Module 143, GUI Module 117, to display a listing of either one form of multimedia files, such as images, or various forms of multimedia files stored within memory 101, such as images and audio, depending on the embodiment of the multimedia button, that are available to be shared, such as images, videos, and audio on display(s) 109. The user can use any one of the aforementioned control methods to pick one or multiple pieces of multimedia to be shared. Once the multimedia is selected, the user is shown a preview of the multimedia file or flies and is asked by Messaging Module 140 if they'd like to send the files, once they select “Yes”, Messaging Module 140 sends the selected multimedia to the messaging application and either attaches it to a message or in some embodiments automatically sends it to the recipient once selected.

In a non limiting example, as shown in FIG. 126 by using the function of the speciality application for handset 171 which provides a cursor on display(s) 109, the user drags cursor 414 over multimedia from device 401 and then once the cursor is over multimedia from device 401, the user taps or otherwise interacts with the touch screen surface of the connected handset which has speciality application for handset 171 installed on it and currently open to select multimedia from device 401.

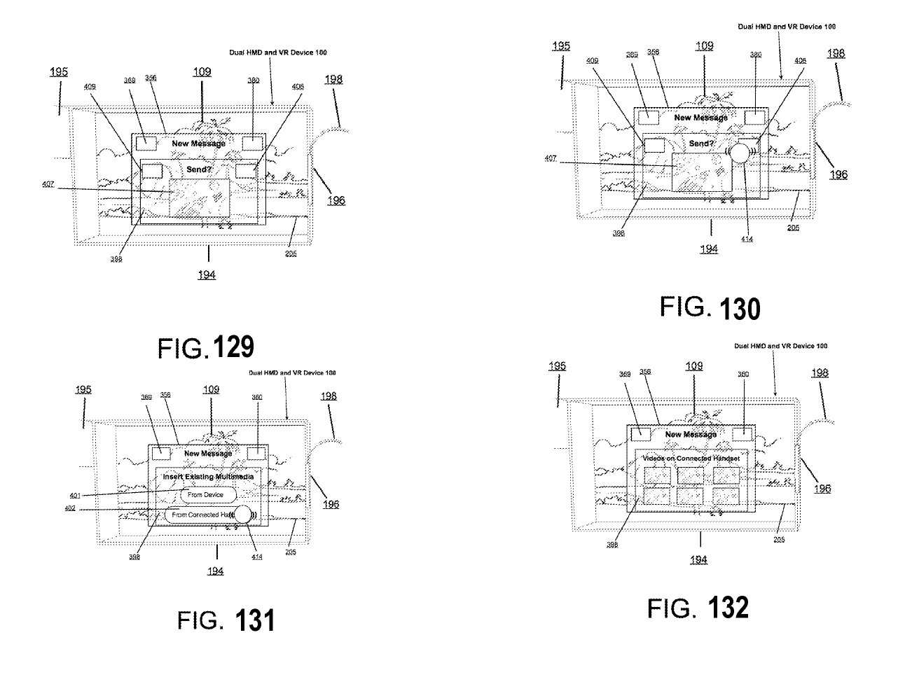

Once multimedia from device 401 is selected, FIG. 127 shows the multimedia which is stored in Dual HMD and VR Device 100 being shown within the dialog box 398. In this embodiment, the multimedia the user is selecting is a photo or photos. FIG. 128 shows the user, by using the function of the speciality application for handset 171 which provides a cursor on display(s) 109, the user drags cursor 414 over image 407 and then once the cursor is over image 407, the user taps or otherwise interacts with the touch screen surface of the connected handset which has speciality application for handset 171 installed on it and currently open to select image 407. In FIG. 129, the user is then shown image 407 within dialog box 398 and prompted if they would like to send the image 407. In FIG. 130, the user by using the function of the speciality application for handset 171 which provides a cursor on display(s) 109, the user drags cursor 414 over OK button 408 and then once the cursor is over OK button 408, the user taps or otherwise interacts with the touch screen surface of the connected handset which has speciality application for handset 171 installed on it and currently open to select OK button 408. By selecting the OK button, the multimedia is then sent. If the user does not select the OK button 408 and selects back button 409, the user can then select a different piece of multimedia to send. Upon, selecting “OK” either the multimedia is immediately sent to the user, or in an embodiment where multimedia is not immediately sent and allows the user to type or edit a text based message that is being sent with the multimedia.

If the user selects to obtain the multimedia from multimedia that is already stored within the connected handset, Messaging Module 140 contains software or instructions to send a request over the bi-directional communication link between Dual HMD and VR Device 100 and the connected handset to speciality application 171, for speciality application 171 to gain access to the area within the connected headset where multimedia is stored to read and send data. Once speciality application 171 gains access to the area within the connected handset where multimedia is stored, speciality application 171 contains instructions to read what is stored in the area where multimedia is stored, and to send data on what is stored in the area where multimedia is stored over the bi-directional communication link between Dual HMD and VR Device 100 and the connected handset to Messaging Module 140. Once received, Messaging Module 140 contains instructions to work with Operating System 116, Graphics Module 143, GUI Module 117, to display a listing of either one form of multimedia files, such as images, or various forms of multimedia files stored within the connected handset depending on the embodiment of the multimedia button, that are available to be shared, such as images, videos, and audio within dialog box 398 on display(s) 109. The user can use any one of the aforementioned control methods to pick one or multiple pieces of multimedia to be shared. Once the multimedia is selected, the user is shown a preview of the multimedia file or flies and is asked by Messaging Module 140 if they'd like to send the files. Upon, selecting “OK” either the multimedia is immediately sent to the user, or in an embodiment where multimedia is not immediately sent and allows the user to type or edit a text based message that is being sent with the multimedia Messaging Module 140 contains software or instructions to send a request over the bi-directional communication link between Dual HMD and VR Device 100 and the connected handset to speciality application 171, for speciality application 171 to generate a thumbnail or icon representing the selected multimedia, this thumbnail also contains software data that will designate to the connected handset what multimedia file is to be attached to the message when it is sent and to send this to Messaging Module 140. Once received by Messaging Module 140 the thumbnails representing the selected multimedia and their associated data are sent to the messaging application or protocol currently in use and uses the thumbnail(s) to represent the attached multimedia which is stored on the connected handset within the message. Once the user chooses to send the message, which is sent via the messaging protocol or application stored on the connected handset, the thumbnail's embedded software data tells the messaging protocol or application on the connected handset to attach the file or files in which the thumbnail represents. In some embodiments automatically the multimedia is sent to the recipient once received by Messaging Module 140.

In a non limiting example, as shown in FIG. 131 by using the function of the speciality application for handset 171 which provides a cursor on display(s) 109, the user drags cursor 414 over multimedia from the connected handset 402 and then once the cursor is over from the connected handset 402, the user taps or otherwise interacts with the touch screen surface of the connected handset which has speciality application for handset 171 installed on it and currently open to select is over from the connected handset 402.

Once is over from the connected handset 402 is selected, FIG. 132 shows the multimedia which is stored the connected handset being shown on display(s) 109. In this embodiment, the multimedia the user is selecting is a video or videos.

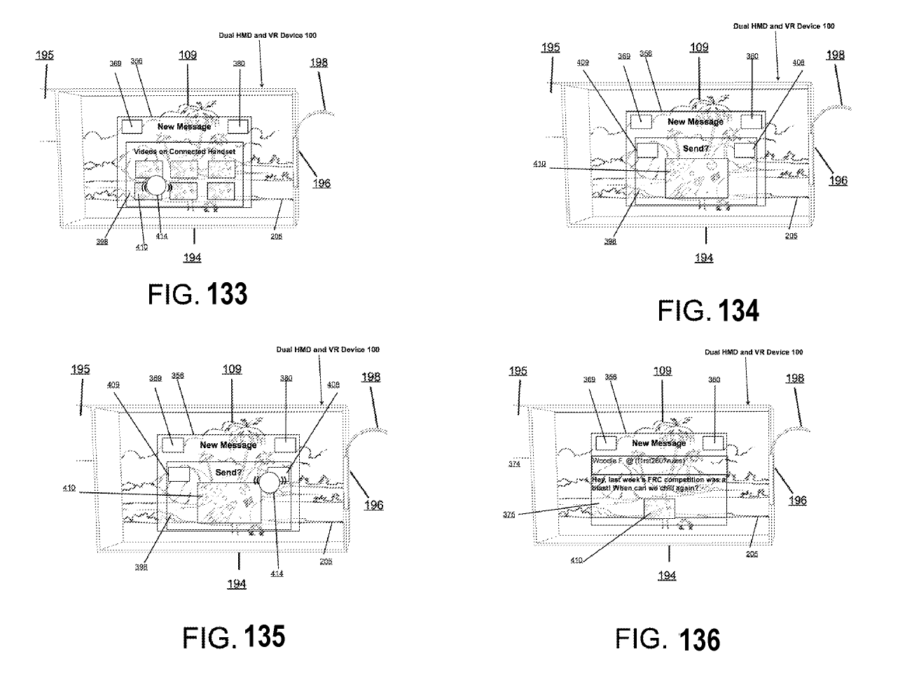

FIG. 133 shows the user, by using the function of the speciality application for handset 171 which provides a cursor on display(s) 109, the user drags cursor 414 over video 410 and then once the cursor is over image 410, the user taps or otherwise interacts with the touch screen surface of the connected handset which has speciality application for handset 171 installed on it and currently open to select image 410.

In FIG. 134, the user is then shown video 410 (the video begins to play automatically without the use of a play button, although in some embodiments a play button may be used to start and stop the video) and prompted if they would like to send the video 410.

In FIG. 135, the user by using the function of the speciality application for handset 171 which provides a cursor on display(s) 109, the user drags cursor 414 over OK button 408 and then once the cursor is over OK button 408, the user taps or otherwise interacts with the touch screen surface of the connected handset which has speciality application for handset 171 installed on it and currently open to select OK button 408.

In this embodiment, when the user selects the OK button, a thumbnail of the multimedia (in this case, video 410) is generated and attached to the message as shown in FIG. 136. The user then has to send the message for the multimedia to be sent along with it, as described above.

It should be noted that speciality application 171 does not need to obtain permission to send the multimedia over the messaging protocol or application in which the connected device ultimately sends the multimedia over, because the messaging applications or protocols that allow multimedia to be attached normally include software or instructions to request permission from where multimedia is stored to be able to send multimedia over the device's RF circuitry to a recipient.

If the user selects to create new multimedia from Dual HMD and VR Device 100, Messaging Module 140 works with Operating System 116, Graphics Module 143, GUI Module 117, to display on display(s) 109, a listing of, depending on the embodiment of the soft keyboard's multimedia button, either one method that a user can use to create one form of multimedia (example: using camera(s) 165 for image capture) on Dual HMD and VR Device 100 or various methods that a user can use to create new multimedia on Dual HMD and VR Device 100 which the user can select by using any one of the aforementioned user input methods.

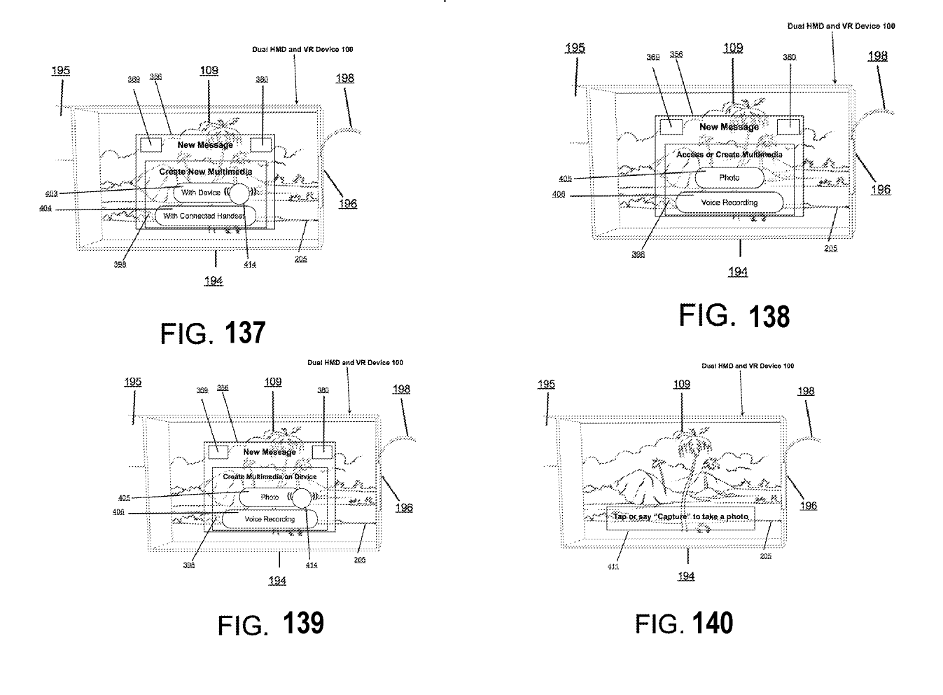

In a non limiting example, as shown in FIG. 137 by using the function of the speciality application for handset 171 which provides a cursor on display(s) 109, the user drags cursor 414 create new multimedia from device 403 and then once the cursor is over create new multimedia from device 403, the user taps or otherwise interacts with the touch screen surface of the connected handset which has speciality application for handset 171 installed on it and currently open to select create new multimedia from device 403.

FIG. 138 shows that the user can use Dual HMD and VR Device 100 to create voice recordings by using microphone 108 and photos and videos by using camera(s) 165. In a non limiting example, FIG. 139 illustrates the user, by using the function of the speciality application for handset 171 which provides a cursor on display(s) 109, the user drags cursor 389 over photo 405 and then once the cursor is over from the photo 405, the user taps or otherwise interacts with the touch screen surface of the connected handset which has speciality application for handset 171 installed on it and currently open to select photo 405.

Once photo 405, is selected, as shown in FIG. 140, window or dialog box 356 and dialog box 398 are hidden temporarily so that dialog box 411 can appear and the user is able to see the outside world and what they would like to capture clearly. The user can tap of the touch screen surface of the connected handset over top of section one of speciality application for handset 171 push a button to take a photo from camera(s) 165 or activate voice recognition and upon hearing the user say “capture”, the multimedia (in this non limiting example, a photo) is created. Created multimedia (in this non limiting example, a photo) is saved within Memory 101 of Dual HMD and VR Device 100.

Once the multimedia is created, the user is shown a preview of the multimedia file or flies, as shown in FIG. 141. Photo 412 is the multimedia that was captured by camera(s) 165 and stored to memory 101 within Dual HMD and VR Device 100. As well as being shown the created multimedia, the user is prompted as to whether they want to send the created multimedia or not. The user is also prompted by Messaging Module 140 if they'd like to send the files as shown.

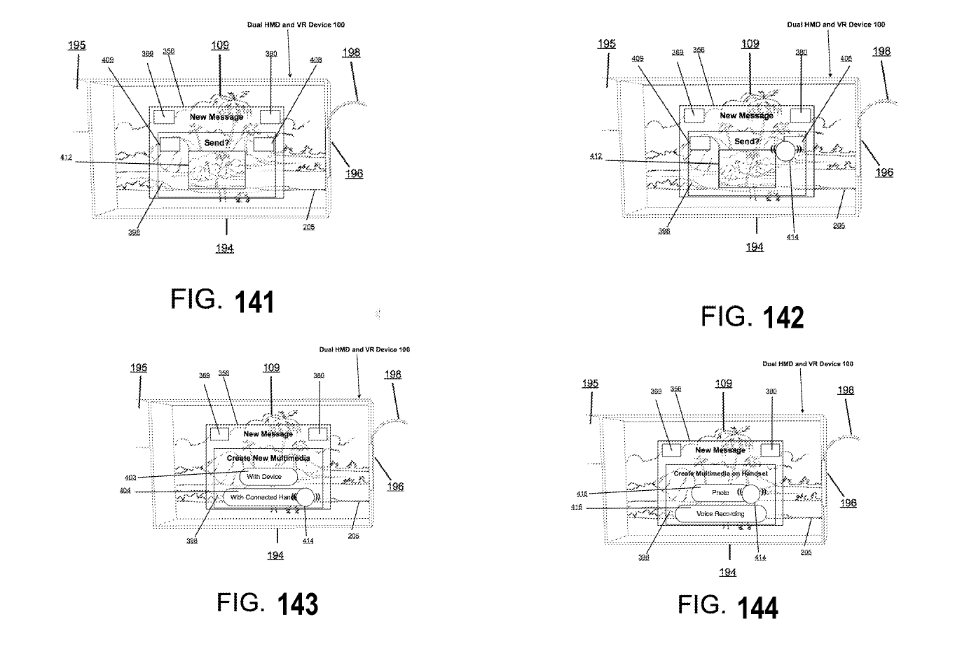

In FIG. 142, the user by using the function of the speciality application for handset 171 which provides a cursor on display(s) 109, the user drags cursor 414 over OK button 408 and then once the cursor is over OK button 408, the user taps or otherwise interacts with the touch screen surface of the connected handset which has speciality application for handset 171 installed on it and currently open to select OK button 408. Once the user confirms that they would like to send the file by pushing OK button 408, Messaging Module 140 attaches the multimedia to the message or automatically sends the multimedia to the recipient once created.

If the user selects to create new multimedia from the connected handset, Messaging Module 140 contains software or instructions to command Speciality Application for Handset 171 to, depending on the embodiment of the soft keyboard's multimedia button, either gains access to the multimedia creating hardware and software of the connected handset for one form of multimedia, or gains access to various methods that a user can use to create new multimedia the connected handset.

Once this occurs, speciality application for handset 171 contains software or instructions to send to Messaging Module 140, over the bi-directional communication link established between Dual HMD and VR Device 100 and the connected handset data regarding what multimedia creation method or methods depending on the embodiment of the soft keyboard's multimedia button are available on the device. Once received, Messaging Module 140 contains software or instructions to work with Operating System 116, Graphics Module 143, GUI Module 117, to display on display(s) 109, a listing of, depending on the embodiment of the soft keyboard's multimedia button, either one method that a user can use to create one form of multimedia on the connected handset or various methods that a user can use to create new multimedia on the connected handset, which the user can select by using any one of the aforementioned user input methods. Once the user selects which method they would like to use to create multimedia or depending on the embodiment of the soft keyboard's multimedia button the only method available to create multimedia, speciality application for handset 171 displays the connected handset's software for creating the specific multimedia the user uses the software on the connected handset to create multimedia.

In a non limiting example, FIG. 143 shows the user by using the function of the speciality application for handset 171 which provides a cursor on display(s) 109, the user drags cursor 414 over create new multimedia with connected handset 404. The user then taps to select create new multimedia with handset 404.

FIG. 144 shows that the connected handset can create photos and voice recordings. The user, by using the function of the speciality application for handset 171 which provides a cursor on display(s) 109, the user drags cursor 414 over photo 415 and then once the cursor is photo 415, the user taps or otherwise interacts with the touch screen surface of the connected handset which has speciality application for handset 171 installed on it and currently open to select photo 415. Once photos 415 is selected, the connected handset brings up the application or protocol it uses to capture photos and the user interacts directly with the handset and not Dual HMD and VR Device 100 to capture a photo.

Once the multimedia is created, it is stored in the connected handset's memory, and in most embodiments of the connected handset the multimedia creation software in the connected handset will allow the user to preview the multimedia and ask them if they want to send it.

When the user confirms that they want to send the multimedia on the connected handset, speciality application for handset 171 contains software or instructions to generate a thumbnail or icon of the created multimedia which contains software data as previously described in this disclosure and sends it to Messaging Module 140.

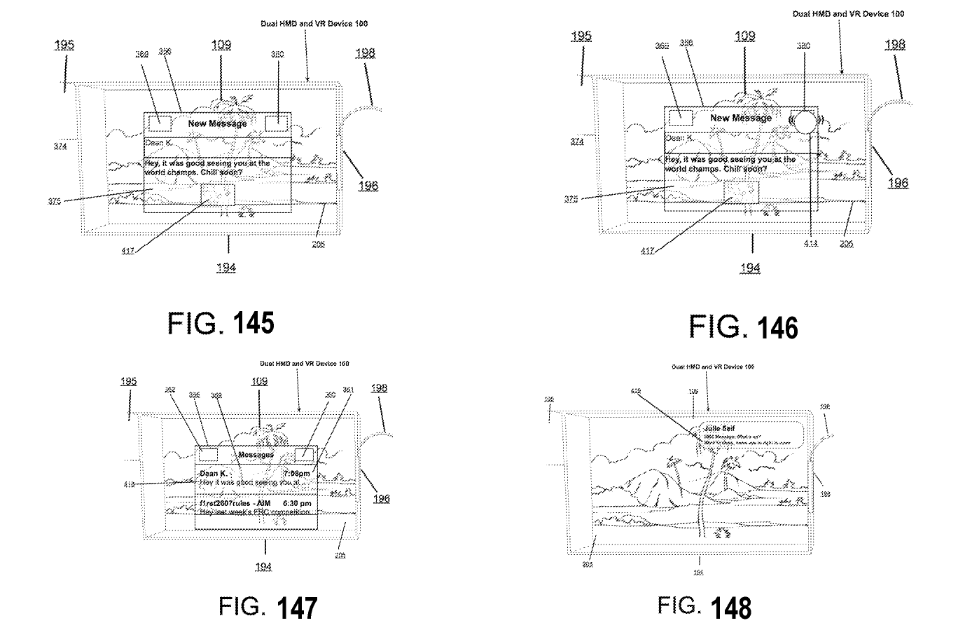

FIG. 145 shows a thumbnail of photo 417 which was just captured on the connected handset displaying within the Messaging Module 140 window or dialog box 356 in the message area 375.

When the user is done typing in their message, Messaging Module 140 contains software or instructions to send the message when the user sends the message. When the user sends the message, Messaging Module 140 contains software or instructions to transmit the message along with the attached thumbnail to Speciality Application for Handset 171, which contains software or instructions to send the message which was transmitted from Messaging Module 140 to the messaging application or protocol it is associated with within the connected handset and to command the messaging application or protocol to send the message over the connected handset's RF circuitry to the recipient or recipient(s).

FIG. 146 by using the function of the speciality application for handset 171 which provides a cursor on display(s) 109, the user drags cursor 414 over send button 380 and then once the cursor is over send button 380, the user taps or otherwise interacts with the touch screen surface of the connected handset which has speciality application for handset 171 installed on it and currently open send button 380 to send the message with the multimedia attached.

When a message is sent with multimedia attached to it one of the following procedures are performed. When multimedia is sent or a message containing multimedia stored or created on Dual HMD and VR Device 100 is sent by the user to a recipient(s), Messaging Module 140 contacts software or instructions to send the multimedia created on Dual HMD and VR Device 100 to speciality application for handset 171. Speciality application for handset 171 contains software or instructions to send the received multimedia to the messaging application or protocol in which it is being sent over on the connected handset so it can be sent.

When multimedia is sent or a message containing multimedia stored or created on the connected handset is sent by the user to a recipient(s), as described, the thumbnail(s) of the multimedia and their associated data designates to the messaging application or protocol that the multimedia is being sent over, the location that these multimedia files can be found in within the connected handset to be sent either on their own or attached to a message.

After a message is sent, it is shown in Messaging Module 140 as a new conversation, as shown in FIG. 147. FIG. 147 shows the conversation 418 that was started in the last non limiting example by sending a message and attachment to Dean K. If the user responds to a message that is sent to them while in another application (this process will be explained below) this happens automatically without the user being currently in the Messaging Module 140 application.

Now, the procedures for reading and interacting with messages which are received by the connected handset will be described.

Speciality Application for Handset 171, contains software or instructions to detect when, in an embodiment where the connected handset has the capability to send and receive various messages, non limiting examples include email protocols (non-limiting examples: internet message access protocol (IMAP) and or post office protocol (POP)), instant messaging (non-limiting examples: extensible messaging and presence protocol (XMPP) and or Short Message Service (SMS)), or any other communication protocol including communication protocols which have not yet been invented as of the filing date of this disclosure, when an electronic message is received by the connected handset.

Once, Speciality Application for Handset 171 detects that an electronic message has been received by the connected handset, Speciality Application for Handset 171 contains software or instructions to work with the messaging software or instructions which are included in the connected handset, to obtain data on the message received such as the sender of the message which includes the sender's name and in some embodiments may include the sender's photo, the contents of the message which may include text or various forms of media such as images or video, and the timestamp which includes the date and time that the message is sent.

Once this information is obtained, Speciality Application for Handset 171 contains software or instructions to send the data including the sender of the message, which in some embodiments may include a photo of the sender, the message, and if included, a thumbnail of video, photo, or other forms of multimedia which may be included in the message that has been received, over the bi-directional connection established between Dual HMD and VR Device 100 and the connected handset, to be read by Messaging Module 140 which is located in applications 135 which is within memory 101.

Once received and read by Messaging Module 140, Messaging Module 140 contains software or instructions to send data including the sender of the message, which in some embodiments may include a photo of the sender, and an excerpt of the message, to Notifications Module 138. Notifications Module 138 contains the software or instructions previously described, to turn the received data into a Notification to be displayed on display(s) 109.

Once the Notification that a message has been received by the connected handset is shown on display(s) 109, and the user can use one of the aforementioned methods to either close the notification, or to respond to the message.

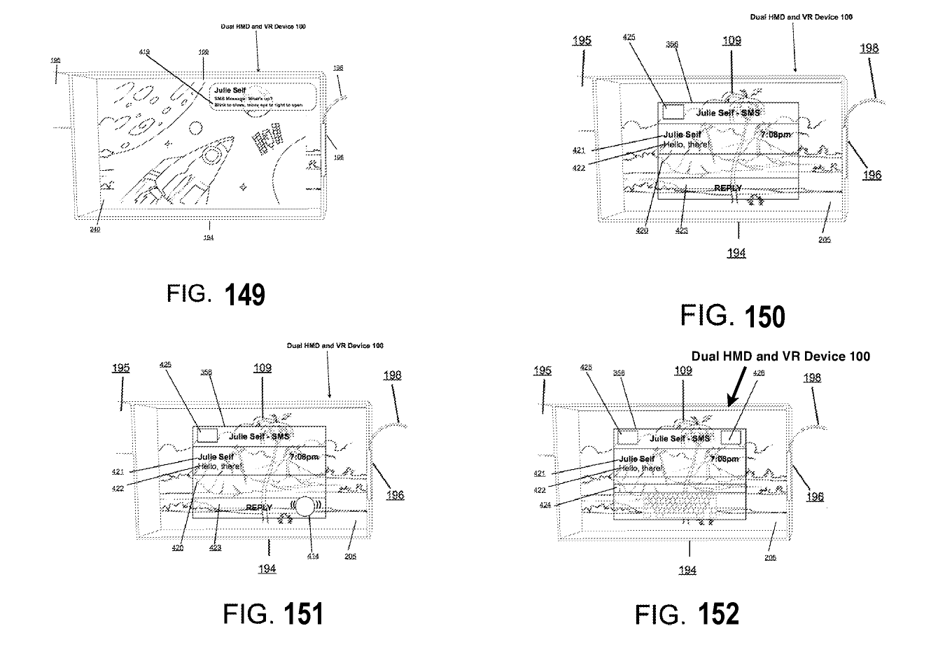

As shown in FIG. 148 and FIG. 149 the notification 419 displays regardless of if the user receives it while using the HMD side of the device or are immersed within a graphical virtual world or experience in the VR side of the device.

If the user chooses to close the notification, no further action needs to be taken.

If the user chooses to open the notification and respond to the message, Messaging Module 140 contains software or instructions work with Graphics Module 143 and GUI Module 117 and Operating System 116 to generate a window or dialogue box 420 as shown in FIG. 150 which contains the senders name 421, the message 422 that the user has sent the wearer of Dual HMD and VR Device 100, exit button 425 (to exit this area and not send a reply back) and a reply area that can be interacted with so the user can reply to the message.

In some embodiments this may include a time stamp of when the message(s) was received, the text and or various forms of media such as images and video, which is layered over the camera feed provided by Camera Feed Module 119 and Camera(s) 165 or a graphical virtual world or a real life virtual world, both of which will be defined later on in the disclosure.

If the user chooses to respond to the message. The user needs to interact with the reply button. In a non limiting example, FIG. 151 shows the user by using the function of the speciality application for handset 171 which provides a cursor on display(s) 109, the user drags cursor 414 over reply button 423 and then once the cursor is over reply button 423, the user taps or otherwise interacts with the touch screen surface of the connected handset which has speciality application for handset 171 installed on it and currently open to select the reply button 423.

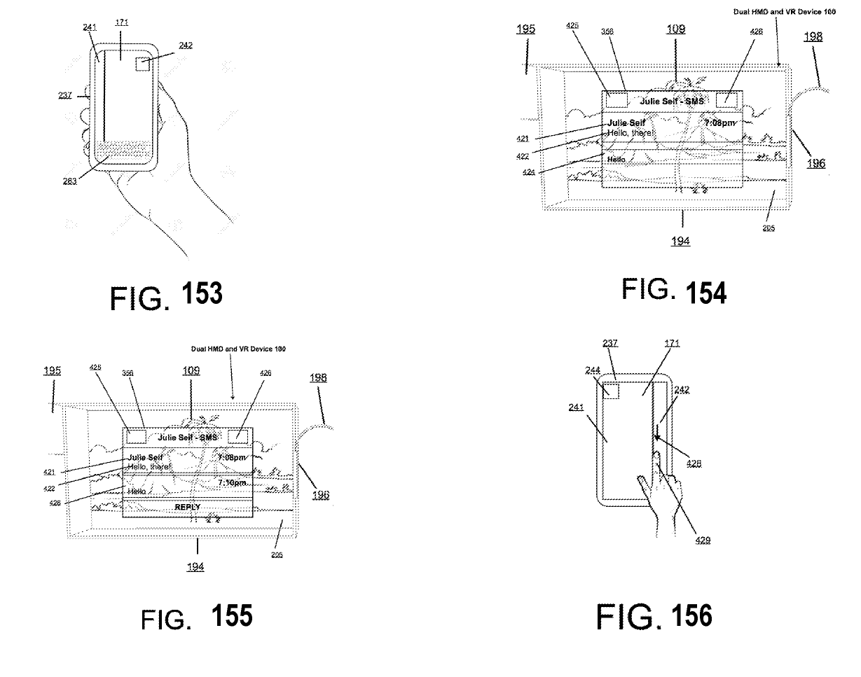

As shown in FIG. 152, as a result of the user selecting reply button 423, the reply button turns into a text area 424 and moves upward so a soft keyboard can appear and as shown in FIG. 153, so that soft keyboard 263 in speciality application for handset 171 and soft keyboard mirroring module 132 on Dual HMD and VR Device 100 launch as previously described. As a result, the user can type and send a message as previously discussed within this disclosure. Button 426 is a send button, when the user interacts with it the message is sent.

In another non limiting example, the user activates voice recognition and says “reply.” Once the reply button 423 loads into a text area 424 as a result of the user saying “reply” the user activates voice recognition and says “reply with: Hello” and hello is inserted into text area 424 as shown in FIG. 154. When the use is ready to send, they activate voice recognition again and say “Send.”

It should be realized that this window or dialog box 420 show a conversation and just not a single message. For example, after the message “Hello” 426 from the above non limiting example is sent, it is shown beneath the message that it was a response to, as shown in FIG. 155. Thus, after multiple messages are sent between the user and the person or person(s) they are in conversation with, the user must scroll to see past messages, if they desire to see past messages.

In a non limiting example, FIG. 156 shows the user using their finger 429 on the second area of speciality application for handset 171 that is allocated for scrolling, to scroll downwards.

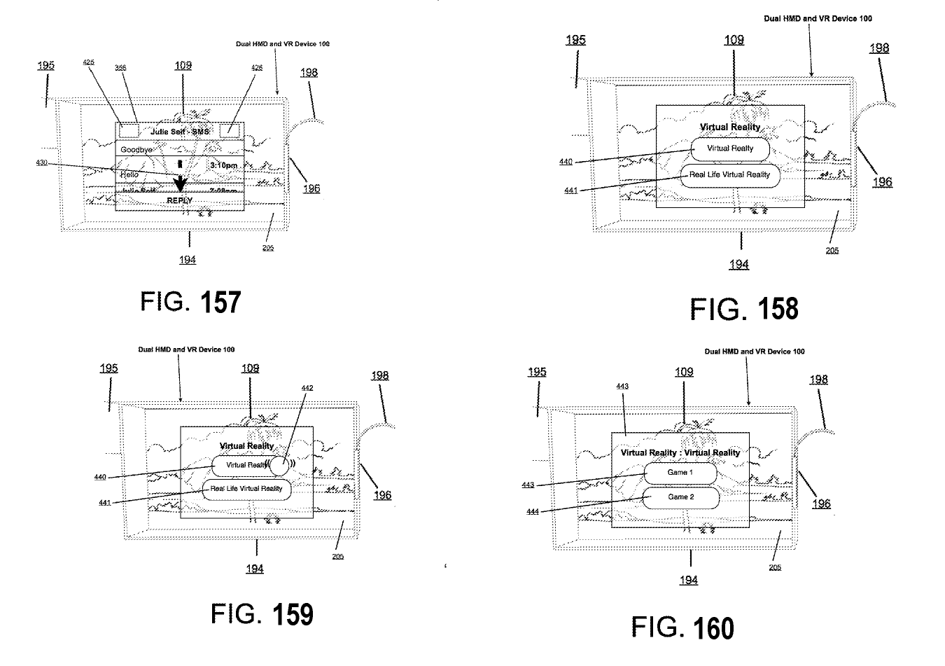

Arrow 428 illustrates the downwards direction that the user is moving their finger 429 in. In response, FIG. 157, shows the messages the make up the conversation shown in window or dialog box 356 scrolling down so that past messages can be shown. Dashed arrow 430 illustrates the direction in which the messages that make up the conversation are moving in.

It should be noted that when responding to notifications, the Messaging Module 140 opens the messaging application or protocol that the notification is associated with, and the user does not need to specify this.

It should be obvious to one who is skilled in the art that Messaging Module 140 allows the user to switch between conversations and have multiple conversations going on at one time.

The applications which will now be discussed require camera(s) 165 to shut off, because these applications take up the entirety of display(s) 109 and do not allow the user to see the outside world because they are immersive applications. However, in some embodiments, these applications may employ transparency, or these applications may run within a non resizable or resizable area or window (therefore only taking up a section of display(s) 109), and other aforementioned methods discussed in this disclosure to allow these applications to be able to be run while camera(s) 165 and the applications to be layered over the resulting camera feed that results from Camera Feed Module 119 and camera(s) 165.

In embodiments where these applications require camera(s) 165 to be shut off as these applications take up the entirety of display(s) 109, when the user launches or executes these applications the procedure described above which occurs when launching an application takes place, but additional steps also occur. Software and instructions stored within Applications 135 contain instructions to detect when an application which takes up the entirety of display(s) 109 is launched by the user. Once this is detected, Applications 135 contains software or instructions to activate the User Safety Module 134. Once it is detected by User Safety Module 134 that the user is not operating a motor vehicle and this information is sent to Applications 135, Applications 135 contains software or instructions to begin to simultaneously launch the application and shut off camera(s) 165.

Now, the VR realm of Dual HMD and VR Device 100 will be discussed. In this embodiment of Dual HMD and VR Device 100, the VR realm of the device is stored within applications 135 as an application titled Virtual Reality Module 126 and is launched as an application, following the same procedures for launching an application as described above, and the procedures for applications which require camera(s) 165 to be shut off some embodiments, as described above.

It should be noted that while the user is in the VR aspect of the device, Dual HMD and VR Device 100, HMD applications can continue to run in the background. The same goes for VR games, worlds, or anything known as a graphical virtual world environment in the VR aspect of the device, those items can continue to run in the background if the user switches back to the HMD aspect of the device, in some embodiments.

After the user launches Virtual Reality Module 126, they are greeted with a window or dialog box 443 as shown in FIG. 158. From this screen, the user can use any one of the aforementioned user input, control, or interaction methods to select either Virtual Reality 440 or Real Life Virtual Reality 441. Real Life Virtual Reality will be described later on in this disclosure.

FIG. 159 shows the user, in a non limiting example, by using the function of the speciality application for handset 171 which provides a cursor on display(s) 109, the user drags cursor 442 over Virtual Reality button 440 and then once the cursor is over Virtual Reality button 440, the user taps or otherwise interacts with the touch screen surface of the connected handset which has speciality application for handset 171 installed on it and currently open, to select Virtual Reality button 440. In response to the user selecting Virtual Reality button 440, as shown in FIG. 160, a listing of the VR worlds, games, or anything known as a graphical virtual world environment which is stored within Applications 135 which is stored within Memory 101 is listed within window or dialog box 443.

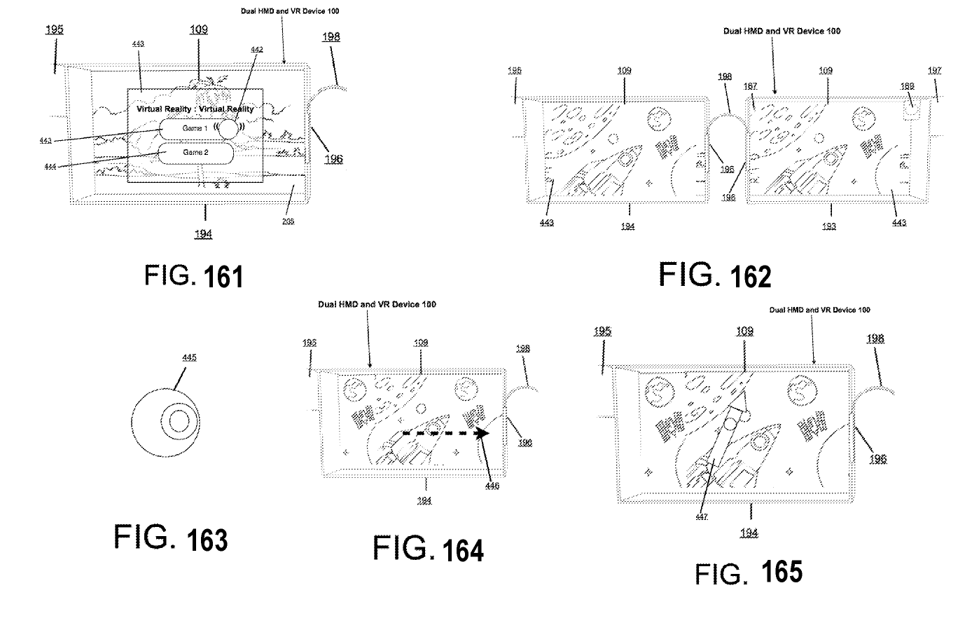

The user can use any one of the aforementioned user input, control, or interaction methods to select any one of the listed VR worlds, games, or anything known as a graphical virtual world environment to access it. As shown in FIG. 161 in a non limiting example, by using the function of the speciality application for handset 171 which provides a cursor on display(s) 109, the user drags cursor 442 over Game 1 443 and then once the cursor is over Game 1 443, the user taps or otherwise interacts with the touch screen surface of the connected handset which has speciality application for handset 171 installed on it and currently open, to select Game 1 443 to launch it.

When the user launches a VR world, game, or anything known as a graphical virtual world environment, the operating system 116 contains software or instructions to send a signal to microprocessing unit(s) 112 to launch or execute the VR world, game, or anything known as a graphical virtual world environment that has been selected by the user to be launched. Simultaneously, while launching the application Operating System 116 works in conjunction with launcher module 204.

Launcher module 204 contains software and instructions to work with Operating System 116 and Graphics Module 143 as the VR world, game, or anything known as a graphical virtual world environment is being launched to accurately display similar yet different views of the VR world, game, or anything known as a graphical virtual world environment on each display of display(s) 109. As previously mentioned, each eye sees similar yet different views of what it is looking at because although the eyes see the same degree measure, they are positioned at different angles. This results in the brain taking two similar yet different sets of image signals, received from each eye, and merging them into one image, creating our field of view.

Thus, the VR worlds, games, or anything known as a graphical virtual world environment that are launched and executed by Dual HMD and VR Device 100 must be represented to the user so that each eye is shown a similar yet different angled view of the VR worlds, games, or anything known as a graphical virtual world environment so the brain receives a similar yet different set of image signals from each eye and merges it into one image, creating a field of view, with ease.

As shown in FIG. 162, in response to the user launching Game 1 443 as illustrated in the previous non limiting example, the Game 1 443 is shown on display(s) 109 and a similar yet different view of the Game 1 443 is shown on display(s) 109.

In some embodiments, the VR worlds, games, or anything known is a graphical virtual world environment may already be coded by developers to show each eye a similar yet different view of the VR worlds, games, or anything known as a graphical virtual world environment or these environments may be coded by developers to work in unison with launcher module 204 to ensure that showing the user a similar yet different view of the VR worlds, games, or anything known as a graphical virtual world environment is done correctly. In some embodiments, launcher module 204 contains software or instructions to adjust the settings of Dual HMD and VR Device 100 to properly render graphics and display VR worlds, games, or anything known as a graphical virtual world environment with clarity and to be exactly how the developer intended these items to appear.

Now that we have discussed the image merging process which occurs between the brain and eyes and how we must ensure this same process occurs when a user is exposed to VR worlds, games, or anything known as a graphical virtual world environment, a discussion must now occur about the field of view and measurement conditions of VR worlds, games, or anything known as a graphical virtual world environment which are experienced by the user of Dual HMD and VR Device 100.

The common minimum horizontal field of view that the user is looking at when immersed within VR worlds, games, or anything known as a graphical virtual world environment on Dual HMD and VR Device 100 is roughly 120 degrees. VR worlds, games, or anything known as a graphical virtual world environment, could very easily have a larger or smaller field of view, depending on what the developer intends for the virtual world to consist of. A talented developer who is making VR worlds, games, or anything known as a graphical virtual world environment to be used with Dual HMD and VR Device 100 could cleverly use of code, software, and hardware components to make the user feel as though they are experiencing an environment with a field of view that is lower or higher than 120 degrees. The numbers just discussed should be thought of as a median and not a maximum or minimum of the degree measures of the VR worlds, games, or anything known as a graphical virtual world environment that the user can be immersed in while using Dual HMD and VR Device 100.

To control or interact VR worlds, games, or anything known as a graphical virtual world environment or objects or items within these worlds, the same control methods which were used for the HMD aspect of the device can be used for the VR side of the device. Non limiting examples of these control methods being used will now be illustrated.

In a non limiting example, FIG. 163 shows the user moving their eye 445 to the left. FIG. 164 shows the position of the graphical virtual world moving to the right, as illustrated by dashed arrow 446, so the user can see more of the graphical virtual world. This occurs as a result of Iris Control Module 122 using Optical Sensor(s) Control 151 and Optical Sensor(s) 164 as previously described in this disclosure to detect the movement of the iris of the eye and containing software or instructions to turn iris movement into a means of changing the position of the graphical virtual world.

In another non limiting example, the user activates voice recognition and says “launch” and in response, as shown in FIG. 165 a rocket 447 in a graphical virtual world environment launches. This occurs as a result of Dual HMD and VR Device 100's microphone and software and instructions within Voice Recognition Module 123 translating the human audible sound waves that are a result of the user speaking a command or phrase into the device's microphone 108 into electrical signals and transmits these signals to Microprocessing Units 112 to carry out the command or interaction with the Dual HMD and VR Device 100. In this case, the electrical signals are used to control an item within a graphical virtual world environment.

The microphone 108, in some embodiments, can also be used as a means of communicating (talking) with other users within a VR world, game, or anything known as a graphical virtual world environment or that is internet based, involves connectivity to communication protocols such as but not limited to wireless communications may use but are not limited to any one or a combination of the following standards, technologies, or protocols: Bluetooth (registered trademark), wireless fidelity (Wi-Fi) (non-limiting examples: IEEE 802.11a, IEEE 802.11b, IEEE 802.11g and or IEEE 802.11n), near field communications (NFC), or has components such as multiplayer which requires an online connection to establish the ability to interact with other players with in the VR world, game, or anything known as a graphical virtual world environment.

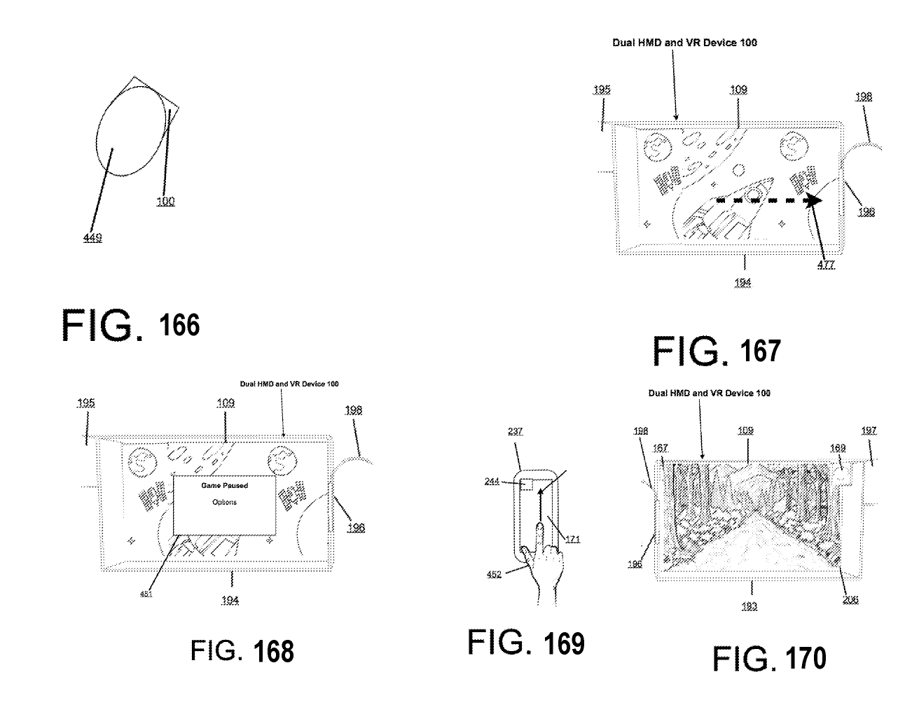

In another non limiting example, FIG. 166 shows an overhead view of the user moving their head 449 to the right while wearing Dual HMD and VR Device 100. This motion triggers the integrated motion sensor away within Dual HMD and VR Device 100. As a result of the user moving their head to the right, as shown in FIG. 167, the area of the graphical virtual world that the user is viewing 450 on display(s) 109 changes, allowing the user to see more of it. Arrow 477 illustrates the direction of movement as a result of the user moving their head. The actual graphical virtual world environment remains stationary. When the user moves their head, display(s) 109 show them a view of the graphical virtual world environment without the world moving.

In another non limiting example, if the user presses button 190 which is located on Dual HMD and VR Device 100 to bring up a in game pause menu 451 on display(s) 109 as shown in FIG. 168. If the user presses the button 190 a second time to close the in game pause menu on display(s) 109.

As previously described in the disclosure, speciality application for handset 171 can be used to control or interact with VR worlds, games, or anything known as a graphical virtual world environment or objects or items within these worlds. It was also discussed and illustrated with examples in that area of the disclosure that when speciality application for handset 171 is used for the VR aspect of the device the two sections that make up speciality application for handset 171 disappear and instead of being sectioned speciality application for handset 171 becomes one large surface for detecting taps, swipes, drags, and the like performed by the user's fingers and thumbs and for software and instructions on Dual HMD and VR Device 100 to translate those movements into ways of interacting with and controlling VR worlds, games, or anything known as a graphical virtual world environment or objects or items within these worlds.

In a non limiting example as shown in FIG. 169, the user 452 swipes forward, as illustrated by arrow 453 on the touch screen surface of the connected handset while speciality application for handset 171 is open, to move forward through a graphical virtual world environment. FIG. 170 shows the starting position of the user. FIG. 171 shows the users position changing as a result of the user swiping forward on the touch screen surface of the connected handset as previously illustrated.

Another topic discussed in that area of the disclosure was that the user can use any of the integrated sensors within the connected handset, such as a motion detecting sensor such as to control or interact with VR worlds, games, or anything known as a graphical virtual world environment or objects or items within these worlds.

Yet another topic discussed in that area of the disclosure was that the user can simultaneously interact with speciality application for handset 171, move the connected handset to activate it's integrated sensors so that interaction and control methods can be used simultaneously to simultaneously interact with or control a single element or more than one element as described in the example provided earlier within this disclosure.

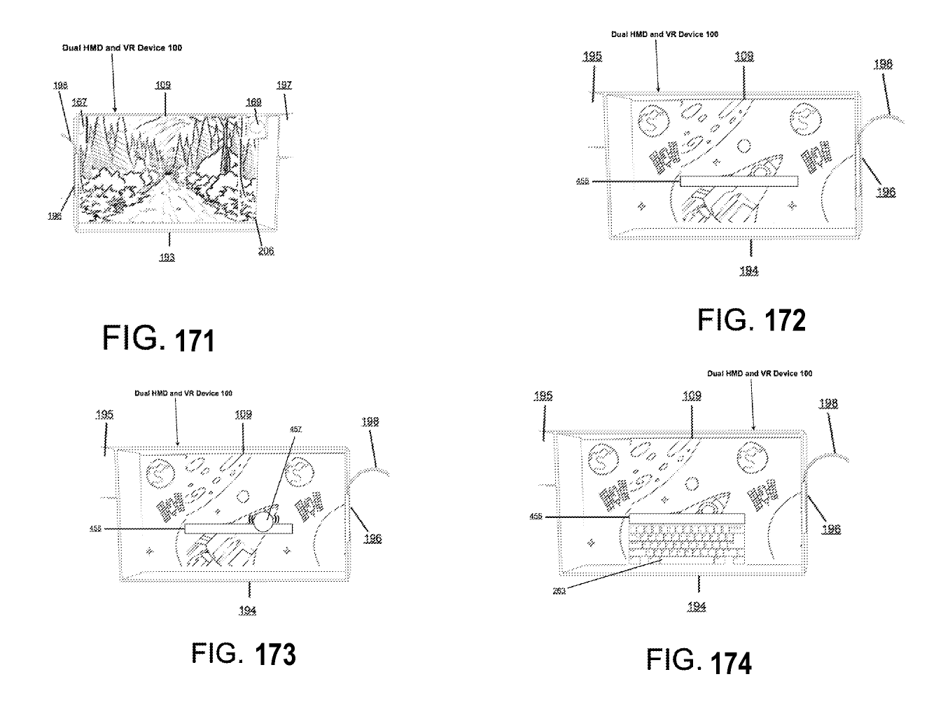

FIG. 172, shows that in VR worlds, games, or anything known as a graphical virtual world environment a text area 455 or text area(s) can exist for the users to interact with to input game commands or communicate with other users. The user can select the text box, by using any one of the aforementioned user input or control methods to select it.

In a non limiting example, FIG. 173 shows the user using by using the function of the speciality application for handset 171 which provides a cursor on display(s) 109, the user drags cursor 457 over text area 455 and then once the cursor is over text area 455, the user taps or otherwise interacts with the touch screen surface of the connected handset which has speciality application for handset 171 installed on it and currently open, to select text area 455.

Once selected as previously described within this disclosure regarding what happens when a text area is selected, soft keyboard mirroring module 132 contains software or instructions to bring up the connected handset's integrated soft keyboard 263 within speciality application for handset 171, to show the keyboard layout of the integrated soft keyboard 263 on display(s) 109 as shown in FIG. 174 and simultaneously activates soft keyboard mirroring module 132, as previously described within this disclosure, which is stored in interactions with applications installed on connected handset module 129 within memory 101 on Dual HMD and VR Device 100 to allow a user to use text input as a means of interacting with or controlling Dual HMD and VR Device 100 and to allow the user to be able to see where they are typing while wearing Dual HMD and VR Device 100 by mirroring the handset's integrated soft keyboard and the user's interactions with the integrated soft keyboard onto display(s) 109. Thus, the user can input text into text areas or other areas which require text within VR worlds, games, or anything known as a graphical virtual world environment.

In another non limiting example, FIG. 177 shows a graphical virtual world which uses custom control mirroring module 133, which was described earlier within this disclosure, to allow a custom game pad 499, to be used to control the graphical virtual world. The user, 501 in FIG. 178 presses the A button 500 on the control pad 499. As described previously within this disclosure, the same control pad is shown on display(s) 109 while the user is immersed in the graphical virtual world environment and shows the mirroring of the user's interactions of the gamepad, illustrated by circle 502 which represents that the user is currently pressing button A 500 on the gamepad by interacting with the touch screen surface of the connected handset by using their finger.

As a result of Dual HMD and VR Device 100 having an established bi-directional communication link with a connected handset in some embodiments, the connected handset is able to be used as an other external co-processing platform(s) 113. This means that software and instructions exist within Microprocessing Unit(s) 112 to delegate processing tasks to the microprocessing units within the connected handset and read and send data regarding processing tasks, when possible, over the bi-directional communication link established between Dual HMD and VR Device 100 and the connected handset to lessen or ease the amount of tasks or operations which must be processed by Dual HMD and VR Device 100. One skilled in the art will recognize that highly immersive experiences such as VR worlds, games, or anything known as a graphical virtual world environment require a lot of processing power. By delegating some processing tasks to other external co-processing platforms 113, issues such as faster battery burn out due to extreme microprocessor usage and most importantly, a slowness or lag in the performance of tasks or functionalities which provide the experience of VR worlds, games, or anything known as a graphical virtual world environment or objects or items within these worlds is negated.

In a non limiting example, if a user is playing a VR shooting game which contains software or instructions where when the user shoots at a target, which may in some embodiments be a vector image, a certain score is obtained, microprocessing unit(s) 112 over the bi-directional communication link established between the connected handset and Dual HMD and VR Device 100, sends data on the game's scoring system, such as algorithms to compute scores.

In a non limiting example, if the user is playing a VR shooting game, microprocessing unit(s) 112 over the bi-directional communication link established between the connected handset and Dual HMD and VR Device 100, can send data to the connected handset's microprocessing units regarding how scores for game events, such as the user shooting at vector image targets, are computed. In this game, when the user shoots at a target, a point value is obtained and added to the user's score. All of the point values obtained are added, resulting in a final score at the end of the game.

If the user shoots at a target, that is worth ten points, the microprocessing unit(s) within Dual HMD and VR Device 100 can send data over the bi-directional communication link established between Dual HMD and VR Device 100 to the microprocessing units within the connected handset that contains data which states that the user just scored ten points. Since the microprocessing units have already received data regarding how to compute scores, the microprocessing units takes the ten points that the user just accumulated and computes the current score of the game. Once this is computed, over the bi-directional communication link established between Dual HMD and VR Device 100 and the connected handset, the user's current score is sent to microprocessing unit(s) 112, which then works with the software or instructions of the game the user is playing, to display the current score 459 of the game on display(s) 109 as shown in FIG. 176.

It should be noted that this process of delegating processing tasks to connected handsets could potentially also be used for HMD applications which require a lot of processing tasks to run.

Dual HMD and VR Device 100 also has the capability to provide a 360 degree graphical virtual world environment which encompasses the user completely. Humans, in real life, can turn their bodies to the direction in which they want to face, which is any direction within 360 degrees and move forward, backward, left, right, diagonally, etc from whatever position they are in. Depending on the direction and distance of our movement, humans either end up viewing objects within our field of view at a different angle or what we see in our field of view changes entirely because we are exposed to more of the environment that we are surrounded by.

In order to provide an environment like this, a way to allow the user to experience VR worlds, games, or anything known as a graphical virtual world environment in such a way that they are similar to the environments that we live, work, and play in, which fully encompasses us and which allow us to move through these VR worlds, games, or anything known as a graphical virtual world environment similar to the way we move through the real world, special software and or instructions must be used that will now be described.

Stored in Launcher Module 204 is software or instructions to allow the VR worlds, games, or anything known as a graphic virtual world environment, to extend past the boundaries of the display(s) 109 that the user is looking at, for the VR worlds, games, or anything known as a graphic virtual world environment to be an environment which encompasses the user, and for the user to be able to use any of of the aforementioned user input or control methods of this device to be able to change the direction in which the user is facing, which in some positions may change their field of view, to be moved in any direction that is 360 degrees or less, and instructions for the user to be able to move in various directions along the degree that they choose. These softwares and or instructions allow virtual worlds to be created that fully encompass the user.

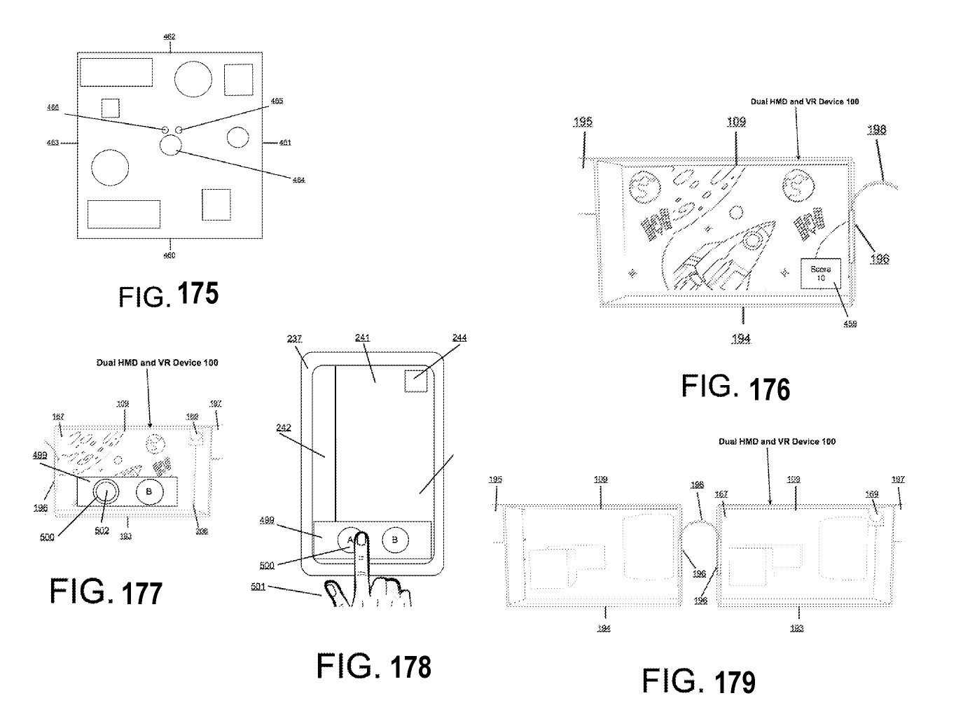

The best way to illustrate this, is to use a common non limiting example such as a room, and turn it into a graphical virtual world environment. FIG. 175 shows an overhead view of a virtual world environment that is a large room. The four lines 460, 461, 462, and 463, which make up the walls of the room, in this non limiting example, they serve as the boundaries of the graphical virtual world environment. This means that the user cannot move past or outside of these boundaries. It should be noted that not ALL VR worlds, games, or anything known as a graphical virtual world environment will have square, box, or line like boundaries. One skilled in the art will realize that a graphical virtual world environment in an overhead view can take on the shape of many geometric or custom shapes. Circle 464 in FIG. 175 represents the position of the user in the graphical virtual world environment. Circles 465 and 466 show the eyes of the user and therefore illustrate what direction they are currently looking in. The various geometric objects within the area that lines 460, 461, 462, and 463 surround show an overhead view of various objects that exist within the virtual world environment.

It should be obvious to one skilled in the art that the user, can be positioned virtually anywhere within the boundaries of the graphical virtual world environment. In a sense, circle 464 illustrates how when in real life, when we stand in the middle of a room, we are encompassed or surrounded by the boundaries of that room and what is contained in it.

FIG. 179 shows a view of the graphical virtual world environment, as it is seen by the user as they look at display(s) 109 to view it. Comparing FIG. 175 to FIG. 179 it is obvious that FIG. 179 shows exactly what the user sees from the positioning that they are in FIG. 175.

As previously described, in real life, when humans turn or adjust their bodies in the direction that they want to face, the human has the option to turn their body in a circle, or within any direction that is within 360 degrees or less. 360 degrees is the degree measure of a circle. Humans also can move our bodies forward, backward, left, right, diagonally, etc from whatever position we are in.

The software or instructions previously described within Launcher Module 204 allows this motion to occur with in VR worlds, games, or anything known as a graphic virtual world environment, and how it occurs will now be described by using both drawings that are overhead views and drawings that are what the user sees while wearing Dual HMD and VR Device 100 and are performing these functions.

FIG. 175, shows an overhead view of the user's, represented by circle 464, current position in a VR world and where their eyes, represented by 465 and 466 are located. The user wants to change the position in which they are facing. Now various non limiting examples will be provided regarding how the user can perform this function. FIG. 179 shows what the user sees in the position they are in, in FIG. 175.

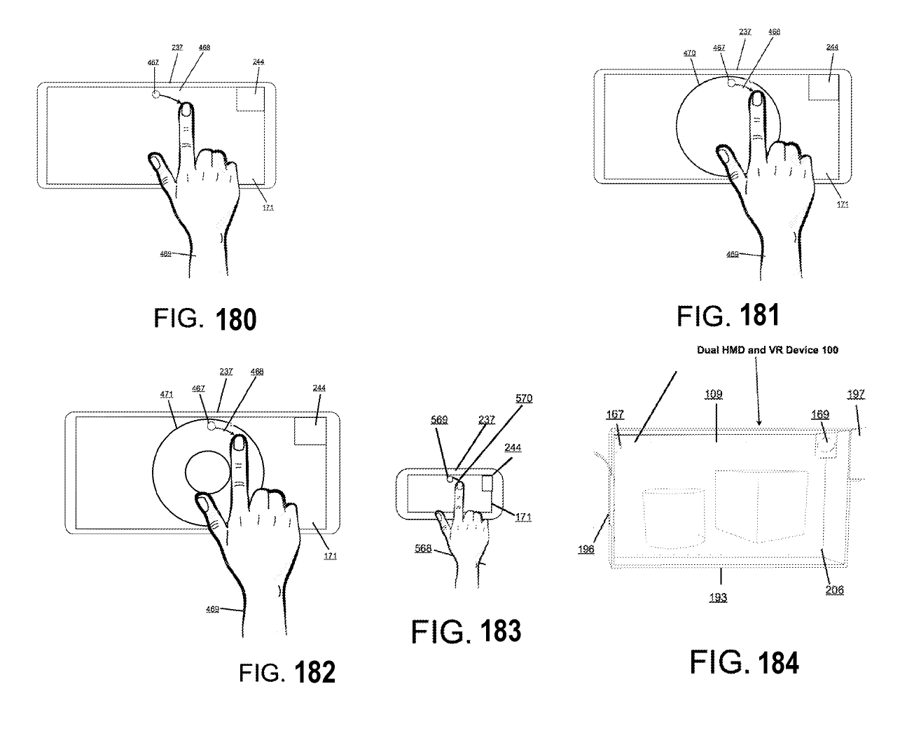

In a non limiting example, the user can drag their finger(s) or thumb(s) along the touch screen surface of the connected handset while specialty application for handset 171 is open, in a motion that is similar to someone slowly tracing a circle with their finger as shown in FIG. 180. FIG. 180 is an enlarged view of a connected handset which is connected to Dual HMD and VR Device 100 which has speciality application for handset 171 open. In FIG. 180 circle 467 is just a circle used to illustrate the starting position of the user and may not be present in all embodiments. Curved arrow 468 which occurs between circle 467 and the user's finger 469 illustrates the distance and direction that the user moved their finger along the touch screen surface, which is in a curve. In some embodiments, a circle 470 may be present within speciality application for handset 171 for the user to carry out this function on as shown in FIG. 181. In some embodiments a donut shape 471 or circle lacking a center may be present within speciality application for handset 171 for the user to carry out this function on as shown in FIG. 182.

In other embodiments, when the speciality application for handset 171 detects that the user is performing this motion on the touch screen surface of the connected handset, a circle may automatically appear beneath the users finger(s) or thumb(s), for the user to trace with their finger. In some embodiments, when the speciality application for handset 171 detects that the user is performing this motion on the touch screen surface of the connected handset, a donut shape or circle lacking a center may automatically appear beneath the users finger(s) or thumb(s), for the user to trace with their finger(s) or thumb(s). As the user performs this circular motion, the position of the user within the virtual world changes.

In this non limiting example, we will illustrate the user changing their position a full 360 degrees. FIG. 175 should be considered the starting position of the user or in the first movement, the place where the user moved from to get to the area they are in at the end of this example.

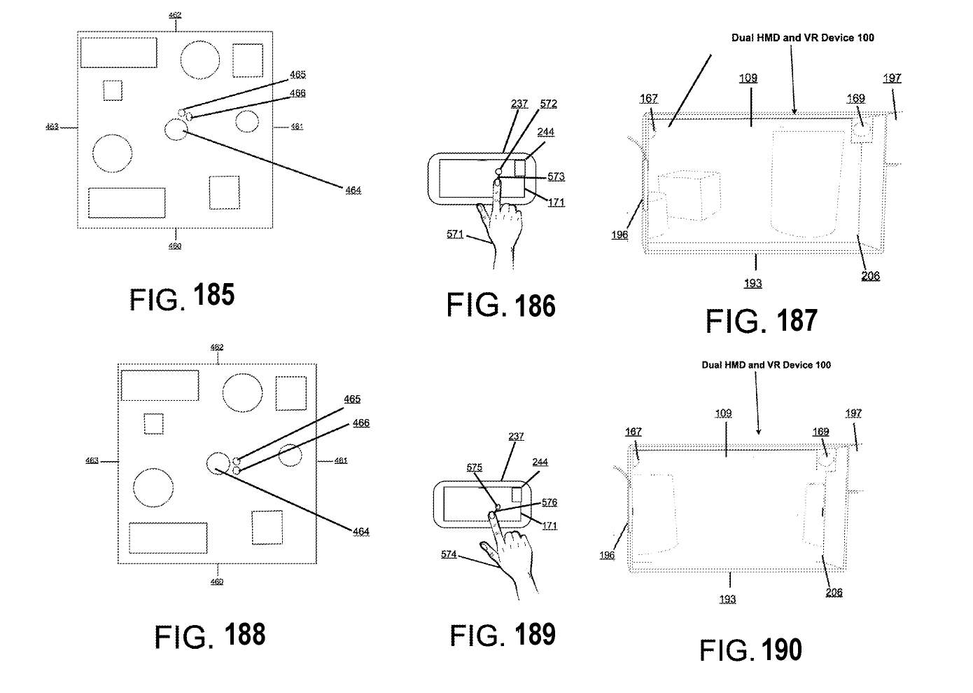

FIG. 183 and FIG. 184 show the user moving their finger 568 in a circular motion within speciality application for handset 171 and in response, the position of the user in the graphical virtual world environment changes, thus what they see within their field of view, as shown on display(s) 109 changes. Circle 569 is where the users thumb(s) or finger(s) began moving from and curved line 570 illustrates the direction of the thumb(s) or finger(s) movements, which is in a curve. FIG. 185 is an overhead view illustrating how the direction of the user's body 464 has changed in the graphical virtual world environment and where their eyes 465 and 466 would be located if they changed their position in real life.

FIG. 186 and FIG. 187 show the user moving their finger 571 in a circular motion within speciality application for handset 171 and in response, the position of the user in the graphical virtual world environment changes, thus what they see within their field of view, as shown on display(s) 109 changes. Circle 572 is where the users thumb(s) or finger(s) began moving from and curved line 573 illustrates the direction of the thumb(s) or finger(s) movements, which is in a curve. FIG. 188 is an overhead view illustrating how the direction of the user's body 464 has changed in the graphical virtual world environment and where their eyes 465 and 466 would be located if they changed their position in real life.

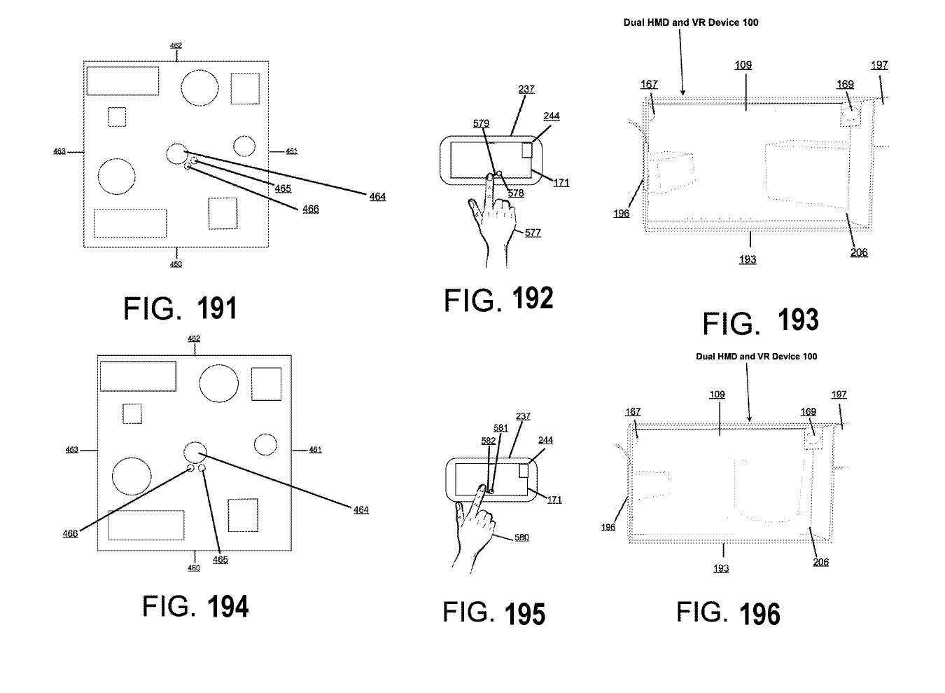

FIG. 189 and FIG. 190 show the user moving their finger 574 in a circular motion within speciality application for handset 171 and in response, the position of the user in the graphical virtual world environment changes, thus what they see within their field of view, as shown on display(s) 109 changes. Circle 575 is where the users thumb(s) or finger(s) began moving from and curved line 576 illustrates the direction of the thumb(s) or finger(s) movements, which is in a curve. FIG. 191 is an overhead view illustrating how the direction of the user's body 464 has changed in the graphical virtual world environment and where their eyes 465 and 466 would be located if they changed their position in real life.

FIG. 192 and FIG. 193 show the user moving their finger 577 in a circular motion within speciality application for handset 171 and in response, the position of the user in the graphical virtual world environment changes, thus what they see within their field of view, as shown on display(s) 109 changes. Circle 578 is where the users thumb(s) or finger(s) began moving from and curved line 579 illustrates the direction of the thumb(s) or finger(s) movements, which is in a curve. FIG. 194 is an overhead view illustrating how the direction of the user's body 464 has changed in the graphical virtual world environment and where their eyes 465 and 466 would be located if they changed their position in real life.

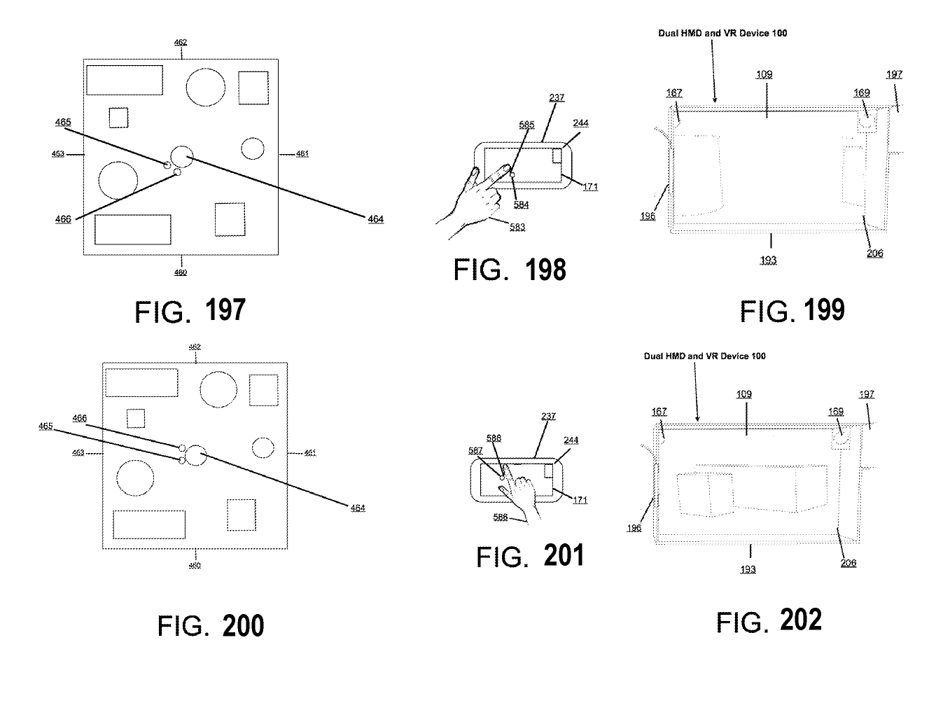

FIG. 195 and FIG. 196 show the user moving their finger 580 in a circular motion within speciality application for handset 171 and in response, the position of the user in the graphical virtual world environment changes, thus what they see within their field of view, as shown on display(s) 109 changes. Circle 581 is where the users thumb(s) or finger(s) began moving from and curved line 582 illustrates the direction of the thumb(s) or finger(s) movements, which is in a curve. FIG. 197 is an overhead view illustrating how the direction of the user's body 464 has changed in the graphical virtual world environment and where their eyes 465 and 466 would be located if they changed their position in real life.

FIG. 198 and FIG. 199 show the user moving their finger 583 in a circular motion within speciality application for handset 171 and in response, the position of the user in the graphical virtual world environment changes, thus what they see within their field of view, as shown on display(s) 109 changes. Circle 584 is where the users thumb(s) or finger(s) began moving from and curved line 585 illustrates the direction of the thumb(s) or finger(s) movements, which is in a curve. FIG. 200 is an overhead view illustrating how the direction of the user's body 464 has changed in the graphical virtual world environment and where their eyes 465 and 466 would be located if they changed their position in real life.

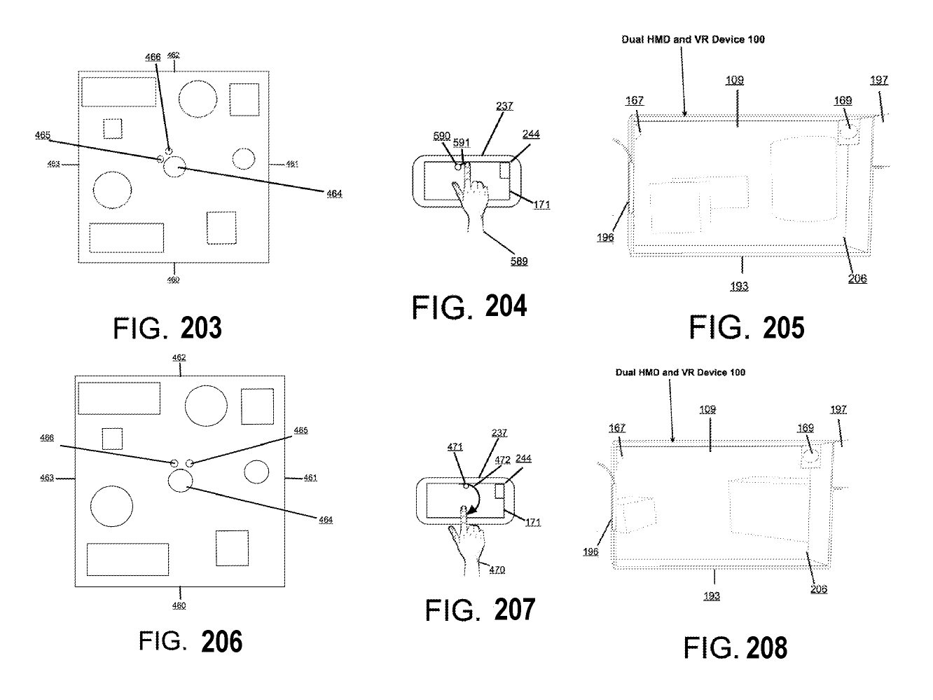

FIG. 201 and FIG. 202 show the user moving their finger 586 in a circular motion within speciality application for handset 171 and in response, the position of the user in the graphical virtual world environment changes, thus what they see within their field of view, as shown on display(s) 109 changes. Circle 587 is where the users thumb(s) or finger(s) began moving from and curved line 588 illustrates the direction of the thumb(s) or finger(s) movements, which is in a curve. FIG. 203 is an overhead view illustrating how the direction of the user's body 464 has changed in the graphical virtual world environment and where their eyes 465 and 466 would be located if they changed their position in real life.

FIG. 204 and FIG. 205 show the user moving their finger 589 in a circular motion within speciality application for handset 171 and in response, the position of the user in the graphical virtual world environment changes, thus what they see within their field of view, as shown on display(s) 109 changes. Circle 590 is where the users thumb(s) or finger(s) began moving from and curved line 591 illustrates the direction of the thumb(s) or finger(s) movements, which is in a curve. FIG. 206 is an overhead view illustrating how the direction of the user's body 464 has changed in the graphical virtual world environment and where their eyes 465 and 466 would be located if they changed their position in real life. It should be realized that in this position the user has returned to the point that they originated from and in the examples just provided, the user just turned the direction of their body a full 360 degrees within the graphical virtual world, while in the physical world their body remained stationary. It should be obvious, by these illustrations, that the changing of the direction that the user is facing occurs in the exact same manner as if does when the user turns their body around in a circle in real life.

To create this effect, software or instructions are stored within Launcher Module 204 to change the positioning of the VR worlds, games, or anything known as a graphic virtual world environment in a direction based off of the direction the user is moving their finger in. In the example above, the user is moving their finger to the right. In response, to move the graphical virtual world environment to make it seem like the user is turning around towards the right, the graphical virtual world environment actually moves itself towards the left. If the user was moving their finger to the left, the graphical virtual world environment would actually move itself to the right.

When the user is in the orientation they want to be in, to stop moving, the user can remove their finger from the touch screen, breaking contact from the touch screen of the connected handset where speciality application for handset 171 is open. In some embodiments, this may occur by the user using a multi touch gesture on the touch screen of the connected handset where speciality application 171 is open, by pressing a button or buttons connected handset, by pressing a button on Dual HMD and VR Device 100, or by using any other aforementioned user input, control, or interaction method previously described within this disclosure. The example illustrated above where the user turned 360 degrees, should be thought of as an example where the user continually dragged their finger on the touch screen surface to turn 360 degrees and did not break contact with it.

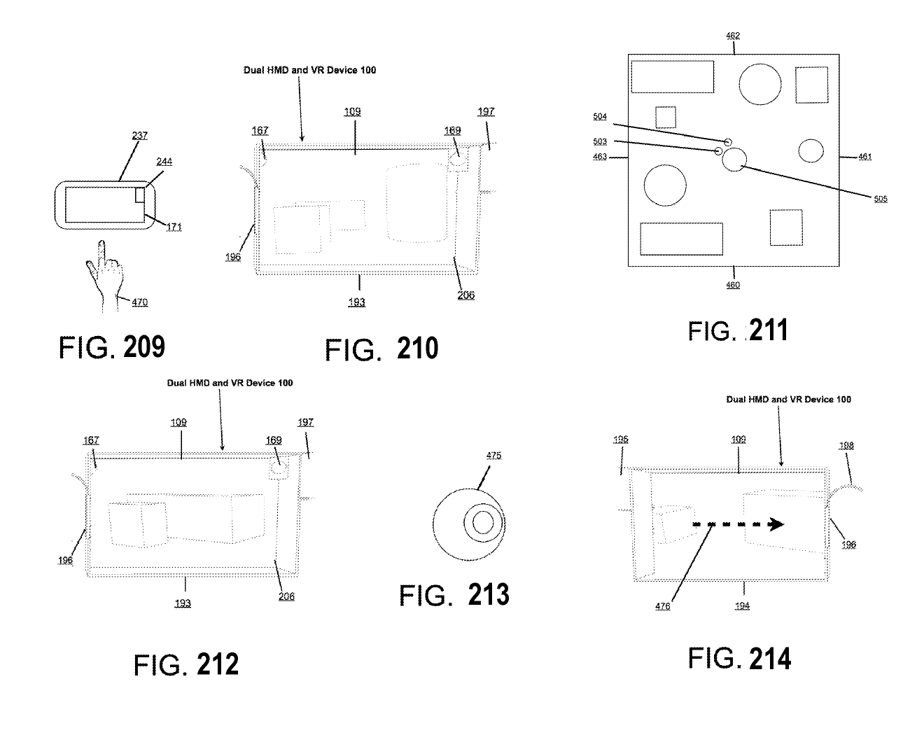

In a non limiting example, the user 470 decides to change their direction 180 degrees to see what is behind them, by moving their finger as shown in FIG. 207 on the touch screen of the handset where speciality application for handset 171 is open. Circle 471 shows the starting position of the user's 470 finger and curved arrow 472 shows the direction the user 470 has moved their finger in. Once the user is in the position that they want to be in as shown in FIG. 196, the user 470, as shown in FIG. 209, then breaks contact with the touch screen of the connected handset where speciality application for handset 171 is open and then the user remains in the position that they were in when their finger broke contact with the handset as shown in FIG. 208.

Iris movements can be used to change what the user sees or in other embodiments, the direction that they are facing. In some embodiments, the user activates iris controlled movements and then moves their eyes to the left or right, only to see a small fraction more of the VR world, game, or anything that can be defined as a graphic virtual world environment or only changing the angle at which they are viewing what they are looking at. This was discussed in regards to virtual worlds earlier within this disclosure.

In other embodiments, iris controlled movements can be used to change the direction in which the user is facing. Software or instructions contained in Launcher Module 204 allow the user by activating iris controlled movements and moving their eyes in a direction and holding their eyes in that position as the VR world, game, or anything known as a graphic virtual world environment, moves in response to the direction in which the user is moving their eyes, so the user can change their position to be anywhere within 360 degrees or less. Once the user is positioned in the direction in which they desire, the user then stops holding their eyes in the direction and they remain in the direction in which they desire.

In a non limiting example, FIG. 211 shows an overhead view the user 505 in their starting position. Circle 503 and circle 504 represent the positioning of the users eyes if they were a part of the virtual world environment, when in reality, the user's eyes are seeing what is shown on display(s) 109. FIG. 212 shows what the user sees on display(s) 109 in their starting position.

FIG. 213 shows the user moving their eye 475 to the right while iris controlled movements are activated and holding their eye in that position, and in response the graphical virtual world environment moves as shown in FIG. 214. The direction of the movement is illustrated by arrow 476 in FIG. 214. Software or instructions exist within Launcher Module 204 to move the graphical virtual world environment to make it seem like the user is turning around towards the right, by actually moving the graphical virtual world environment towards the left. If the user was holding their eye to the left, the graphical virtual world environment would actually move itself to the right.

The graphical virtual world environment will continue to move until the user confirms that they are in the direction they want to be in by moving their eye back to it's original position, deactivating iris movements, blinking, pressing a button on Dual HMD and VR Device 100, or by using any other aforementioned user input, control, or interaction method previously described within this disclosure to remain in the direction that they desire to be in.

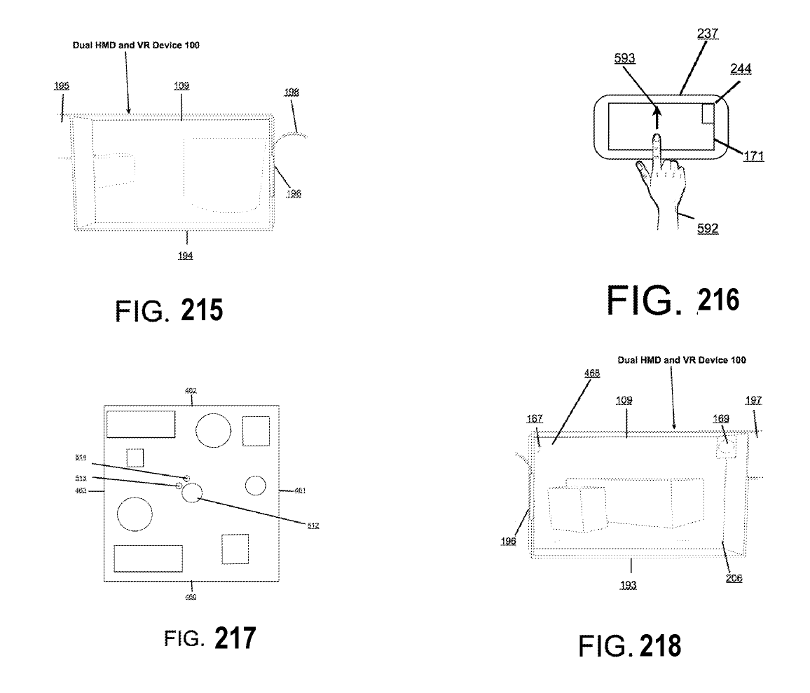

Once the user selects the direction software or instructions stored within launcher model 204 adjusts the position so that the selected position is shown in the middle of display(s) 109 shown in FIG. 215. This is done, because when you are moving your eyes by using iris controlled movements your eyes are turned in the position that you want the VR world, game, or anything known as a graphic virtual world environment to move in and once you stop doing that movement your eyes then moved back to looking straight ahead or back to their starting position. Thus, it is important to put what the user sees at the direction that the user chose in the center of display(s) 109 so it can continue to be looked at with ease.

Voice recognition can be utilized to change the direction in which the user is facing within VR worlds, games, or anything known as a graphic virtual world environment.

In most embodiments the software steadily turns the user's field of view, as if the user is turning in real life as illustrated in previous examples. In other embodiments, the software may not turn the user in the way previously described but may just show them what they want to see without going through the process of turning the users body around. For instance, if the user said “face: behind” instead of going through the process of having the virtual world turn, the software or instructions may have what's behind the user show automatically on screen. This would take less time and less processing power.

In other embodiments, button presses of the connected handset or of duel HMD and VR Dual HMD and VR Device 100 could be allocated for changing the users orientation.

Now that a discussion has occurred about how the user can change the direction they are facing within the VR worlds, games, or anything that can be described as a graphical virtual world environment, a discussion will now take place about how the user can move left, right, forward, backward, diagonal, etc from whatever position they are in just as a human would in real life within these VR worlds, games, or anything that can be described as a graphical virtual world environment.

The software or instructions previously described within Launcher Module 204 allows this motion to occur with in VR worlds, games, or anything known as a graphical virtual world environment, and how it occurs will now be described by using both drawings that are overhead views and drawings that are what the user sees while wearing Dual HMD and VR Device 100 and are performing these functions.

In a non limiting example, the user 592 can drag their finger(s) or thumb(s) along the touch screen surface of the connected handset while specialty application for handset 171 is open, in a forward motion, as shown in FIG. 216. Arrow 593 illustrates the direction in which the user 592 is dragging their finger. It should be noted that regardless of if the user performs this motion whether the handset is in portrait or landscape orientation, the connected handset is able to detect that the user intends on moving forward. This is because of software which exists in most touch screen handsets that works in unison with motion sensor array(s) which exist within the handsets to correctly detect the position and orientation of the handset to ensure that interactions and the position and intended direction that these interactions are performed in, on the touch screen of the handset are correctly translated and detected via software regardless of the position that these interactions are performed in.

FIG. 217 shows an overhead view the user 512 in their starting position. Circle 513 and circle 514 represent the positioning of the users eyes if they were a part of the virtual world environment, when in reality, the user's eyes are seeing what is shown on display(s) 109. FIG. 218 shows what the user sees on display(s) 109 in their starting position.

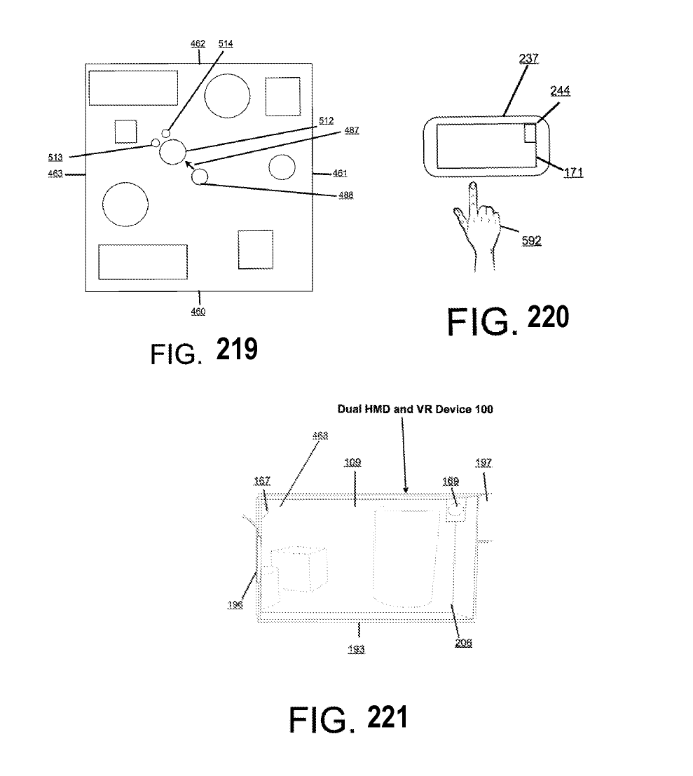

FIG. 219 is an overhead view, which results in response to the user dragging or swiping their finger(s) or thumb(s) forward along the touch screen surface of the connected handset while speciality application for handset 171 is open, moving the user 512 from starting point 488 forward, as illustrated by arrow 487 and then the user 592 as shown in FIG. 220, breaking contact with the touch screen of the connected handset while speciality application for handset 171 is open, which stops the forward movement of the user. The position the user chose to stop at is the position in which user 466 is located in FIG. 221.

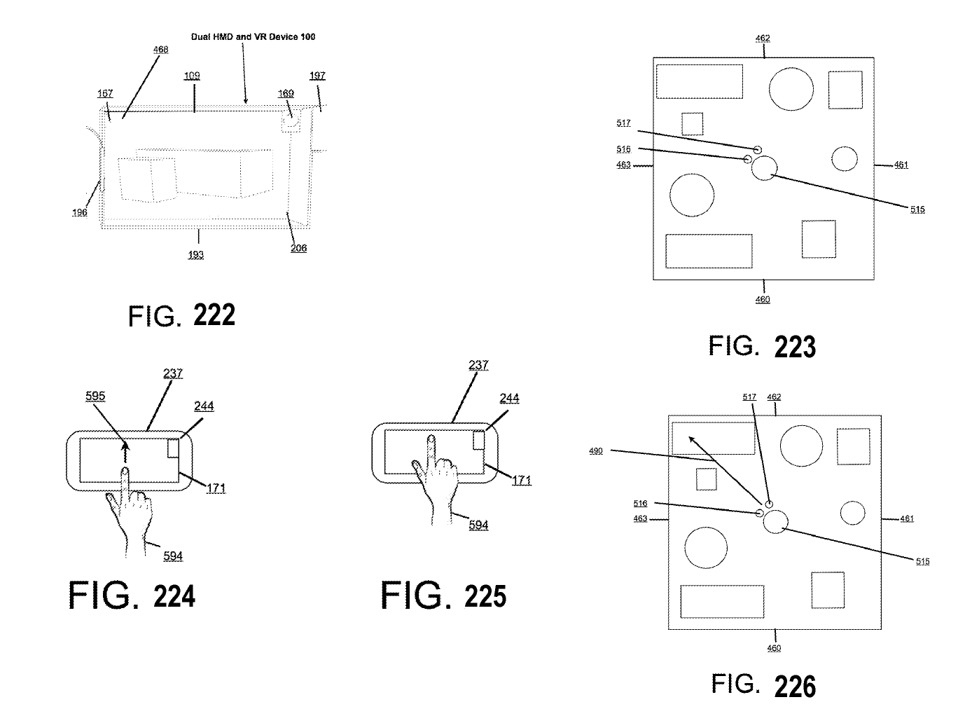

As a result of the user moving forward, what they see on display(s) 109 changes as a result as shown in FIG. 222. This method only moves the user a minimal amount. In some embodiments, when using this method, the user may use repeated drags or swipes to move forward more.

The user 594 can drag or swipe their finger(s) or thumb(s) in the forward position, illustrated by arrow 595, in FIG. 224 and then hold their finger(s) or thumb(s) in the position that that their finger(s) or thumb(s) ended up in as a result of moving forward as shown in FIG. 225 on the touch screen surface of the connected handset.

FIG. 223 shows an overhead view the user 515 in their starting position. Circle 516 and circle 517 represent the positioning of the users eyes if they were a part of the virtual world environment, when in reality, the user's eyes are seeing what is shown on display(s) 109. FIG. 222 shows what the user sees on display(s) 109 in their starting position.

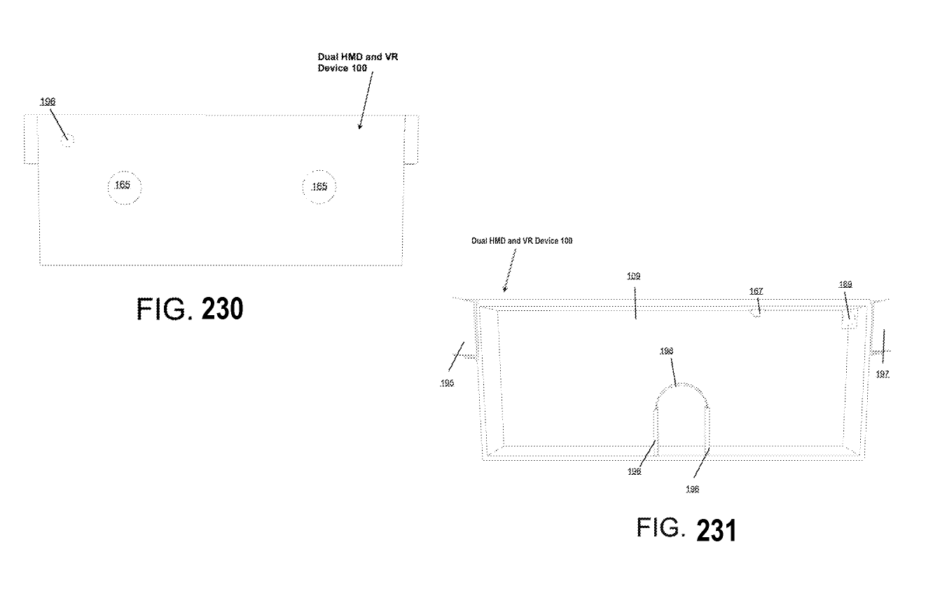

In response to the user dragging their finger(s) or thumb(s) in the forward position and then holding their finger(s) or thumb(s) in the position that that their finger(s) or thumb(s) ended up in as a result of dragging their finger(s) or thumb(s) forward, the user continuously moves in a forward direction as illustrated by arrow 490 shown in FIG. 226 which is an overhead view of the users position in the graphical virtual world environment. The user continues to move forward until they break contact with the touch screen when they are satisfied with their position in the virtual world environment as shown in FIG. 230. Arrow 519 in FIG. 228 illustrates the movement of the user from starting point 518 to their current position.

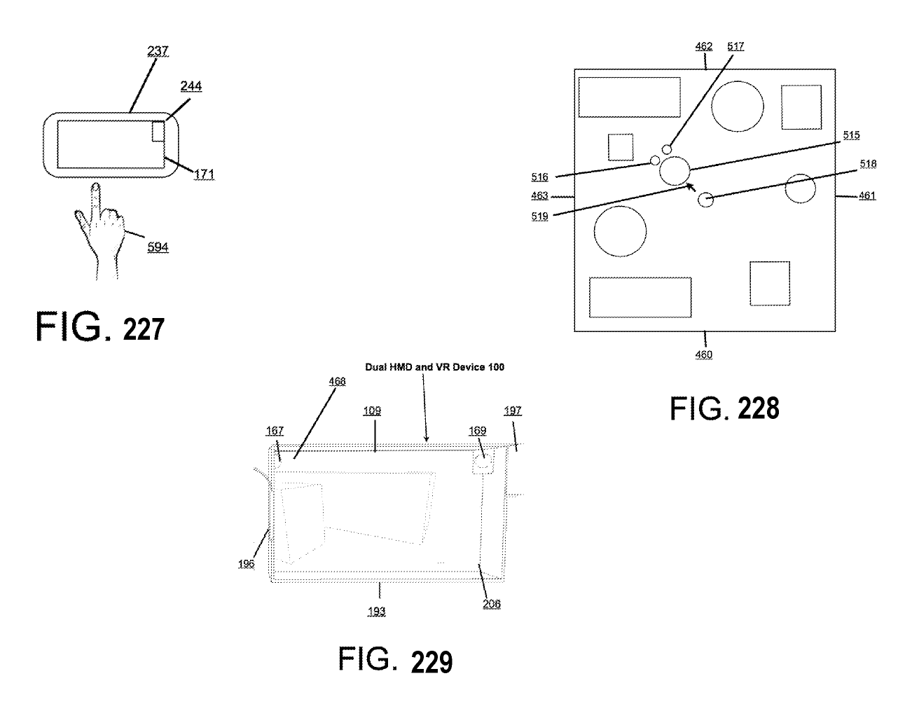

By breaking contact with the touch screen as shown in FIG. 227, the user stops moving. FIG. 228 is an overhead view of the user's 515 position in the graphical virtual world environment as a result of moving forward and then the user breaking contact with the touch screen when they became satisfied with their position within the graphical virtual world environment. As a result of the user moving forward, what they see on display(s) 109 changes as a result as shown in FIG. 229.

In some embodiments, the pressure that the user puts on the touch screen as they drag and release or drag and then hold their finger(s) or thumb(s) in a forward position or the rate of speed in which they carry out the motion of moving their finger(s) or thumb(s) in a forward position may influence how fast or slow the user moves through the VR worlds, games, or anything known as a graphical virtual world environment.

It should be obvious to one who is skilled in the art that these methods of moving forward can be used to move the user left, right, backwards, diagonal, etc, it just depends on where they interact with the touch screen. [[More non limiting examples will now be discussed to ensure this concept is fully grasped.]]

The user can use voice recognition to move left, right, forward, backward, diagonal, etc. This will now be discussed.

In yet another non limiting example, the user activates voice recognition and says “Move: Forward.”

In response to the user saying “Move: Forward”, the user begins to move forward. The user continues to move forward until they reactivate voice recognition and say “Stop” when they are satisfied with their position in the virtual world environment.

Voice recognition can also be used to allow the user to change their direction and move simultaneously.

In a non limiting example, the user activates voice recognition and says “Face: Right, Move: Forward.” First the user is moved within the graphical virtual world environment to be moved to the right. Because the user commanded their position to change to the right, in response, to move the graphical virtual world environment to make it seem like the user is turning around towards the right, the graphical virtual world environment actually moves itself towards the left. If the user commanded for their position to be moved to the left, the graphical virtual world environment would actually move itself to the right.

Now that the user is in this position the user begins moving forward. Once the user is in the position they want to be in, they activate voice recognition and say “Stop.”

To one skilled in the art it should be obvious that there are many combinations possible and that the user doesn't always have to state the direction that they want to face before stating the direction they want to move in. The direction the user wants to move in could be stated first, followed by the position the user wants to be in, so the user could move and then change the direction they are facing.

In some embodiments, iris movements, turns of the head which trigger the motion sensor array 158 within Dual HMD and VR Device 100, buttons on the connected handset, and buttons that are a part of Dual HMD and VR Device 100 may be used to move the user left, right, forward, backward, diagonal, etc. It should be noted that using these methods interaction or control to move the user in the directions described isn't necessarily practical, however a gifted programmer or developer may create a VR worlds, games, or anything known as a graphic virtual world environment that has an ingenious method for using these methods of interaction of control to move the user in the directions described with ease.

As described earlier within closure it should be noted that VR worlds, games, or anything that can be described as a graphical virtual world environment can be created for this device to be as immersive or not immersive as a developer wants the worlds to be. Thus meaning that in some VR worlds, games, or anything that can be described as a graphical virtual world environment, that user may not be able to move as freely in all directions.

In another version of the invention Dual HMD and VR Device 100 has a single display for display(s) 109, as shown in FIGS. 230 and 231. It should be obvious, that to accommodate a single display, in most embodiments, as shown in the figures just referenced, that the design of the cases of the invention would have to change. As just as they exist previous embodiments, this version of the invention Dual HMD and VR Device 100 has camera(s) 165 on it. In some embodiments, of this version of the invention has multiple cameras.

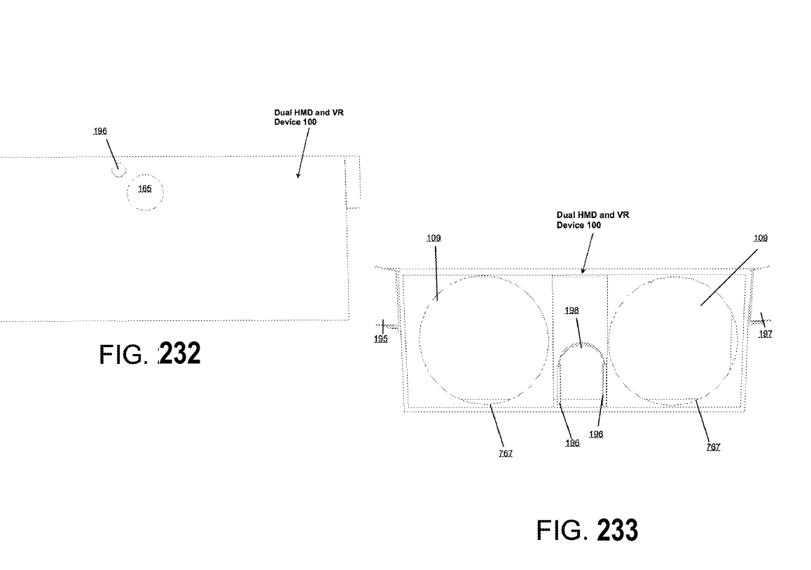

In other embodiments, this version of the invention has a single camera 165, as illustrated in FIG. 232, which serves a non limiting example. When Dual HMD and VR Device 100 is a single camera embodiment, software or instructions are included within Camera Feed Module 119 which include instructions to manipulate the real time video feed that is captured by the single camera to generate two similar but different views of the real time video feed to be shown to each eye, instructions to adjust the cameras (example: zoom), instructions to display each view generated from the single camera video feed on a separate display.

Again, FIG. 24 serves to illustrate how the live video feed is separated into two separate but intersecting field's of view so that each view is shown on a separate display included in display(s) 109 and still creates a flawless field of view for the user. Square 765 is from the left most camera, square 766 is from the right most camera, and the section where they overlap is where their field of view intersects. Since in the region of intersection, both views show the same or similar view when they are displayed on display(s) 109, the image merging power of the brain works to merge the images into one flawless scene.

It should be noted that in some embodiments, software or instructions are included within Camera Feed Module 119 to display each view taken from the single camera video feed on a display of display(s) 109 which relates to each field of view's position. A non limiting example of this would be, that a view taken from the left most area of the field of view in which the single camera acquires would show on the display of display(s) 109 which rests in front of the user's left eye. Another non limiting example of this would be, that a view taken from the right most area of the field of view in which the single camera acquires would show on the display of display(s) 109 which rests in front of the user's right eye.

Nose pad(s) 196 measure between a quarter inch to one and a quarter inch high. Nose pad(s) 196 measure between one sixteenth of an inch to one half inch in width. This embodiment of the invention has two nose pads. In some embodiments, nose pad(s) 196 may not have a slight curvature to them. Nose pad(s) 196 function in the same way that nose pad(s) do on a pair of eye glasses, to provide comfort for the wearer.

In some embodiments, nose pad(s) 196 and case 198 (which may be known in some embodiments as a nose bridge) may not be included, depending on the design and construction of Dual HMD and VR Device 100.

As discussed regarding previous embodiments within this disclosure, the user may wear a contact lens or contact lenses on each eye as the contact lens 759 shown in FIG. 11 which is a view of the aspect contact lens that when worn faces away from the eye, and FIG. 12 which is a side view of the aspect contact lens that when worn faces away from the eye, when using Dual HMD and VR Device 100.

FIG. 233 illustrates another version of embodiment of Dual HMD and VR Device 100 which was illustrated in FIGS. 2-7, which includes one or more optical lenses 767, which are positioned in front of display(s) 109. As seen in FIG. 301, the user would look through the optical lenses 767 to view display(s) 109. These embodiments include supplementary light source for optical sensors 167 and optical sensor(s) 164, they are unable to be seen in these illustrations due to the lenses. In some embodiments, they may be a custom shape, not the expected circular shape and in some embodiments not covering up the screen a bit like in the previous example, as shown in non limiting example, FIG. 234 which optical lenses 768 which are a rectangular shape.

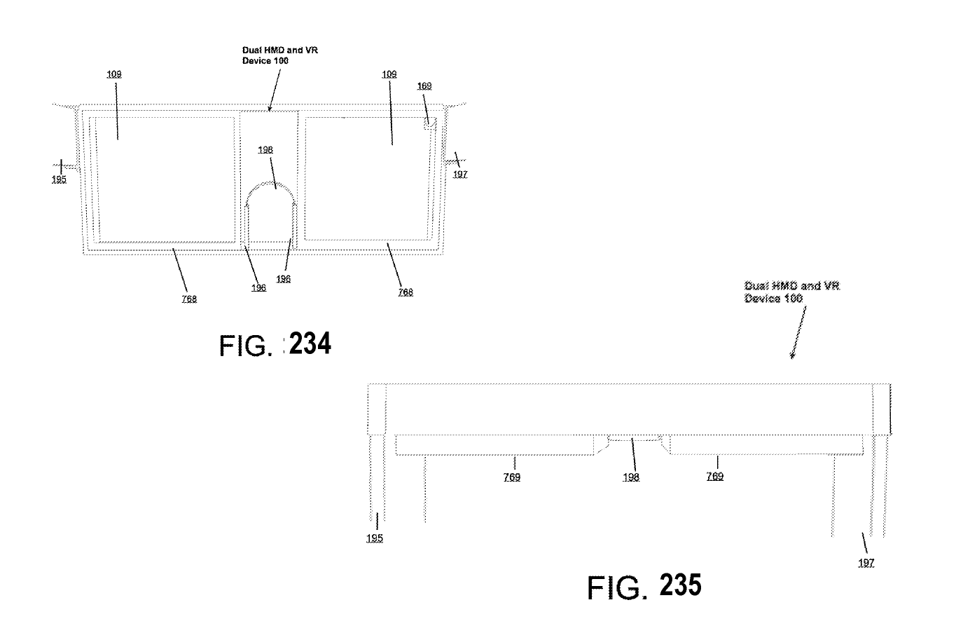

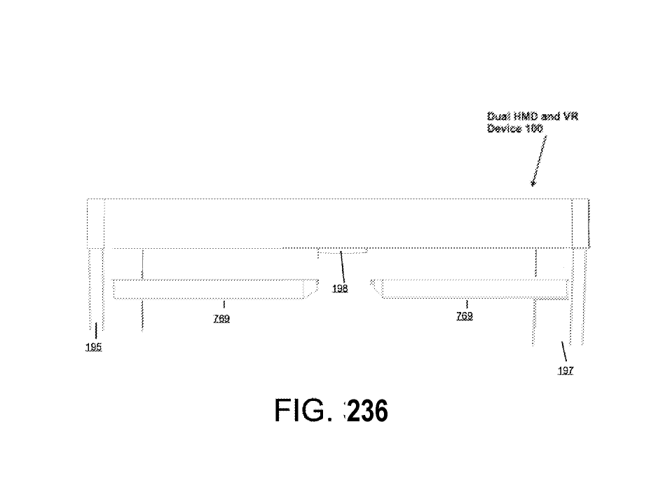

In other embodiments, these lenses may be removable, and be able to be removed and attached or reattached to the device as the user sees fit using any method which is appropriate for objects have the ability to be removed, attached, or reattached to and from other objects. It should be obvious to one skilled in the art that many ways can be devised to create a method of removing and attaching optical lenses to Dual HMD and VR Device 100. FIGS. 235 and 236 illustrates an overhead view non limiting example, where the optical lenses 769 are encased in a casing which allows optical lenses 769 to press fit on and off of Dual HMD and VR Device 100. As discussed regarding previous embodiments within this disclosure, the user may wear a contact lens or contact lenses on each eye as the contact lens 759 shown in FIG. 11 which is a view of the aspect contact lens that when worn faces away from the eye, and FIG. 12 which is a side view of the aspect contact lens that when worn faces away from the eye, when using Dual HMD and VR Device 100.

Software or instructions are included within HMD module 125 to split the display vertically down the middle so it is recognized by software and instructions as two separate displays. This is so, an identical GUI or whatever is being shown on display(s) 109 from within the HMD aspect of the device can be displayed just as it would be in a multi display embodiment, without software, instructions, or programs having to be rewritten or modified to support a single display embodiment of Dual HMD and VR Device 100.

Software or instructions are also included within VR module 126 to split the display vertically down the middle so it is recognized by software and instructions as two separate displays. This is so, anything classified as a Real Life Virtual World, VR, world, game, or anything that can be described as a graphical virtual world environment can be displayed just as it would be in a multi display embodiment, without software, instructions, or programs having to be rewritten or modified to support a single display embodiment of Dual HMD and VR Device 100.

In an aspect of all embodiments of the invention, Dual HMD and VR Device 100, it is thought that all of the components (for example, the camera(s) 165) can be interchangeable as new technology becomes available. In a non limiting example, this would allow the user to replace the camera or camera(s) which make up camera(s) 165 when an upgraded camera becomes available.

What is claimed, is:

1. A Dual HMD and VR Device, including:
one or more displays;
one or more microprocessing units;
memory;
RF circuitry;
one or more cameras, and
one or more programs, where the one or more programs are stored in the memory and configured to be executed by the one or more microprocessing units, they include instructions to obtain a video feed from one or more cameras;
instructions to display a video feed on each display;
instructions to, identically layer anything that can be defined as graphics, text, interfaces, applications, and the like over the video feed shown on each display;
instructions to position the graphics, text, interfaces, applications, and the like which are layered over the video feed along the z-axis so that they appear as though they are floating, not obstructing the users view in anyway; and
instructions to add opacity and transparency to anything that can be defined as graphics, text, interfaces, applications, and the like which are displayed on top of the video feed.
The device of claim one, wherein only one display is included, and one or more programs, where the one or more programs are stored in the memory and configured to be executed by the one or more microprocessing units, they include:
to split the display down the middle vertically, and for software or instructions to recognize each section of the split display as two separate displays.
The device of claim one, wherein only one camera is included, and one or more programs, where the one or more programs are stored in the memory and configured to be executed by the one or more microprocessing units, they include
instructions to taking the video feed obtained from a single camera and manipulate it into two video feeds to be shown on the display or displays
The device of claim one, wherein more than camera exists, and one or more programs, where the one or more programs are stored in the memory and configured to be executed by the one or more microprocessing units, they include:
instructions to display the video that was acquired with each camera onto the display or display(s) in which the cameras reside in front of.
The device of claim one, further comprising one or more optical lenses.
The device of claim one, further comprising one or more contact lenses.
The device of claim one, further comprising one or more contact lenses and one or more optical lenses.
The device of claim one further comprising one or more external co processing platforms.
The device of claim one, further comprising
light sensor(s); and one or more programs, where the one or more programs are stored in the memory and configured to be executed by the one or more microprocessing units, they include
instructions to detect the lighting and changes in lighting of the outside environment;
instructions to change the display brightness based on the lighting of the outside conditions;
instructions to change the brightness of the display at the same rate of speed in which the human eye adjusts itself to light; and
instructions to adjust the appearance of anything that can be defined as graphics, text, interfaces, applications, and the like that are layered on top of the obtained video feed based on the lighting conditions of the outside environment.
The device of claim one, further comprising
a supplementary light source for optical sensor(s);
optical sensor(s); and one or more programs, where the one or more programs are stored in the memory and configured to be executed by the one or more microprocessing units, they include
instructions to detect iris movements, blinks of the eyelids, and the like; and
instructions to translate iris movements, blinks of the eyelids, and the like as a device control method.
The device of claim one further comprising a head phone jack.
The device of claim one further comprising a microphone.
The device of claim one further comprising a motion sensor array.

2. An application for a wireless device, to provide various methods of controlling or interacting with the device of claim one, comprising of one or more programs, including:
instructions to establish a bi-directional communication link between the wireless device and the device of claim 1 by connecting via the RF circuitry of both the wireless device and the device of claim 1;
instructions to detect when the user interacts with one or more sensor(s) in the wireless device;
instructions to send data regarding which sensor was interacted with to the device of claim 1,
instructions to detect when the user interacts with one or more button(s) on the wireless device;
instructions to send data regarding which button(s) were interacted with to the device of claim 1;
instructions to detect when the user interacts with the touch screen of the wireless device;
instructions to send data regarding the users interaction with the touch screen of the wireless device to the device of claim 1;
instructions to detect when the user interacts with the touch screen of the wireless device while simultaneously interacting with one or more sensor(s) included in the wireless device;
instructions and to send data regarding the users interaction with the touch screen of the wireless device while simultaneously interacting with one or more sensor(s) included in the wireless device to the device of claim 1,
instructions to detect when the user interacts with one or more button(s) of the wireless device while simultaneously interacting with one or more sensor(s) included in the wireless device;
instructions and to send data regarding the users interaction with one or more button(s) of the wireless device while simultaneously interacting with one or more sensor(s) included in the wireless device to the device of claim 1,
instructions to detect when the user interacts with the touch screen of the wireless device while simultaneously interacting with one or more button(s) included in the wireless device;
instructions and to send data regarding the users interaction with the touch screen of the wireless device while simultaneously interacting with one or more button(s) included in the wireless device to the device of claim 1;
instructions to detect when the user interacts with the touch screen of the wireless device, over top of an allocated area of the application, meaning that the user is intending to use this interaction with the touch screen to move a cursor or pointing device shown on the display(s) of the device of claim one, and to send data regarding this movement and the location in which the movement was performed in to the device of claim 1;
instructions to detect when a user taps their finger on the touch screen surface of the wireless device on top of an allocated area of the application, meaning that the user is intending to use this interaction with the touch screen to use a cursor or pointing device which is shown on the display(s) of the device of claim one to click, confirm, or select something on screen, and to send data regarding this interaction and the location in which it occurred on to the device of claim 1;
instructions to detect when the user drags their finger on and then breaks contact with the touch screen surface of the wireless device on top of an allocated area of the application, meaning that the user is intending to use this interaction with the touch screen to scroll whatever is shown on the displays of the device of claim one, and to send data regarding this interaction and the location in which it occurred on to the device of claim 1;
instructions for this application, if commanded by the user, to change orientation based on what the user specifies their dominant hand as being;
instructions to allow the user to allocate a user interaction such as the user tapping or otherwise performing a touch screen or multi touch gesture on the touch screen of the wireless device, interaction with one or more sensor(s) on the wireless device, or button press of the wireless device to open the wireless device's integrated keyboard;
instructions to, if commanded by the user, bring up the wireless device's integrated keyboard within this application;
instructions to, if the wireless device's integrated keyboard is open, to track the user's interaction with this keyboard;
instructions to transmit the user's interactions with this keyboard and a mirroring of the keyboard layout to the device of claim 1;
instructions to, if the wireless device's integrated keyboard is open, to transmit the text or other data in which the user is typing to the device of claim 1;
instructions to, if the wireless device's integrated keyboard is open within this application, allow the allocated regions of the application to move a cursor or pointing device which is shown on the display(s) of the device of claim 1, scroll something which is shown on the display(s) of the device of claim 1, and to allow the cursor or pointing device which is shown on the display(s) of the device of claim 1 to select something, to remain open and available for use simultaneously while the wireless device's integrated keyboard is open within this application;
wherein the device of claim 1 contains one or more programs, where the one or more programs are stored in the memory and configured to be executed by the one or more microprocessing units, they include:
instructions to receive data from a wireless device which is connected via wireless device's RF circuitry to the RF circuitry of the device of claim 1, creating a bi-directional communication link;
instructions to receive data when one or more sensor(s) in the connected wireless device is interacted with, regarding which sensor was interacted with, and to turn that data into a method of controlling or interacting with the device of claim 1;
instructions to receive data when a user interacts with one or more button(s) on the connected wireless device, regarding which button was interacted with, and to turn that data into a method of controlling or interacting with the device of claim 1;
instructions to receive data when the user interacts with the touch screen of the connected wireless device, and to translate this into a means of controlling or interacting with the device of claim 1;
instructions to receive data when the user interacts with the touch screen of the wireless device while simultaneously interacting with one or more sensor(s) included in the wireless device to the device of claim 1 and to translate this into a means of controlling or interacting with the device of claim 1;
instructions to receive data when the user interacts with one or more button(s) of the wireless device while simultaneously interacting with one or more sensor(s) included in the wireless device to the device of claim 1 and to translate this into a means of controlling or interacting with the device of claim 1;
instructions to receive data when the user interacts with the touch screen of the wireless device while simultaneously interacting with one or more button(s) included in the wireless device to the device of claim 1 and to translate this into a means of controlling or interacting with the device of claim 1;
instructions to receive data when the user interacts with the touch screen of the wireless device, on top of an allocated area of the wireless device application, meaning that the user is intending to use this interaction with the touch screen to move a cursor or pointing device shown on the display(s) of the device of claim one and to translate this into a means of controlling or interacting with the device of claim 1;
instructions to receive data when the user taps their finger on the touch screen surface of the wireless device on top of an allocated area of the application, meaning that the user is intending to use this interaction with the touch screen to use a cursor or pointing device which is shown on the display(s) of the device of claim one to click, confirm, or select something on screen, and to send data regarding this interaction and to translate this into a means of controlling or interacting with the device of claim 1;
instructions to receive data when the user drags their finger on and then breaks contact with the touch screen surface of the wireless device on top of an allocated area of the application, meaning that the user is intending to use this interaction with the touch screen to scroll whatever is shown on the displays of the device of claim one, and to translate this into a means of controlling or interacting with the device of claim 1;
instructions to receive a mirroring of the wireless device's integrated keyboard layout, when a the wireless device's integrated keyboard is open within an application on the wireless device which is created for use with the device of claim 1;
instructions to receive information on the positioning and location of the users fingers or thumbs as they interact with the wireless device's integrated keyboard, which is open within an application on the wireless device which is created for use with the device of claim 1;
instructions to display the positioning and location of the users fingers of thumbs while they interact with the wireless device's integrated keyboard, overtop of the mirroring of the wireless device's keyboard layout, which is displayed on the displays of the device of claim 1;
instructions to receive text or other data which is entered by the user when the wireless device's integrated keyboard is open within the application on the wireless device which is created for use with the device of claim 1; and
instructions to continue to receive data on interactions the user has with the allocated regions of the application to move a cursor or pointing device which is shown on the display(s) of the device of claim 1, scroll something which is shown on the display(s) of the device of claim 1, and to allow the cursor or pointing device which is shown on the display(s) of the device of claim 1 to select something, simultaneously while the user has the wireless device's integrated keyboard opened within an application on the wireless device which is created for use with the device of claim 1.
The wireless device application of claim 2, further comprising of one or more programs, including: instructions to allow the user to allocate a user interaction such as user tapping or otherwise performing a touch screen or multi touch gesture on the touch screen of the wireless device, interaction with one or more sensor(s) on the wireless device, or one or more button press on the wireless device to launch applications on the device of claim one;
instructions to send data regarding that the user has performed a gesture or interaction which they have allocated to opening an application to the device of claim 1;
wherein the device of claim 1 contains one or more programs, where the one or more programs are stored in the memory and configured to be executed by the one or more microprocessing units, they include:
instructions to receive data regarding that a user has performed a gesture or interaction on the wireless device which was allocated within an application created for use with the device of claim 1 to open a specific application once the gesture or interaction has been performed;
and to launch the application that the gesture or interaction is associated with.
The wireless device application of claim 2, further comprising of one or more programs, including:
instructions to change the layout of the application if commanded over the bi-directional communication link between the device of claim 1 and the wireless device;
instructions to continue to detect touch screen interactions, button interactions, sensor interactions, which occur on the wireless device while the layout of the wireless device application of claim 2 is changed;
instructions to continue to send data when the user performs touch screen interactions, button interactions, sensor interactions, which occur on the wireless device while the layout of the wireless device application of claim 2 is changed;
instructions to bring up the wireless device's integrated keyboard if commanded by the user while the layout of the wireless device application of claim 2 is changed;
instructions to, if the wireless device's integrated keyboard is open, to track the user's interaction with this keyboard while the layout of the wireless device application of claim 2 is changed;
instructions to, transmit the user's interactions with this keyboard and a mirroring of the keyboard layout to the device of claim 1 while the layout of the wireless device application of claim 2 is changed;
instructions to, if the wireless device's integrated keyboard is open, to transmit the text or other data in which the user is typing to the device of claim 1 while the layout of the wireless device application of claim 2 is changed;
instructions to, if the wireless device's integrated keyboard is open within the wireless device application of claim 2, allow the touch screen, button(s), and sensor(s) of the wireless device to remain available for use simultaneously while the wireless device's integrated keyboard is open within this application while the layout of the wireless device application of claim 2 is changed;
wherein the device of claim 1 contains one or more programs, where the one or more programs are stored in the memory and configured to be executed by the one or more microprocessing units, they include:
instructions to command over the bi-directional communication link between the device of claim 1 and the wireless device to change the layout of the wireless device application of claim 2;
instructions to continue to receive data when the user performs touch screen interactions, button interactions, sensor interactions, which occur on the wireless device while the layout of the wireless device application of claim 2 is changed;
instructions to, receive the user's interactions with wireless device's integrated keyboard and a mirroring of the keyboard layout while the layout of the wireless device application of claim 2 is changed;
instructions to, receive the text or other data in which the user is typing while the layout of the wireless device application of claim 2 is changed; and
instructions to, receive data from the touch screen, button(s), and sensor(s) of the wireless device to simultaneously while the wireless device's integrated keyboard is open within the wireless device application of claim 2 while the layout of the wireless device application of claim 2 is changed.
The wireless device application of claim 2, further comprising of one or more programs, including:
instructions to receive custom control images, such as control pads, when they are sent to this device from the device of claim 1, and to track how the user interacts with this control pad, and to send this data to the device of claim 1;
instructions to track how the user interacts with the custom control image;
instructions to send the tracking of the user's interaction with the custom control image to the device of claim 1;
wherein the device of claim 1 contains one or more programs, where the one or more programs are stored in the memory and configured to be executed by the one or more microprocessing units, they include:
instructions to send custom control images, such as control pads, to the wireless device application of claim 2;
instructions to show the custom control images on the display(s) of the device of claim 1;
instructions to receive data which is sent from the wireless device regarding how the user interacts with the custom control image, which includes tracking of the user's fingers and thumbs as they interact with the control image, to translate this data into a means of controlling or interacting with the device of claim 1, and
instructions to mirror the user's interactions with the control image over the control image which is shown on the display(s) of the device of claim 1.
The wireless device application of claim 2, further comprising of one or more programs, including:
instructions to receive data to be processed sent by the device of claim 1;
instructions to process received data sent by the device of claim 1 on the microprocessing units of the wireless device;
instructions to send the processed data to the device of claim 1;
wherein the device of claim 1 contains one or more programs, where the one or more programs are stored in the memory and configured to be executed by the one or more microprocessing units, they include:
instructions to delegate a processing task to be computed on the microprocessing unit(s) of connected wireless device;
instructions to send the task to be processed over the bi-directional communication link established between the device of claim 1 and the wireless device; and
instructions to receive the data resulting from the successfully processed task from the wireless device over the bi-directional communication link established between the wireless device and the device of claim 1.
The wireless device application of claim 2, further comprising of one or more programs, including:
instructions to periodically access the location services or global positioning system module of the connected handset to obtain data on where the user has traveled or is currently traveling, by detecting a change in the location services or global positioning system coordinates;
instructions to request continued data from the location services or global positioning system module of the wireless device;
instructions to determine, by the rate of speed, which is obtained by analyzing the time it takes the user to travel from one destination to another, whether or not they are operating a motor vehicle;
instructions to, once it is determined by rate of speed that the user is operating a motor vehicle, the application of claim two sends data to the device of claim 1 over the established bi-directional communication link between the device of claim 1 and the wireless device, which states that the user is operating a motor vehicle;
instructions to, once it is determined that the user is no longer operating a motor vehicle, the application of claim two sends data to the device of claim 1 over the established bi-directional communication link between the device of claim 1 and the wireless device, which states that the user is no longer operating a motor vehicle;
wherein the device of claim 1 contains one or more programs, where the one or more programs are stored in the memory and configured to be executed by the one or more microprocessing units, they include:
instructions to receive data from the wireless device, stating that the user is using the device of claim 1 while driving;
instructions to curtail the device of claim 1's functionality as a result of receiving the data from the wireless device;
instructions to display a message on the display(s) of the device of claim one alerting the user that using the device while operating a motor vehicle is a safety hazard, therefore functionalities of the device of claim 1 are curtailed; and
instructions to receive data, when it is determined that the user is no longer operating a motor vehicle, from the wireless device that the application of claim 2 is installed on to, which states that the user is no longer operating a motor vehicle; and
restore the full functionality of the device of claim one, upon receiving data that the user is no longer operating a motor vehicle.
The wireless device application of claim 2, further comprising of one or more programs, including:
instructions to request access from the software within the wireless device which handles phone calls to send and receive data regarding calls received by the wireless device;
instructions to request access to the software within the wireless device which allows calls to be answered, rejected, sent to voice mail, or allow the user to otherwise interact with received calls;
instructions to request access to the software within the wireless device which contains the address book of the wireless device;
instructions to, when a call is received, to send the call and data regarding the call such as data associated with the caller if the caller has an entry in the address book, to the device of claim 1;
instructions to, send data to the software within the wireless device which allows calls to be answered, rejected, sent to voice mail, or allows the user to otherwise interact with received calls, regarding what the user chose to do regarding a received call or call(s), so that the software within the wireless device can perform what the user chose;
wherein the device of claim 1 contains one or more programs, where the one or more programs are stored in the memory and configured to be executed by the one or more microprocessing units, they include:
instructions to generate a notification regarding the call based on the information that was sent to the device of claim one regarding the call and giving the user the option to interact with the notification to answer, reject, send the call to voice mail, or interact with the call via any other method which the wireless device provides a user with for interacting with calls; and
instructions to send data to the application of claim 2 which is installed on the wireless device regarding how the user chose to interact with the call.
The wireless device application of claim 2, further comprising of one or more programs, including:
instructions to request access from the software(s) or protocol(s) within the wireless device in which various forms of messages can be sent and received from, to send and receive data regarding messages received by the wireless device;
instructions to request access to the software(s) or protocol(s) within the wireless device which allows messages to be received, sent, or allow the user to otherwise interact with messages;
instructions to request access to the software within the wireless device which contains the address book of the wireless device or the address book or books which is associated with the software(s) or protocol(s) that messages are sent and received on;
instructions to send the message that the user typed to the software or protocol it is to be sent over, so that protocol can send the message to the recipient(s) of the message the user is sending the message to;
wherein the device of claim 1 contains one or more programs, where the one or more programs are stored in the memory and configured to be executed by the one or more microprocessing units, they include:
instructions to when a message is received, generate a notification regarding the message based on information that was sent to the device of claim one regarding the message and giving the user the option to interact with the message;
instructions to, when a message is received and the user chooses to view the message, to send the message and data regarding the message, to the device of claim 1;
instructions to, when the user sends the message, the device of claim 1 sends the message; over the bi-directional communication link to the application of claim 2;
instructions to allow the user to draft a new message over any software or protocol they choose that is available on the wireless device;
instructions to allow the user to interactively select the recipient of the message with suggestions provided the address book or address books stored in the wireless device or the address book or books associated with software or protocols which the user is sending the message over;
instructions to allow the user to manually select the recipient of the message by choosing to look through the address book or address books, stored in the wireless device or the address book or books associated software or protocols which the user is sending the message over, by sending data between the device of claim 1 and the application of claim 2 regarding the address book the user has chosen to interact with;
instructions to allow the user to type a message and or allowing the user to attach multimedia or create new multimedia from either the device of claim 1 or from the wireless device, and
instructions to, when the user is done typing composing a message, the device of claim 1 sends the message; over the bi-directional communication link between the wireless device and the device of claim one to the application of claim 2.

3. A method, for providing a virtual reality environment in which the user is completely encompassed by the environment and can move or turn any direction in the environment comprising:
one or more programs, where the one or more programs are configured to be executed by one or more microprocessing units, they include
instructions which allow virtual reality worlds which encompass the user 360 degrees;
instructions for virtual reality worlds to extend past the boundaries of the display(s) of the device which they are being viewed on;
instructions which allow virtual reality environments which are 360 degrees to be moved or turned by the user so more of the environment may be viewed; and
instructions which allow the user to move in any direction forwards, backwards, left, right, and the like within a virtual reality environment.
